(19) United States
(12) Patent Application Publication
(10) Pub. No.: US 2013/0260002 A1
(43) Pub. Date: Oct. 3, 2013

(54) METHOD TO REDUCE SODIUM CONTENT IN PROCESSED FOODS USING NATURALLY BREWED SOY SAUCE AND OTHER FLAVOR ENHANCERS AND RESULTING REDUCED-SODIUM FOOD PRODUCT

(71) Applicants: WISCONSIN ALUMNI RESEARCH FOUNDATION, Madison, WI (US); KIKKOMAN USA R & D LABORATORY, INC., Walworth, WI (US)

(72) Inventors: Jeffrey Joseph Sindelar, Madison, WI (US); Scott A. Rankin, Cross Plains, WI (US); Takuya Sato, Verona, WI (US); Rani Govindasamy-Lucey, Madison, WI (US); John J. Jaeggi, Brooklyn, WI (US)

(73) Assignees: Kikkoman USA R & D Laboratory, Inc., Walworth, WI (US); Wisconsin Alumni Research Foundation, Madison, WI (US)

(21) Appl. No.: 13/799,660

(22) Filed: Mar. 13, 2013

Related U.S. Application Data
(60) Provisional application No. 61/617,362, filed on Mar. 29, 2012.

(51) Int. Cl. A23L 1/238

(52) U.S. Cl. CPC A23L 1/238
USPC 426/549; 426/649; 426/582; 426/641

(57) ABSTRACT

Described is a method of making a reduced-sodium food product and the resulting food product itself. In the method, a corresponding full-sodium food product is designated as containing 100% sodium from NaCl. The method includes the steps of preparing a food product using no more than about 50 wt % NaCl from flake salt as compared to the corresponding full-sodium food product and up to 45 wt % NaCl provided from soy sauce or natural flavor enhancer as compared to the corresponding full-sodium food product. The result is a reduced-sodium food product that is at least 5 wt % reduced in NaCl as compared to the full-sodium food product.

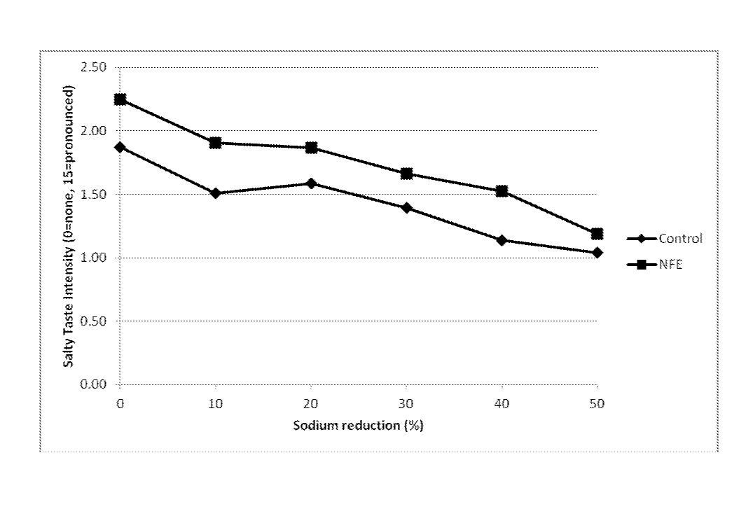

### CROSS-REFERENCE TO RELATED APPLICATIONS

Priority is hereby claimed to provisional application Ser. No. 61/617,362, filed Mar. 29, 2012, which is incorporated herein by reference.

### BACKGROUND

Sodium chloride (NaCl) is one of the oldest and most familiar food ingredients to man. NaCl is the baseline for humans' salty perception (Hazen 2010), as the salting of food began some 10,000 years ago in Mesopotamia (Man 2007) for preservation purposes. To this day, NaCl is of crucial importance in numerous food products. NaCl is especially important in processed meats, bread, and cheese, contributing to desirable food quality and food safety characteristics. The role of NaCl in processed meat products, in particular, can be placed in three broad categories: physical functionality, preservation, and sensory attributes (Rust 1987; Hutton 2002). An abundance of research supports the necessity of the inclusion of NaCl to produce safe and quality processed meat products.

However, despite the importance of NaCl in producing food of high quality and safety, there has been a great deal of both consumer and regulatory interest in reducing sodium intake in the human diet. Sodium reduction movements stem from reports that overconsumption of sodium has the propensity to lead to hypertension, cardiovascular disease, and bone disease, among other ailments. As of late, there has been a shift in consumer food purchasing habits, the most important factor now influencing what consumers take home are health-related concerns (Resurreccion 2003).

The current recommendation for human sodium intake from the World Health Organization (WHO) is 2,000 milligrams (mg) per day (WHO 2007). As of June 2010, it has been suggested that the current recommended dietary allowance (RDA) supplied by the Dietary Guidelines Advisory Committee in the United States be reduced from 2,300 mg per day to 1,500 mg per day (Soong 2010; Wenther 2010). The Dietary Guidelines Advisory Committee have also suggested setting a legal limit on NaCl in packaged foods, with gradual changes taking place (Wenther 2010). Sodium reduction initiatives, such as the National Salt Reduction Initiative (NSRI), aim to reduce salt in the American diet by 20% over a five year period, starting in 2010. Numerous meat processors and other food companies have joined in the crusade to decrease sodium intake across all food products, as approximately 75% of the daily dietary sodium is added to food before it ever reaches the consumer (Doyle and Glass 2010).

Although several research studies have been conducted to examine Na reduction and/or replacement in processed meats, there is still a need to develop novel approaches to reduce sodium without sacrificing product safety and quality. It is especially important to find methods to maintain the salty taste that is traditionally associated with processed meats despite reduced sodium content, as decreases in sodium are often associated with declining consumer acceptance (Sofos 1983a).

Limited research has been conducted on using of naturally brewed soy sauce and similar products, such as natural flavor enhancer (NFE) as a means to replace and reduce sodium and/or NaCl in food products. Kremer and others (2009) examined the use of naturally brewed soy sauce in salad dressings, tomato soup, and stir-fried pork. Soy sauce may have the ability to induce an enhanced perceived saltiness level through scent (Djordjevic and others 2004). Umami substances appear to work in a compensative relationship with NaCl (Yamaguchi and Takahaski (1984); Mojet and others (2004)). However, little is known as to the abilities umami-containing substances may have on the quality and sensory characteristics of processed meats.

As noted above, high levels of dietary sodium are associated with raised blood pressure and adverse cardiovascular health. The U.S. Department of Agriculture and Health and Human Services recommends a daily intake of less than 5.8 g of salt (2,300 mg of sodium), with a lower target of 3.7 g of salt per day for most adults. Despite these guidelines, during the period from 2005 through 2006, the average US male is estimated to have consumed 10.4 g of salt per day and the average female 7.3 g per day. Anderson et al. reported that the major food sources of sodium in the United States are breads, cereals and grains (19.5%), meat products and eggs (12.0%), seasonings and salad dressing (11.7%), and dairy products (8.2%). To avoid excess sodium intake, the sodium content in these traditional foods should be reduced.

In early 2010, the New York City Department of Health and Mental Hygiene announced the “National Salt Reduction Initiative”, a proposal led by the city of New York, in partnership with other cities, states, and national health organizations, that sets targets for voluntary sodium reduction in packaged and restaurant foods by 25% over five years. As a response to this initiative, several food industries are working towards removing sodium from their products. One of such efforts is the substitution of sodium chloride with potassium chloride, which has the downside of imparting bitter and metallic flavors to food products. Thus, salt substitutes and salty taste enhancers that do not impart off-flavors, lower the quality and safety, or decrease consumer acceptability are needed.

### SUMMARY OF THE INVENTION

Described is a method of using naturally brewed soy sauce (SS) and related natural flavor enhancers (NFE) to replace flake salt in processed foods such as processed meat products, bread, cheese, salad dressings, packaged snack foods (potato chips, pretzels, nacho and other corn chips, puffed snack products, etc.), and the like.

As used herein, the term “meat product,” is used broadly to encompass any and all processed and semi-processed comminuted and whole-muscle meat products to which sodium in the form of NaCl is conventionally added, such as (but not limited to) bacon and other salted meats (such as meat jerky), sausages of all description (such as frankfurters, bratwurst, etc.), cold-cuts of all description (for example, bologna, etc.), ground and minced meats and products made from ground and minced meats, meat patties, meat emulsions, extruded meat products, and the like. The terms “cheese” and “bread” have their standard, common meaning. “Cheese” as used herein includes cheese products of any and all description, including, but not limited to soft and hard cheeses, fresh and aged cheeses, pasta filata cheeses, etc. “Bread” as used herein includes all bread products, without limitation, included leavened and unleavened breads. The term “food product” is used herein to designate any processed animal or vegetable product intended for human or animal consumption.

“Soy sauce” refers to conventional, brewed soy sauce, which has been a staple condiment in Japan for centuries. “Natural flavor enhancer” (“NFE”) refers to a soy sauce-related product available commercially from Kikkoman USA, Walworth, Wis. The process to make NFE is described in U.S. Patent Publication No. US 2009/0098246, published Apr. 16, 2009, and incorporated herein by reference.

Disclosed herein is a method of making a reduced-sodium food product. The method and the resulting product is characterized by reference to a corresponding full-sodium food product, which is designated as containing 100% sodium in the form of NaCl. The method comprises preparing a food product using no more than about 50 wt % NaCl in the form of flake salt as compared to the corresponding full-sodium food product and up to 45 wt % NaCl provided in the form of soy sauce or natural flavor enhancer as compared to the corresponding full-sodium food product, thereby yielding a reduced-sodium food product that is at least 5 wt % reduced in NaCl as compared to the full-sodium food product. The proportion of NaCl provided by flake salt versus soy sauce or natural flavor enhancer can be adjusted accordingly to yield a product having more significant reductions in sodium content. Thus, for example, the method can use up to about 50% NaCl in the form of flake salt and up to about 40 wt %, or 35 wt %, or 30 wt %, or 25 wt %, or 20 wt %, or 15 wt % NaCl provided in the form of soy sauce or natural flavor enhancer as compared to the corresponding full-sodium food product, thereby yielding a reduced-sodium food product that is at least 10 wt %, or 15 wt %, or 20 wt %, or wt %, or 30 wt %, or 35 wt % reduced in NaCl as compared to the full-sodium food product.

The method may further comprise preparing the food product by adding KCl in an amount by weight approximately equal to the percent reduction in NaCl in the reduced-sodium food product.

Another version of the method comprises making a reduced-sodium food product in which a corresponding full-sodium food product is designated as containing 100% sodium in the form of NaCl provided by an amount of flake salt. Here the method comprises preparing a food product by reducing the amount of NaCl provided by flake salt, and replacing only a portion of the reduced amount of NaCl provided by flake salt with NaCl contained in soy sauce or natural flavor enhancer, thereby yielding a reduced-sodium food product. Additionally, this version of the method may further comprise adding KCl in an amount by weight approximately equal to the percent reduction in NaCl in the reduced-sodium food product.

Also disclosed herein is a reduced-sodium food product produced by any of the methods described herein.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, 5, 6, from 1 to 9, from 3.6 to 4.6, from 3.5 to 9.9, and so forth.

All references to singular characteristics or limitations of the present method and resulting product shall include the corresponding plural characteristic or limitation, and vice-versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods of the present invention can comprise, consist of, or consist essentially of the essential elements and limitations of the method described herein, as well as any additional or optional ingredients, components, or limitations described herein or otherwise useful in formulating processed food products that require the addition of sodium chloride.

### BRIEF DESCRIPTION OF THE DRAWING

The sole FIGURE is a graph depicting salty taste perception in bread loaves with NaCl or NFE and different levels of sodium reduction.

### DETAILED DESCRIPTION

### 1. Materials and Methods: Reduced-Sodium Meat Products

1.1 Experimental Design and Data Analysis:

This study utilized varying levels of naturally brewed soy sauce (SS), as well as a modified soy sauce product (natural flavor enhancer; “NFE”), sodium chloride (NaCl), and potassium chloride (KCl) in the manufacture of emulsified frankfurters during three phases of research. Four treatments (TRTs) and a control (C) were used in each phase of this study. Treatments for Phase I were as follows: C, 2.5% salt (meat block basis) provided by 100% flake salt; TRT 1: 25% salt from SS or NFE, 75% salt from flake salt; TRT 2: 50% salt from SS or NFE, 50% flake salt; TRT 3: 75% salt from SS or NFE, 25% flake salt; TRT 4: 100% salt from SS or NFE. Treatments for Phase II were as follows: C, 2.5% salt (meat block basis) 100% flake salt; TRT 1: 50% SS or NFE, 50% flake salt; TRT 2: 50% SS or NFE, 40% flake salt; TRT 3: 50% SS or NFE, 30% flake salt; TRT 4: 50% SS or NFE, 20% flake salt. Treatments for Phase III were as follows: C, 2.5% salt (meat block basis) 100% flake salt; TRT 1: 50% SS or NFE, 50% flake salt; TRT 2: 50% SS or NFE, 30% flake salt, 20% KCl; TRT 3: 50% SS or NFE, 15% flake salt, 35% KCl; TRT 4: 50% SS or NFE, 0% flake salt, 50% KCl.

The experimental design was a randomized complete block using a mixed effects model. Statistical analysis was performed for all measurements using the Statistical Analysis System (version 9.2, SAS Institute Inc., Cary, N.C.) Mixed Model procedure (SAS Inst. 2003). The model included the fixed main effects of treatment (TRTs 1-4, C) and replication (n=3) resulting in 15 observations. All least significant differences were found using the Tukey-Krämer pair-wise comparison method. Significance levels were determined at P<0.05 throughout. (Thus, all results identified as significant were P<0.05; all results identified as not significant were P>0.05.)

1.2. Product Manufacture:

Percentages are in percent-by-weight unless specifically identified otherwise. Ready-to-eat emulsified frankfurters were manufactured with 90% lean beef and 42% lean pork trimmings obtained from a local supplier (UW Provision, Middleton, Wis.). Raw materials were ordered separately for each research phase. The 42% lean pork trimmings were coarse ground (Hobart Model 4732, Hobart Corporation, Troy, Ohio) using a 19.05 mm plate and the 90% lean beef knuckles were coarse ground using a 9.53 mm plate. The coarse ground beef and the coarse ground pork were randomly separated into 15 batches of 4.54 kilograms (kg) each and were vacuum packaged (Ultravac 2100-C, Ultravac Solutions LLC, Kansas City, Mo.; Seal Setting=5, Vacuum Setting=5; Flavorseal Vacuum Pouch, 3 mil, Carroll Manufacturing & Sales, Avon, Ohio; O₂ Transmission Rate: 52 cc/in² per 24 hours). Packages were randomly assigned to treatments (TRT 1-4) and control (C). Vacuum packaged raw materials were stored under refrigeration for one to three days.

The control for all phases was comprised of the following: 40.16% beef, 40.16% pork, 16.07% ice, 2.00% salt from flake salt (2.5% of the meat block), 1.37% spices (Product 6020023 V1, [sugar, spice extractives], Saratoga Food Specialties, Bolingbrook, Ill.), 0.20% cure (Product 0490000 Sure Cure—6.25% sodium nitrite, [salt, sodium nitrite, FD&C Red #3, sodium silica aluminate] Excalibur Seasoning Company, Pekin, Ill.), and 0.054% sodium erythorbate. Phosphates were not added to any TRTs or C because the emulsified frankfurters were intended to test the functionality of the NaCl found in the SS.

The formulations for Phase I were as follows: All treatments contained 40.16% beef, 40.16% pork, 1.37% spices, 0.20% cure, and 0.054% sodium erythorbate. Treatments varied in the percentage of ice, NaCl and SS or NFE.

For the formulations that included SS, TRT I was a 25% salt replacement, with 75% salt from flake salt (1.50% added in formulation), 25% salt from SS, and contained 13.44% ice, 3.13% SS (16% NaCl, Kikkoman USA, Walworth, Wis.); TRT 2 was a 50% salt replacement, with 50% salt from flake salt (1.00% added in formulation), 50% salt from SS and contained 10.81% ice, 6.26% SS; TRT 3 was a 75% salt replacement, with 25% salt from flake salt (0.50% added in formulation), 75% salt from SS and contained 8.18% ice, and 9.39% SS; TRT 4 was a 100% salt replacement, with 0% salt from flake salt (0% added in formulation), 100% salt from SS and contained 5.55% ice, and 12.52% SS.

The SS-containing formulations for Phase II were as follows: All treatments contained 1.37% spices, 0.20% cure, and 0.054% sodium erythorbate. The percentage of meat, ice and SS varied as a result of reducing the amount of NaCl, which led to a change in batch weight. Percentages of pork and beef ranged from 40.16% to 40.40% for TRTs 1-4. Percentages of ice ranged from 9.76% to 9.83% for TRTs 1-4, and SS (13.69% NaCl, Kikkoman USA, Walworth, Wis.) ranged from 7.31% to 7.36% for TRTs 1-4. NaCl percentage was varied between treatments: TRT I included 50% salt from flake salt (1.00% added in formulation) and 50% NaCl from SS; TRT 2 had a 10% reduction in salt, with 40% salt from flake salt (0.80% added in formulation) and 50% salt from SS; TRT 3 was a 20% reduction in salt, with 30% salt from flake salt (0.60% added in formulation) and 50% salt from SS; TRT 4 was a 30% reduction in salt, with 20% salt from flake salt (0.40% added in formulation) and 50% salt from SS.

The SS-containing formulations for Phase III were as follows: All treatments contained 40.16% beef, 40.16% pork, 9.75% ice, 7.32% SS (13.68% NaCl, Kikkoman USA, Walworth, Wis.), 1.37% spices, 0.20% cure, and 0.04% sodium erythorbate. Treatments varied in the amount of NaCl, and KCl: TRT 1 was 50% salt from flake salt, 0% salt from KCl and 50% salt from SS and had formulation levels of 1.00% salt and 0% KCl; TRT 2 was a 20% reduction in sodium, with 30% salt from flake salt, 20% salt from KCl, and 50% salt from SS and had formulation levels of 0.60% salt and 0.40% KCl; TRT 3 was a 35% reduction in sodium with 15% salt from flake salt, 35% salt from KCl and 50% salt from SS and had formulation levels of 0.30% salt and 0.70% KCl; TRT 4 was a 50% reduction in sodium with 0% salt from flake salt, 50% salt from KCl and 50% salt from SS and had formulation levels of 0% salt and 1.00% KCl.

For the formulations that contained NFE, TRT I was a 25% salt replacement, with 75% salt from flake salt (1.50% added in formulation), 25% salt from NFE and contained 12.47% ice, and 4.10% NFE (12.20% salt, Kikkoman USA, Walworth, Wis.); TRT 2 was a 50% salt replacement, with 50% salt from flake salt (1.00% added in formulation), 50% salt from NFE and contained 8.86% ice, and 8.21% NFE; TRT 3 was a 75% salt replacement, with 25% salt from flake salt (0.50% added in formulation), 75% salt from NFE and contained 5.26% ice, and 12.31% NFE; TRT 4 was a 100% salt replacement, with 0% salt from flake salt (0% added in formulation), 100% salt from NFE and contained 1.65% ice, and 16.42% NFE.

The NFE-containing formulations for Phase II were as follows: All treatments contained 1.37% 0.20% cure, and 0.054% sodium erythorbate. The percentage of meat, ice and NFE varied as a result of reducing the amount of flake salt, which led to a change in batch weight. Percentages of pork and beef ranged from 40.16% to 40.40% for TRTs 1-4. Percentages of ice ranged from 8.86% to 8.93% for TRTs 1-4, and NFE (12.2% NaCl, Kikkoman USA, Walworth, Wis.) ranged from 8.21% to 8.26%. NaCl percentage was varied between treatments: TRT 1 included 50% salt from flake salt (1.00% added in formulation) and 50% salt from NFE; TRT 2 had a 10% reduction in salt, with 40% salt from flake salt (0.80% added in formulation) and 50% salt from NFE; TRT 3 had a 20% reduction in salt, with 30% salt from flake salt (0.60% added in formulation) and 50% salt from NFE; TRT 4 was a 30% reduction in salt, with 20% salt from flake salt (0.40% added in formulation) and 50% salt from NFE.

The NFE-containing formulations for Phase III were as follows: All treatments contained 40.16% beef, 40.16% pork, 8.88% ice, 8.19% NFE (12.2% NaCl, Kikkoman USA, Walworth, Wis.) 1.37% spices, 0.20% cure, and 0.054% sodium erythorbate. Treatments varied in the amount of flake salt, and KCl: TRT 1 was 50% salt from flake salt, 50% salt from NFE and had formulation levels of 1.00% salt and 0% KCl; TRT 2 was a 20% reduction in sodium, with 30% salt from flake salt, 20% salt from KCl, and 50% salt from NFE and had formulation levels of 0.60% salt and 0.40% KCl; TRT 3 was a 35% reduction in sodium with 15% salt from flake salt, 35% salt from KCl, and 50% salt from NFE and had formulation levels of 0.30% salt and 0.70% KCl; TRT 4 was a 50% reduction in sodium with 0% salt from flake salt, 50% salt from KCl and 50% salt from NFE and had formulation levels of 0. % salt and 1.00% KCl.

Emulsions were produced using techniques described by Rust (1987). The emulsified frankfurters were manufactured using a bowl chopper (Krämer & Grebe 67-225, Krämer & Grebe GmbH & Co. KG., Biendenkopf-Wallau, Germany). The coarse ground beef was chopped with cure, flake salt (Phase I), flake salt and/or SS or NFE (Phase II), flake salt and/or SS or NFE and/or KCl (Phase III), and half of the ice until a temperature of 2.2° C. was achieved. The pork, spices, and remainder of the ice were added and the bowl chopper was scraped to ensure complete mixing and chopping. The mixture was chopped until a temperature of 14.4° C. was achieved. After the completion of chopping, the emulsion was transferred to a rotary-vane vacuum filler with a linking attachment (Handtmann VF 608 Plus vacuum filler, Handtmann CNC Technologies Inc., Buffalo Grove, Ill.) and stuffed into 27 mm cellulose casings (Viscofan USA Inc., Montgomery, Ala.) with 80 grams per link.

All treatments were hung on smokehouse sticks and were placed on a smokehouse truck and were showered with cold water prior to the onset of cooking. Cooking was accomplished using a single truck smokehouse (Alkar Model 450 MiniSmoker, Alkar Engineering Corp., Lodi, Wis.) and a standard frankfurter smokehouse schedule cooked to an internal temperature of 71.1° C. After the completion of thermal processing, the frankfurters were immediately chilled until the internal temperatures were below 4.4° C. Thermal processing and cooling data was recorded using a data logger (TempTale®4, Sensitech, Beverly, Mass.). After cooling, the cellulose casings were removed and frankfurters were placed in barrier bags (Flavorseal Vacuum Pouch, 3 mil, Carroll Manufacturing and Sales, Avon, Ohio; O₂ Transmission Rate: 52 cc/in² per 24 hours) and vacuum packaged (Ultravac 2100-C Vacuum Packager, Koch Equipment, Kansas City, Mo.; Seal setting=5, Vacuum setting=5). Samples were boxed and stored at 2° C. until further analysis at predetermined sampling dates.

1.3. Soy Sauce and Natural Flavor Enhancer Preparation:

Naturally brewed soy sauce (Kikkoman USA, Walworth, Wis.) contains the following ingredients: water, wheat, soybeans, and salt. The typical composition of naturally brewed soy sauce is as follows: 13.7% NaCl (weight basis), 8.8% protein (weight basis), 1.41% total nitrogen (weight basis), and an alcohol target (volume basis) of at least 2.1%. Preliminary research indicated a residual protease exists in SS which can negatively affect the integrity of an emulsion system. In order to inactivate this protease, the SS was treated by placing in 500 ml bottles and cooking in a water bath at 75° C. for 7 hours. Upon the completion of cooking, SS was weighed out into aluminum pans (323 mm×263 mm×65 mm) according to formulation needs, and was then covered with aluminum foil and frozen overnight at −20° C. SS was then removed from the freezer as needed during processing.

NFE (Kikkoman USA, Walworth, Wis.) contains the following ingredients: water, soybeans, wheat, salt, and alcohol. The typical composition of natural flavor enhancer is as follows: 12.2% NaCl (weight basis), 8.9% protein (weight basis), 1.43% total nitrogen (weight basis), and an alcohol target (volume basis) of at least 3.0%. As with soy sauce, preliminary research indicated a residual protease exists in NFE which can negatively affect the integrity of an emulsion system. In order to inactivate this protease, the NFE was treated by placing in 500 ml bottles and cooking in a water bath set to 750 C for 7 hours. Upon the completion of cooking, NFE was weighed out into aluminum pans (323 mm×263 mm×65 mm) according to formulation needs and were covered with aluminum foil and frozen overnight in a −200 C freezer. NFE was then removed from the freezer as needed during processing.

Kikkoman's NFE product is disclosed in U.S. patent application Ser. No. 12/064,279, published as US 2009/0098246 on Apr. 16, 2009, a copy of which is attached hereto and incorporated herein.

1.4. Proximate Composition:

Proximate analysis was conducted on the cooked frankfurter samples for moisture (AOAC 2000a), crude protein (AOAC 2000b), and crude fat (AOAC 2000c). Moisture and crude protein samples were conducted in duplicate. Crude fat samples were conducted in triplicate.

1.5. Instrumental Color Measurements:

Instrumental color was measured using a Minolta Colorimeter (Model CR-300, Minolta Camera Co., Ltd., Osaka, Japan; 1 cm aperture, illuminant C, 20° observer angle). The colorimeter was standardized by placing the same vacuum packaging bags that were used to package the frankfurters over the white standardization tile. Values for the white standard tile were L*97.06, a*=−0.14, b*1.93 (Y=93.7, x=0.3163, and y=0.3324).

Commission Internationale de l'Eclairage (“CIE,” International Commission on Illumination) L* (lightness), a* (redness) and b* (yellowness) external and internal color measurements were taken at two weeks post-manufacture. Frankfurters were sliced lengthwise and placed into vacuum bags and measurements were taken immediately after the frankfurters were sliced. Measurements for exterior and interior color were taken at two randomly selected locations on each of the samples. In an effort to address smokehouse related impacts on external color, the placement of C and TRTs on the smokehouse truck was randomized to minimize the effects of any color variation from any source other than the SS content.

1.6. pH Measurements and Processing Attributes:

pH levels were measured using methods described by Sebranek and others (2001). The pH samples were blended in a 1:9 ratio of sample to distilled, de-ionized water (DDW) and were homogenized with a Polytron Mixer (PIO-3SGTT, Dispersing Aggregate PTA20/2W, Kinematica, AG, Lucerne, Switerzland) at setting 7 for 45 seconds. Whatman #1 filter paper was folded and pushed into the 150 ml beaker slurry to allow the fat free solution to come through the paper. The tip of the electrode was placed into the solution and pH was measured with a pH meter (Accumet Basic AB 15 Plus pH Meter, Fisher Scientific, Fair Lawn, N.J.) equipped with an electrode (Accument combination pH electrode with Ag/AgCl reference Model 13-620-285, Fisher Scientific, Fair Lawn, N.J.) calibrated with 4.00 and 7.00 phosphate buffers. Measurements were made in duplicate for each treatment.

The pH of raw materials and raw emulsion was determined by pressing the electrode probe of a pH meter calibrated with 4.00 and 7.00 phosphate buffers (Testo 206, Testo AG, Lenzkirch, Germany) into the raw beef, pork, and emulsion on the day of production.

1.7. Purge Level Measurements:

The amount of purge present in a package was measured using both the color and texture samples. Complete packages were weighed, and then opened, drained, and the bags and frankfurters were blotted dry with a paper towel. Bag weight was recorded and frankfurter weight was recorded. Purge was calculated by the following equation:

Percent Purge=((Total Weight−Bag Weight−Meat Weight)/Meat Weight)×100.

1.8. Emulsion Stability Measurements:

The stability of the raw emulsion was also determined on the day of production by the Rongey Method (Sebranek and others 2001) using a Wierbicki tube divided by a 40 mesh stainless steel disc (22 mm diameter; purchased from a local hardware store). Tubes were filled with approximately 25 grams of emulsion using an open-ended 30 cc syringe, weighed, and covered with aluminum foil. Filled sample tubes were left at room temperature for 30 minutes before being placed in a water bath set to 71.1° C. for 30 minutes. Samples were removed from the water bath and allowed to cool for approximately 5 minutes before centrifuging (Sorvall RC 50 Plus with a SLA-3000 Rotor, Thermo Scientific, Fair Lawn, N.J., with settings of: Minimum Temperature of 22° C. and Maximum Temperature of 30° C., 1,500 rpm for 6 minutes). Upon the completion of the centrifugation cycle, the samples were read for amounts of separated fat (top layer) and separated water (bottom layer) that drained from the emulsion through the mesh disc. Emulsion stability tests were conducted in duplicate for each treatment. The total amount of liquid separation was determined by the following equations:

Percent water separation=(ml of water/sample weight)×100

Percent fat separation=(ml of fat/sample weight)×100

Percent total liquid separation=% water separation+% fat separation

1.9. Cook Yield Measurements:

Cook yields were determined for the frankfurters by taking a raw weight of the whole batch prior to thermal processing and reweighing the product after thermal processing and cooling. Cook yield was determined by the following equation:

Cook yield=(cooled weight/raw weight)×100.

1.10. Salt Level Measurements:

Salt levels were measured using methods described by Sebranek and others (2001). The salt level samples were finely ground with a food processor (Fresh Chop Model 72600, Hamilton Beach Brands Inc., Southern Pines, N.C.) and blended in a 1:9 ratio of sample to DDW. Samples were heated on a hot plate set to 300° C. until they reached a rolling boil, and were then removed from the heat to cool to ambient temperature. After cooling, a piece of folded Whatman #1 filter paper was pushed into the 150 ml beaker and a Quantab strip (Quantab Titrators for Chloride, High Range Titrators—300-6000 ppm Cl, Hach Company, Loveland, Colo.) was inserted into the solution and allowed to go to completion. Percent NaCl was determined by using the conversion chart provided on the Quantab bottle. All values were multiplied by 10 to account for the dilution factor to give the actual percentage of salt. Measurements were made in duplicate for each treatment.

1.11. Instrumental Texture Measurements:

1.11.1. Texture Profile Analysis:

The texture profile analysis was conducted using methods described by Wenther (2003) and Bourne (1978). The TA-HDi-brand Texture Analyzer (Texture Technologies Corp., Scarsdale, N.Y.) equipped with a 25 mm diameter cylinder (TA-25) was used to determine the texture profile analysis of samples by a two compression test. The TA-HDi Texture Analyzer was calibrated with a 10 kg weight and Texture Expert software (Version 1.22) was used. Texture profile analysis was conducted on chilled frankfurter samples two weeks post-manufacture using a core of frankfurter (1.6 cm diameter, 1.9 cm high). The test was performed at 3.3 mm/second for both a two-cycle 50% compression and a two-cycle 72% compression. One measurement was taken per core and two cores were taken from four links of each treatment, resulting in eight measurements for both compression sets. The following equations were used for textural measurements:

Hardness=the peak force during the first compression (72% compression).

Springiness=the height the sample recovered during the time that elapses between the end of the first bite and the start of the second bite (50% compression).

Cohesiveness=the ratio of the positive force area during the second compression (50%) to that during the first compression (50%), calculated as: ((Area 2/Area 1)×100).

Chewiness=the product of (hardness×(cohesiveness/100)×springiness).

1.11.2. Puncture Analysis:

The puncture analysis was conducted using methods described by Wenther (2003). The puncture test was conducted on frankfurter samples two weeks post-manufacture using the TA-HDi Texture Analyzer (Texture Technologies Corp., Scarsdale, N.Y.) equipped with a 2 mm diameter stainless steel puncture probe (TA-52). The 2 mm probe was programmed to penetrate 12 mm into each sample after the TA-HDi detects the sample's surface at 12 g resistance. The penetration rate was 1.5 mm/second. The pre-test speed was 3.0 mm/second and the post test speed was 10 mm/second. Samples were tested at room temperature (one hour after removal from refrigeration) to ensure consistency between treatments. No tests were conducted within 12.7 mm of the sample ends.

Samples were measured for penetration peak force (puncture). The peak force was determined as the force required to break the outer surface/skin of the sample. For each treatment, four readings were taken per sample and two samples were measured, giving a total of eight measurements per treatment.

1.12. Consumer Sensory Analysis and Demographics:

Frankfurter samples were presented to consumer sensory panelists at the University of Wisconsin-Madison, Sensory Analysis Laboratory (Madison, Wis.) over three days (three hours per day; one replication per day) to collect data from a minimum of 50 panelists per replication. Panelists were provided with DDW to cleanse the palate between samples. Samples were coded with a random three digit number and presented in random order. A 10 cm line scale was used for ballots with anchors at 1 and 9 cm. Demographic questions were asked regarding ethnicity, age, gender, and the frequency of soy sauce and Asian food consumption.

Consumer sensory panels were conducted two weeks post-frankfurter manufacture. Water was heated to a boil and then removed from heat, at which point frankfurters were added and held for 7 minutes. Frankfurters were then cut into 6.35 mm pieces with the ends being discarded. Samples were placed into labeled sample cups, covered, and held at 60° C. in a warming cabinet (Flav-R-Fresh Impulse Display Cabinet, Hatco Corp., Milwaukee, Wis.) for no longer than one hour while serving was conducted. Panelists were presented three 6.35 mm pieces in a covered container and were asked to rate internal color, texture, overall liking, overall taste intensity, salty taste, and meat taste of the samples. For Phase III, bitterness was also included on the ballot.

### Results and Discussion

### 2. Phase I—Sodium Chloride Replacement Using Soy Sauce:

2.1. Proximate Composition:

Raw materials (pork and beef) were individually mixed uniformly before batching and assignment as TRT or C for the entire research phase. Because of this, proximate analysis of moisture, fat, and protein was only determined for the emulsified frankfurter C samples. The average moisture content was 58.10% and values ranged from 57.51% to 58.38%. Average fat content was 23.14% and values ranged from 20.58% to 25.82%. Average protein content was 13.48% and values ranged from 12.75% to 14.64%.

TABLE 3.1
Least squares means for Phase I instrumental external and internal color, pH, purge, emulsion stability, cook
yield, and salt level for emulsified frankfurters containing naturally brewed soy sauce (SS; TRTs 1-4) and a
control frankfurter containing no SS (C).

| | | | | | | | | | Emulsion | Cook | |
|---|---|---|---|---|---|---|---|---|---|---|---|
| | External^{b} | | | Internal^{b} | | | | Purge^{d} | Stability^{e} | Yield^{f} | Salt^{g} |
| TRT^{a} | L* | a* | b* | L* | a* | b* | pH^{c} | (%) | (%) | (%) | (%) |
| C | 62.64ⁱ | 15.55ⁱ | 12.23^{k} | 66.60ⁱ | 14.42ⁱ | 8.68^{m} | 6.11ⁱ | 0.92ⁱ | 7.42ⁱ | 92.28ⁱ | 2.27ⁱ |
| 1 | 62.18^{ij} | 15.03^{ij} | 12.83^{jk} | 65.76^{j} | 14.39ⁱ | 10.70^{l} | 5.97^{j} | 1.09ⁱ | 7.45ⁱ | 91.30ⁱ | 2.17^{j} |
| 2 | 61.24^{j} | 15.30^{ijk} | 13.71^{ij} | 65.35ⁱ | 13.93^{j} | 11.82^{k} | 5.85^{k} | 1.02ⁱ | 7.92ⁱ | 92.27ⁱ | 2.13^{jk} |
| 3 | 59.16^{k} | 14.53^{jk} | 13.58^{ij} | 63.56^{k} | 14.15^{ij} | 12.85^{j} | 5.79^{l} | 0.99ⁱ | 8.39ⁱ | 92.10ⁱ | 2.10^{jk} |
| 4 | 59.36^{k} | 14.47^{k} | 14.43ⁱ | 63.00^{k} | 13.98^{j} | 14.17ⁱ | 5.72^{m} | 0.96ⁱ | 7.66ⁱ | 92.42ⁱ | 2.06^{k} |
| SEM^{h} | 0.33 | 0.20 | 0.26 | 0.18 | 0.12 | 0.21 | 0.012 | 0.083 | 0.85 | 0.30 | 0.022 |

^{a}Treatments (2.5% NaCl): C = 100% from flake salt; TRT 1 = 25% salt from SS. 75% salt from flake salt; TRT 2 = 50% salt from SS, 50% salt from flake salt; TRT 3 = 75% salt from SS, 25% salt from flake salt; TRT 4 = 100% salt from SS.
^{b}Commission Internationale de l'Eclairage (CIE) L*, a*, b*, where L* = lightness or darkness on a 0 (black) to 100 (white) scale, a* = redness (positive value) or greenness (negative value), or b* = yellowness (positive value) or blueness (negative value).
^{c}pH of fully cooked emulsified frankfurters.
^{d}Percentage of purge in fully cooked emulsified frankfurter product package after two weeks storage at 4° C.
^{e}Emulsion stability of randomly collected raw emulsion = Percentage of total liquid separation, calculated as the summation of percentage of water separation and percentage of total fat separation.
^{f}Percentage cook yield = ((raw weight of frankfurters/cooked weight of frankfurters) × 100)
^{g}Percentage of salt in fully cooked emulsified frankfurters.
^{h}SEM = Standard error means for instrumental external and internal color. pH, percentage purge, emulsion stability, percentage salt, and percentage moisture for emulsified frankfurters
^{i-m}Means within the same column with different superscripts are different (P < 0.05).

2.2. Instrumental Color Measurements:

Both external and internal color measurements were conducted for the emulsified frankfurters. The least squares means for both sets of measurements are displayed in Table 1. External color values for CIE L*, a*, and b* were affected by the addition of SS to frankfurters. L* values were significantly lower for TRTs 2, 3, and 4 as compared to C, indicating that the usage of SS at 50%, 75%, and 100% salt levels darkened product color. Usage of SS at the 25% level did not result in a statistically darker color. External color a* values were significantly lower for TRTs 3 and 4 as compared to C, indicating that the usage of SS at 75% and 100% salt levels led to a less red color. External color b* values were significantly higher for TRTs 2, 3, and 4 as compared to C, indicating that the usage of SS at 50%, 75%, and 100% salt levels led to a more yellowish product.

Internal color measurements for CIE L*, a*, and b* were also affected by the addition of SS to frankfurters. Internal L* values were significantly lower for all TRTs compared to C. L* values for internal color decreased with increasing SS content, as TRT 4, which contained 100% salt from SS had the lowest L* value. Internal a* values were significantly lower for TRTs 2 and 4 as compared to C. These a* values show that the addition of SS can decrease the reddish appearance of frankfurters. Internal b* values were significantly higher for all TRTs compared to C. These values for internal b* indicate that addition of SS to replace NaCl at any level tested can lead to an increased yellowish appearance. Overall, the usage of SS can affect both the internal and external color of frankfurters, although not all usage levels led to significant differences suggesting minimal practical differences for color existed.

2.3. pH Measurements and Processing Attributes:

The least squares means for pH measurements are also displayed in Table 1. The pH levels of all TRTs were statistically different than C and pH decreased with each increase in SS. These results are consistent with what would be expected, as the pH of SS that was used for this experiment had a pH value of 4.57 and resulted in a reduction of pH as SS levels increased.

Various product and processing parameters were recorded during the production of the frankfurters. Raw emulsion pH ranged from 5.81 (TRT 4) to 5.96 (C). The mean pH of the lean beef and fat pork trimmings were 5.79 and 6.19, respectively.

2.4. Purge, Emulsion Stability, and Cook Yield Measurements:

The least squares means for purge levels, emulsion stability, and cook yield measurements are also listed in Table 1. No significant differences were found between C and TRTs for purge levels at two weeks of refrigerated storage. Purge loss values ranged from 0.92% (C) to 1.09% (TRT 1). Emulsion stability measurements also displayed no significant differences for any TRTs. Percentage of total liquid separation ranged from 7.4% (C and TRT 1) to 8.4% (TRT 3), and no significant differences existed between C and any TRTs. Cook yield measurements ranged from 91.30% (TRT I) to 92.42% (TRT 4) and no statistical differences existed between C and TRTs. As a result of the ingoing NaCl content remaining constant between C and TRT formulations at a level of 2.5%, it can be expected that emulsion stability, cook yield, and purge would not be significantly affected by the replacement of the NaCl source from flake salt to SS. This is because of the role NaCl has in the formation of an emulsion through the extraction of myofibrillar proteins, the formation of protein cross-links, and the binding of fat and water. Research conducted by Sofos (1983b) on the effects of reducing NaCl in frankfurters suggested that NaCl levels of 2.5% produced stable emulsions with high cook yields. The results from Sofos' (1983b) experiment is in agreement with the results found in this study, as there were no differences for cook yield, emulsion stability, or purge levels.

2.5. Salt Level Measurements:

The least squares means for salt level measurements are likewise displayed in Table 1. Salt values of TRTs varied significantly from C. C had the highest level of NaCl at 2.27% and TRT 4 had the lowest NaCl content at 2.06%. TRTs 2 and 3 were not different from TRTs 1 or 4; however, differences existed between TRT 1 and TRT 4. A trend of decreasing NaCl percentage with increasing SS content existed. Differences in final salt content may also be come from any possible variation in the amount of NaCl present in the SS, formulations were developed utilizing a level of 16% NaCl in SS; however, it is possible that a lower percentage of NaCl was actually present.

2.6. Instrumental Texture Measurements:

Both textural profile analysis (TPA) and puncture measurements were conducted for the frankfurters. The least squares means for textural analyses are listed in Table 2. TPA testing revealed that only TRT 4 was found to be significantly harder than C. No differences were observed for either springiness or cohesiveness between any TRTs or C. Only TRT 2 was significantly lower for chewiness measurements than C. Based on the findings from TPA, no clear relationship can be determined for the effects of SS for NaCl replacement. Puncture testing results revealed significant differences between C and some TRTs. TRTs 3 and 4 required significantly less peak force to break the outer skin of the frankfurters as compared to C. As the level of NaCl from SS increased, less peak force was generally needed to break the skin.

2.7. Consumer Sensory Analysis and Demographics:

The least squares means for sensory analysis results are presented in Table 3. Overall liking was impacted by the addition of SS, as TRTs 1, 2, and 3 were liked significantly more than C; however, no significant difference existed between C and TRT 4. All TRTs containing SS were perceived as significantly saltier than C, with saltiness ratings increasing with the amount of added SS. The sensory saltiness results indicate that the inclusion of SS allows for an increase in the perceived salty taste. Further, differences may not be fully realized in sensory results as salt levels (Table 1) were shown to decrease, although not all significant, as the amount of SS increased. Overall taste intensity was also increased by the addition of SS, as all TRTs tasted significantly more intense than C. Taste intensity, like saltiness, also increased with the addition level of SS.

TABLE 3.2
Least squares means for Phase I hardness, springiness,
cohesiveness. chewiness, and puncture for emulsified
frankfurters containing naturally brewed soy sauce
(SS: TRTs 1-4) and a control frankfurter containing no SS (C).

| | Hardness^{b} | Springiness^{c} | Cohesiveness^{d} | Chewiness^{e} | Puncture^{f} |
|---|---|---|---|---|---|
| TRT^{a} | (N) | (mm) | (%) | (N × mm) | (N) |
| C | 11.55ⁱ | 2.92ⁱ | 85.06ⁱ | 28.62^{hi} | 2.25^{h} |
| 1 | 10.68ⁱ | 2.93ⁱ | 84.19ⁱ | 26.36^{ij} | 2.28^{h} |
| 2 | 10.56ⁱ | 2.83ⁱ | 84.72ⁱ | 25.36^{j} | 2.18^{h} |
| 3 | 11.25ⁱ | 2.81ⁱ | 84.07ⁱ | 26.65^{ij} | 1.95ⁱ |
| 4 | 17.69^{h} | 2.86ⁱ | 84.77ⁱ | 30.71^{h} | 1.88ⁱ |
| SEM^{g} | 0.29 | 0.043 | 0.74 | 0.82 | 0.095 |

^{a}Treatments (2.5% NaCl): C = 100% from flake salt, TRT 1 = 25% salt from SS, 75% salt from flake salt; TRT 2 = 50% salt from SS, 50% salt from flake salt; TRT 3 = 75% salt from SS, 25% salt from flake salt; TRT 4 = 100% salt from SS.
^{b}Hardness = The peak force during the first compression (compressed 72%).
^{c}Springiness = The height the sample recovered during the time that elapses between the end of the first bite and the start of the second bite (both compressed 50%).
^{d}Cohesiveness = The ratio of the positive force area during the second compression (50%) to that during the first compression (50%), calculated as ((Area 2/Area 1) × 100).
^{e}Chewiness = The product of (hardness × cohesiveness × springiness).
^{f}Puncture = The peak force required to break the outer surface/skin of the frankfurter.
^{g}SEM = Standard error of the means for hardness, springiness, cohesiveness, chewiness, and peak external force for emulsified frankfurters.
^{h-j}Means within the same column with different superscripts are different (P < 0.05).

TABLE 3.3
Least squares means for Phase I consumer sensory analysis^{a} for emulsified
frankfurters containing naturally brewed soy sauce (SS: TRTs 1-4) and a
control frankfurter containing no SS (C).

| | Overall | Salty | Overall Taste | | Internal | Meat |
|---|---|---|---|---|---|---|
| TRT^{b} | Liking | Taste | Intensity | Texture | Color | Taste |
| C | 4.43^{f} | 4.25^{f} | 4.38^{g} | 5.67^{d} | 3.19^{h} | 4.55^{e} |
| 1 | 4.85^{de} | 4.57^{e} | 4.71^{f} | 5.00^{e} | 4.00^{g} | 4.95^{d} |
| 2 | 4.83^{de} | 4.63^{de} | 4.94^{f} | 4.81^{e} | 4.33^{f} | 4.97^{d} |
| 3 | 5.04^{d} | 4.77^{de} | 5.29^{e} | 4.41^{f} | 5.05^{e} | 5.06^{d} |
| 4 | 4.53^{ef} | 4.94^{d} | 5.97^{d} | 4.50^{f} | 5.76^{d} | 5.09^{d} |
| SEM^{c} | 0.12 | 0.11 | 0.11 | 0.10 | 0.098 | 0.11 |

^{a}Ranked on a 10 cm line scale with anchors at 1 cm and 9 cm, indicating very little/weak or very much/strong, respectively for overall liking, salty taste, overall taste intensity, and meat taste; indicating very light or very dark for internal color, and indicating very soft or very hard for texture.
^{b}Treatments (2.5% NaCl); C = 100% from flake salt; TRT 1 = 25% salt from SS, 75% salt from flake salt; TRT 2 = 50% salt from SS, 50% salt from flake salt; TRT 3 = 75% salt from SS, 25% salt from flake salt; TRT 4 = 100% salt from SS.
^{c}SEM = standard error of the means for overall liking, salty taste, overall taste intensity, texture, internal color, and meat taste for frankfurters containing SS.
^{d-g}Means within the same column with different superscripts are different (P < 0.05).

The inclusion of SS led to significantly softer texture for all TRTs as compared to C. These differences in texture may be a result of less protein cross-links forming due to salt from SS not being as functional as flake salt. Further, internal color was affected by the addition of SS, as all TRTs containing SS were significantly darker as compared to C. These results agree with the instrumental internal color results for L*, as C was found to be lighter than all TRTs. The inclusion of SS also led to a significant increase in the perceived meat taste, as all TRTs rated higher than C, but were not significantly different from one another.

Demographic questions revealed the following information about panelists participating in this phase of research. Over three replications, 202 panelists answered demographics questions. 49% of panelists were male and 51% were female. 44% of panelists were between ages 18-24, 27% of panelists were between ages 25-34, 11% of panelists were between ages 35-44, 10% of panelists were between ages 45-54, 10% of panelists were between ages 55-64, and 3% of panelists were over age 65.18% of participating panelists were Asian, 70% were Caucasian, 8% were Hispanic, 2% were African American, and 1% were Native American. Of the 202 panelists, 39% consume SS a few times per year, 37% consume SS a few times per month, 8% consume SS once per week, and 17% consume SS at least once per week. 33% of the panelists consume Asian food a few times per year, 40% of panelists consume Asian food a few times a month, 10% of panelists consume Asian food once per week, and 17% of panelists consume Asian food more than once per week.

2.8. Selection of Treatments for Further Investigation (Phases II and III):

Results from Phase I were utilized to determine which TRT would have the greatest efficacy for reducing NaCl levels while maintaining quality and sensory attributes in further research phases. When determining the ideal level of SS usage to continue within further studies, sensory results were taken heavily into consideration, with emphasis on overall liking, taste intensity, and saltiness. Quality results were utilized to support and justify the chosen level. Based upon the results of Phase I for quality and sensory analyses, the 50% salt from SS+50% salt from flake salt TRT was selected as the TRT to move forward with as a baseline for further research phases (II and III).

### 3. Phase II—Sodium Chloride Reduction Using Soy Sauce:

3.1 Proximate Composition:

As a result of raw materials (pork and beef) being individually and uniformly mixed prior to batching and assigning to TRT or C, proximate composition for moisture, fat, and protein were determined on the cooked emulsified frankfurter C samples only. The average moisture content was 58.33% and values ranged from 55.47% to 60.29%. Average fat content was 22.93% and values ranged from 20.20% to 27.09%. Average protein content was 13.96% and values ranged from 13.39% to 14.48%.

3.2 Instrumental Color Measurements:

The least squares means for both external and internal color measurements are displayed in Table 4. External color values for CIE L*, a*, and b* were affected by the addition of SS to frankfurters. L* values were significantly lower for all TRTs as compared to C, indicating that the usage of SS can darken product color. These results are consistent with those found in Phase I, as SS used at the 50% level was significantly different from C in Phase I as well. TRTs 2, 3, and 4 were significantly lower for external color a* value compared to C. External color b* values were significantly higher for all TRTs as compared to C, indicating that the addition of SS led to a more yellowish product.

TABLE 3.4
Least squares means for Phase II instrumental external and internal color, pH, purge, emulsion stability, cook
yield, and salt level for emulsified frankfurters containing naturally brewed soy sauce (SS; TRTs 1-4) and a
control frankfurter containing no SS (C).

| | External^{b} | | | Internal^{b} | | | | Purge^{d} | Emulsion | Cook Yield^{f} | Salt^{g} |
|---|---|---|---|---|---|---|---|---|---|---|---|
| TRT^{a} | L* | a* | b* | L* | a* | b* | pH^{c} | (%) | Stability^{e} (%) | (%) | (%) |
| C | 60.27ⁱ | 17.74ⁱ | 13.53^{k} | 64.16^{l} | 15.85ⁱ | 8.63^{j} | 6.16ⁱ | 0.78^{j} | 9.26ⁱ | 91.79^{j} | 2.41^{l} |
| 1 | 58.71^{j} | 16.89^{jk} | 15.39^{ij} | 62.20^{j} | 15.09^{j} | 11.92ⁱ | 6.07^{j} | 0.78^{j} | 9.40ⁱ | 91.55ⁱ | 2.33^{l} |
| 2 | 58.94^{j} | 16.89^{jk} | 16.10ⁱ | 62.68^{j} | 15.04^{j} | 12.08ⁱ | 6.06^{j} | 0.77ⁱ | 10.73ⁱ | 91.66ⁱ | 2.07^{j} |
| 3 | 57.44^{k} | 17.53^{ij} | 15.48^{ij} | 61.23^{k} | 15.75^{l} | 11.91^{l} | 6.05^{l} | 0.67^{l} | 9.25^{l} | 91.70^{l} | 1.92^{k} |
| 4 | 58.45^{j} | 16.64^{k} | 14.88^{j} | 62.07^{j} | 15.19^{j} | 11.92ⁱ | 6.05^{j} | 1.02^{j} | 12.07^{j} | 91.39^{j} | 1.72^{l} |
| SEM^{h} | 0.27 | 0.33 | 0.77 | 0.45 | 0.14 | 0.27 | 0.022 | 0.12 | 0.99 | 0.21 | 0.041 |

^{a}Treatments: C = 2.5% NaCl, 100% from flake salt; TRT 1 = 2.5% NaCl, 50% salt from SS, 50% salt from flake salt; TRT 2 = 10% reduction in NaCl. 50% salt from SS. 40% salt from flake salt; TRT 3 = 20% reduction in NaCl, 50% salt from SS, 30% salt from flake salt; TRT 4 = 30% reduction in NaCl, 50% salt from SS, 20% salt from flake salt.
^{b}Commission Internationale de l'Eclairage (CIE) L*, a*, b*, where L* = lightness or darkness on a 0 (black) to 100 (white) scale, a* = redness (positive value) or greenness (negative value), or b* = yellowness (positive value) or blueness (negative value).
^{c}pH of fully cooked emulsified frankfurters.
^{d}Percentage of purge in fully cooked emulsified frankfurter product package after two weeks storage at 4° C.
^{e}Emulsion stability of randomly collected raw emulsion = Percentage of total liquid separation, calculated as the summation of percentage of water separation and percentage of total fat separation.
^{f}Percentage cook yield = ((raw weight of frankfurters/cooked weight of frankfurters) × 100)
^{g}Percentage of salt in fully cooked emulsified frankfurters.
^{h}SEM = Standard error means for instrumental external and internal color, pH, percentage purge, emulsion stability, percentage salt, and percentage moisture for emulsified frankfurters.
^{i-l}Means within the same column with different superscripts are different (P < 0.05).

Internal color measurements for CIE L*, a*, and b* were affected by the addition of SS to frankfurters. Internal L* values were significantly lower for all TRTs compared to C. These results indicate that using SS as a source of NaCl can significantly darken the internal color of frankfurters. These results agree with those found in Phase I, and are consistent with the trend in data from the 50% SS+50% flake salt TRT. Internal a* values were significantly lower for TRTs 1, 2, and 4 as compared to C. Internal b* values were significantly higher for all TRTs compared to C, and the values for all TRTs were similar. These values for internal b* indicate that addition of SS to replace NaCl led to an increased yellowish appearance. These results are consistent with those found in Phase I, in which increasing SS content led to darker, less red, and more yellow products. Sofos (1983a) found that no major changes occurred in frankfurter instrumental color measurement results when altering NaCl levels; therefore, it is likely that changes occurring in this experiment likely stem solely from the addition of SS.

3.3 pH Measurements and Processing Attributes:

Least squares means of pH levels of all TRTs were statistically different from C, but were not different from one another (Table 4). The results demonstrate that pH values decreased with addition of SS, which is similar to the trend found in Phase I. The pH of the SS used for this research phase was 4.93, and in turn resulted in a decreasing pH value with increasing SS usage. It was expected that the pH values of TRTs containing SS would differ very little, as a constant amount of SS was added to each TRT.

Various product and processing parameters were recorded during frankfurter production. Raw emulsion pH ranged from 5.73 (TRT 1 and 4) to 5.82 (C). The mean pH of the lean beef and the fat pork trimmings were 5.71 and 6.17, respectively.

3.4 Purge, Emulsion Stability, and Cook Yield Measurements:

Least squares means for purge levels, emulsion stability, and cook yield are listed in Table 4. After two weeks of storage, no significant differences were found for purge levels, and values ranged from 0.67% (TRT 3) to 1.02% (TRT 4). Emulsion stability results revealed no significant differences for any TRTs. Although not significantly different, the percentage of total liquid separation ranged from 9.3% (C and TRT 3) to 12.1% (TRT 4). Cook yield measurements also did not have any significant differences, and values ranged from 91.39% (TRT 4) to 91.79% (C).

Although no other research studies have examined SS to reduce NaCl in processed meats, NaCl reduction has still been heavily studied. Emulsion stability results agree with those of Whiting (1984) who tested the stability of frankfurter batter. Both Whiting's experiment and this study demonstrated that the ability of an emulsion to hold liquid decreased when containing less than 2.0% NaCl; TRT 4 in this study contained 1.75% NaCl by formulation and had the least stable emulsion. The changes in emulsion stability for TRT 4 also concur with results found by Hand and others (1987), as in their study on the effects of chloride salts on frankfurters, a 1.5% NaCl treatment had the most severe losses in emulsion stability compared to both a 2.0% and 2.5% NaCl frankfurters. In their examinations of the stability of reduced NaCl emulsions, Sofos (1983b) and Barbut (1988) also found that emulsion stability decreased with decreasing NaCl content, which is in agreement with the results of this study. The cook yield results of this experiment contradict those found by Sofos (1983b), as his study investigating reduced NaCl frankfurters revealed that decreased NaCl content also decreased cook yield, which did not occur in this study.

3.5 Salt Level Measurements:

The least squares means for salt level measurements are displayed in Table 4. Salt levels of TRTs 2, 3, and 4 varied significantly from C. TRT I was not different from C, as was expected based upon formulations. C and TRT I both had the same ingoing NaCl level, 2.5%, with the only difference stemming from the NaCl source; C was 100% from flake salt and TRT I was 50% from SS+50% from flake salt. Decreases in percentage of NaCl in TRTs 2, 3, and 4 were expected as a result of decreases in ingoing NaCl percentage. TRTs 2, 3, and 4 were formulated to have 2.25%, 2.00%, and 1.75% total NaCl, respectively; measurements showed that the TRTs had 2.07%, 1.92%, and 1.72% NaCl, respectively.

3.6 Instrumental Texture Measurements:

Both textural profile analysis (TPA) and puncture measurements were conducted and the least squares means are listed in Table 5. TPA testing revealed that all TRTs were significantly less hard than C, indicating that the inclusion of SS and the reduction in NaCl content decreased product firmness. All TRTs had significantly lower springiness measurements as compared to C. All TRTs were significantly less cohesive than C, indicating that the decreased NaCl and addition of SS affected product integrity. All TRTs were significantly lower for chewiness measurements than C, indicating that chewiness can be impacted by NaCl reduction and SS addition. Puncture tests demonstrated that TRTs 2, 3, and 4 required significantly less peak force to break the outer skin of the frankfurters as compared to C, likely caused by the decreased level of NaCl present. The decrease in NaCl is likely the most pertinent factor in the puncture testing differences, as TRT I was not significantly different from C. The instrumental texture results of this study agree with those found by Sofos (1983a), whose study determined shear force values of frankfurters decreased significantly with decreasing NaCl content. Results from Hand and others (1987) also support the texture results found in this study, as they tested a 1.5% NaCl treatment which showed a reduced peak force, indicating a softer product can be caused by decreased NaCl content. In this experiment, both the inclusion of SS and decrease in NaCl content affected all textural traits, although not all TRTs were significantly different than C.

TABLE 3.5
Least squares means for Phase II hardness, springiness,
cohesiveness. chewiness, and puncture for emulsified
frankfurters containing naturally brewed soy sauce
(SS: TRTs 1-4) and a control frankfurter containing no SS (C).

| | Hardness^{b} | Springiness^{c} | Cohesiveness^{d} | Chewiness^{e} | Puncture^{f} |
|---|---|---|---|---|---|
| TRT^{a} | (N) | (mm) | (%) | (N × mm) | (N) |
| C | 52.45^{h} | 6.13^{h} | 57.48^{h} | 184.61^{h} | 2.38^{h} |
| 1 | 41.79ⁱ | 5.92ⁱ | 48.82^{ij} | 121.66ⁱ | 2.25^{hi} |
| 2 | 42.16ⁱ | 5.93ⁱ | 48.89^{ij} | 121.61ⁱ | 2.20ⁱ |
| 3 | 39.36^{ij} | 5.88ⁱ | 50.13ⁱ | 116.13ⁱ | 2.15^{ij} |
| 4 | 36.62^{j} | 5.72^{j} | 44.21^{j} | 94.10^{j} | 1.99^{j} |
| SEM^{g} | 0.90 | 0.037 | 1.16 | 5.34 | 0.060 |

^{a}Treatments: C = 2.5% NaCl, 100% from flake salt, TRT 1 = 2.5% NaCl, 50% salt from SS, 50% salt from flake salt; TRT 2 = 10% reduction in NaCl, 50% salt from SS, 40% salt from flake salt; TRT 3 = 20% reduction in NaCl, 50% salt from SS, 30% salt from flake salt; TRT 4 = 30% reduction in NaCl, 50% salt from SS, 20% salt from flake salt.
^{b}Hardness = The peak force during the first compression (compressed 72%).
^{c}Springiness = The height the sample recovered during the time that elapses between the end of the first bite and the start of the second bite (both compressed 50%).
^{d}Cohesiveness = The ratio of the positive force area during the second compression (50%) to that during the first compression (50%), calculated as ((Area 2/Area 1) × 100).
^{e}Chewiness = The product of (hardness × cohesiveness × springiness).
^{f}Puncture = The peak force required to break the outer surface/skin of the frankfurter.
^{g}SEM = Standard error of the means for hardness, springiness, cohesiveness, chewiness, and peak external force for emulsified frankfurters.
^{h-j}Means within the same column with different superscripts are different (P < 0.05).

3.7 Consumer Sensory Analysis and Demographics:

The least squares means for sensory analysis results are presented in Table 6. Overall liking was impacted by the addition of soy sauce. TRTs 2 and 3 were liked significantly more than C. No significant difference existed between C, TRT 1 and 4. TRTs 1 and 2 were perceived as significantly saltier than C. TRT 3, with a 20% reduction in NaCl content not significantly different for saltiness than C; while TRT 4 with a 30% NaCl reduction was significantly lower in saltiness than C. The sensory saltiness results indicate that with the use of SS, at least a 20% reduction in total NaCl content is feasible in frankfurters.

Overall taste intensity was also increased by the addition of SS, as all TRTs were rated significantly more intense tasting than C, despite a decrease in NaCl content in TRTs 2, 3, and 4. The inclusion of SS, as well as the reduction of NaCl, led to a significantly softer texture for all TRTs as compared to C. Textural sensory results concur with those found by Sofos (1983a) in the evaluation of reduced NaCl frankfurters, as both studies have suggested that texture is less acceptable to consumers when formulations contain below 2.0% NaCl. TRT 4, which had 30% NaCl reduction, was rated as having the softest texture. These results agree with those found in the instrumental texture evaluation. Internal color was affected by the addition of SS, as all TRTs containing SS were significantly darker than C. Instrumental internal color results for L* support sensory internal color results, as C was found to be lighter than all TRTs in both instances. Only TRT I was ranked significantly higher in meat taste than C, however, no statistical differences existed between any TRTs.

TABLE 3.6
Least squares means for Phase II consumer sensory analysis^{a} of emulsified
frankfurters containing naturally brewed soy sauce (SS; TRTs 1-4) and a
control frankfurter containing no SS (C).

| | Overall | Salty | Overall Taste | | Internal | Meat |
|---|---|---|---|---|---|---|
| TRT^{b} | Liking | Taste | Intensity | Texture | Color | Taste |
| C | 4.89^{e} | 4.76^{f} | 4.93^{f} | 5.68^{d} | 3.62^{f} | 5.00^{e} |
| 1 | 5.20^{de} | 5.48^{d} | 6.02^{d} | 4.62^{f} | 5.19^{d} | 5.33^{d} |
| 2 | 5.26^{d} | 5.11^{e} | 5.77^{d} | 4.67^{f} | 4.93^{e} | 5.18^{de} |
| 3 | 5.36^{d} | 4.61^{fg} | 5.30^{e} | 4.96^{e} | 5.31^{d} | 5.15^{de} |
| 4 | 5.11^{de} | 4.38^{g} | 5.34^{e} | 4.02^{g} | 5.10^{de} | 5.05^{de} |
| SEM^{c} | 0.11 | 0.10 | 0.10 | 0.095 | 0.091 | 0.11 |

^{a}Ranked on a 10 cm line scale with anchors at 1 cm and 9 cm, indicating very little/weak or very much/strong, respectively for overall liking, salty taste, overall taste intensity, and meat taste; indicating very light or very dark for internal color; arid indicating very soft or very hard for texture.
^{b}Treatments: C = 2.5% NaCl, 100% from flake salt; TRT 1 = 2.5% NaCl, 50% salt from SS, 50% salt from flake salt; TRT 2 = 10% reduction in NaCl, 50% salt from SS, 40% salt from flake salt; TRT 3 = 20% reduction in NaCl, 50% salt from SS, 30% salt from flake salt; TRT 4 = 30% reduction in NaCl, 50% salt from SS, 20% salt from flake salt.
^{c}SEM = standard error of the means for consumer sensory data for frankfurters containing SS.
^{d-g}Means within the same column with different superscripts are different (P < 0.05).

Demographic questions revealed the following information about panelists participating in this phase's sensory panels. Over three replications, 214 panelists answered demographics questions. 53% of panelists were male and 47% were female. 37% of panelists were between ages 18-24, 34% of panelists were between ages 25-34, 9% of panelists were between ages 35-44, 11% of panelists were between ages 45-54, 7% of panelists were between ages 55-64, and 2% of panelists were over age 65.19% of participating panelists were Asian, 71% were Caucasian, 8% were Hispanic, and 2% were African American. Of the 214 panelists, 39% consume SS a few times per year, 37% consume SS a few times per month, 10% consume SS once per week, and 14% consume SS at least once per week. 31% of the panelists consume Asian food a few times per year, 42% of panelists consume Asian food a few times a month, 8% of panelists consume Asian food once per week, and 19% of panelists consume Asian food more than once per week.

### 4. Phase III—Sodium Reduction Using Soy Sauce:

4.1 Proximate Composition:

Raw materials (pork and beef) were individually and uniformly mixed before batching and being assigned to either TRT or C; because of this, proximate composition for moisture, fat, and protein were determined for the emulsified frankfurter C samples only. The average moisture content was 55.64% and values ranged from 53.71% to 56.23%. Average fat content was 24.54% and values ranged from 22.91% to 28.92%. Average protein content was 13.21% and values ranged from 12.69% to 13.76%.

4.2 Instrumental Color Measurements:

The least squares means for both external and internal color measurements of the emulsified frankfurters are displayed in Table 7. External color values for CIE L*, a*, and b* were affected by the addition of SS to frankfurters. L* values were significantly lower for all TRTs as compared to C, indicating that the usage of SS darkened external product color. These results are consistent with those found in Phase I and II, in which external product lightness also decreased with SS addition. External color a* values were significantly lower for TRT I as compared to C; however, TRT I was not different from TRTs 2, 3, and 4. Despite not being significantly different from C, a* values of TRTs 2, 3, and 4 were lower than that of C, which indicated a less red product. External color b* values were significantly higher for all TRTs as compared to C, indicating, as in prior phases that the addition of SS led to a more yellowish product.

Internal color measurements were affected by the addition of SS to frankfurters.

Internal L* values were significantly lower for all TRTs compared to C; however, TRTs were not different from one another. These results indicate that using SS as a source of NaCl can significantly darken the internal color of frankfurters; this is consistent with results found in Phase I and II. Internal a* values were significantly lower for TRT 3 as compared to C. All TRTs containing SS were not different from each other and showed a similar trend to that of Phase I and Phase II, as all a* values were indicative of lower redness. Internal b* values were significantly higher for all TRTs compared to C. These values for internal b* indicate that addition of SS to replace NaCl at leads to an increased yellowish appearance, which supports results from Phase I and Phase II that also showed increased yellowness in SS containing TRTs.

TABLE 3.7
Least squares means for Phase III instrumental external and internal color, pH, purge, emulsion stability, processing
yield, and salt level for emulsified frankfurters containing naturally brewed soy sauce (SS; TRTs 1-4) and a
non-SS control (C).

| | External^{b} | | | Internal^{b} | | | | Purge^{d} | Emulsion | Processing | Salt^{f} |
|---|---|---|---|---|---|---|---|---|---|---|---|
| TRT^{a} | L* | a* | b* | L* | a* | b* | pH^{c} | (%) | Stability^{e} (%) | Yield^{f} (%) | (%) |
| C | 63.25ⁱ | 16.45ⁱ | 13.54^{k} | 67.57ⁱ | 14.70ⁱ | 8.65^{j} | 6.2ⁱ | 0.81ⁱ | 7.18ⁱ | 91.10ⁱ | 2.5 |
| 1 | 60.89^{j} | 15.87^{j} | 15.32^{j} | 65.02^{j} | 14.33^{ij} | 12.86ⁱ | 6.0^{k} | 0.80ⁱ | 8.04ⁱ | 90.60ⁱ | 2.5 |
| 2 | 60.87^{j} | 15.91^{ij} | 15.27^{j} | 64.91^{j} | 14.36^{ij} | 12.72ⁱ | 6.1^{jk} | 0.81ⁱ | 8.31ⁱ | 91.15ⁱ | 1.9* |
| 3 | 61.42^{j} | 16.11^{ij} | 15.65^{ij} | 64.82^{j} | 14.26^{j} | 12.74ⁱ | 6.1^{ij} | 0.81ⁱ | 8.40ⁱ | 91.13ⁱ | 1.6* |
| 4 | 61.44^{j} | 16.17^{ij} | 16.52ⁱ | 64.64^{j} | 14.38^{ij} | 12.90ⁱ | 6.1^{ij} | 0.78ⁱ | 8.91ⁱ | 91.18ⁱ | 1.2* |
| SEM^{h} | 0.54 | 0.57 | 0.25 | 0.24 | 0.29 | 0.24 | 0.019 | 0.092 | 0.49 | 0.40 | — |

^{a}Treatments: C = 2.5% ingoing NaCl, 100% from flake salt; TRT 1 = 2.5% ingoing NaCl: 50% NaCl from SS, 50% NaCl from flake salt; TRT 2 = 20% reduction in Na: 50% NaCl from SS, 30% NaCl from flake salt, 20% replacement of NaCl with KCl; TRT 3 = 35% reduction in Na: 50% NaCl from SS, 15% NaCl from flake salt, 35% NaCl replacement with KCl; TRT 4 = 50% reduction in Na: 50% NaCl from SS, 50% replacement of NaCl with KCl.
^{b}Commission Internationale de l'Eclairage (CIE) L*, a*, b*, where L* = lightness, a* = redness, and b* = yellowness on a 0-100 white scale.
^{c}pH of fully cooked emulsified frankfurters.
^{d}Purge measured after two weeks storage at 4° C.
^{e}Stability of raw frankfurter emulsion (total liquid separation = water + fat separation).
^{f}Percentage processing yield = ((raw weight/cooked weight) × 100).
^{g}Percentage of salt in fully cooked emulsified frankfurters.
^{h}SEM = Standard error of the means.
^{i-k}Means within the same column with different superscripts are different (P < 0.05).
*Indicates values were calculated based on C and TRT 1 as they could not be measured using the Quantab method due to KCl content.

4.3 pH Measurements and Processing Attributes:

The least squares means for pH measurements are displayed in Table 7. The pH levels of TRTs 1 and 2 were statistically different than C, but were not different from one another. All TRT pH values were lower than C, showing a trend of decreased pH with the inclusion of SS. These results support those of Phase I and II, in which pH decreased with addition of SS, and are consistent with what was expected. SS used in this phase had a pH of 4.58. It could be postulated that the values of TRTs containing SS would not be different, as a constant amount of SS was added to each TRT, yet this did not occur.

Various product and processing parameters were recorded during the production of the frankfurters. Raw emulsion pH ranged from 5.75 (TRT 1) to 5.93 (C). The mean pH of the lean beef and the fat pork trimmings were 5.76 and 6.12, respectively.

4.4 Purge, Emulsion Stability, and Cook Yield Measurements:

The least squares means for purge levels, emulsion stability, and cook yield measurements are listed in Table 7. No significant differences were found for purge levels after two weeks of refrigerated storage; however, purge values ranged from 0.78% (TRT 4) to 0.81% (C, TRT 2, and 3). No significant differences in emulsion stability were observed between any TRTs or C. Percentage total liquid separation ranged from 7.2% (C) to 8.9% (TRT 4). No significant differences existed between C and any TRTs. Cook yield measurements ranged from 90.60% (TRT 1) to 91.18% (TRT 4).

Seman and others (1980) established emulsion stability results in bologna that demonstrated a similar trend in that no differences were found between controls and treatments containing NaCl and KCl. Arganosa and Marriot (1990) replaced NaCl with KCl in restructured ham at a 50% level and found no differences in cook yield compared to a 100% NaCl treatment. Seman and others (1980) also concluded that no differences existed for cook yield when bologna was formulated for NaCl replacement using KCl. The results of this experiment are in agreement with the results found by Arganosa and Marriot (1990) as well as Seman and others (1980).

4.5 Salt Level Measurements:

The values for salt level measurements are displayed in Table 7. Salt levels of TRTs 2, 3, and 4 were lower than those of C and TRT 1. Statistical analysis was not performed for TRTs 2, 3, or 4 salt measurement data due to the fact that the values were extrapolated based on C and TRT 1. These values were extrapolated because the NaCl measurement system that was used measured the presence of chloride ions and was unable to distinguish between chloride ions coming from NaCl and chloride ions coming from KCl, and therefore, any measurements would have been inaccurate for NaCl content.

4.6 Instrumental Texture Measurements:

Both textural profile analysis (TPA) and puncture measurement least squares means are listed in Table 8. TPA testing revealed that all TRTs were significantly less hard than C, indicating that the inclusion of SS and reduction in NaCl content can decrease product hardness. TRT 3 was significantly lower in springiness measurements as compared to C. No significant differences were found for cohesiveness or chewiness. Puncture testing demonstrated that TRTs 2, 3, and 4 required significantly less peak force to break the outer skin of the frankfurters compared to C, similar to those results of Phase II. Research conducted by Whiting and Jenkins (1981) suggested that frankfurter texture was unaffected by changes in ratios of NaCl to KCl, which may indicate that textural differences found in this study stem solely from the addition of SS. Seman and others (1980) presented contradictory results using bologna to both this research and Whiting and Jenkins (1981) results, suggesting that the addition of KCl led to higher textural hardness values. Results of Hand and others (1982) are in agreement with results from this study, as they found a frankfurter treatment containing 65% NaCl and 35% KCl to be less firm than a control throughout a six week storage period; this suggests that textural differences could be caused by a combination of the changes in amount of added KCl and SS.

TABLE 3.8
Least squares means for Phase III hardness, springiness,
cohesiveness. chewiness, and puncture for emulsified
frankfurters containing naturally brewed soy sauce
(SS: TRTs 1-4) and a control frankfurter containing no SS (C).

| | Hardness^{b} | Springiness^{c} | Cohesiveness^{d} | Chewiness^{e} | Puncture^{f} |
|---|---|---|---|---|---|
| TRT^{a} | (N) | (mm) | (%) | (N × mm) | (N) |
| C | 53.46^{h} | 5.99^{h} | 55.88^{h} | 179.40^{h} | 2.07^{h} |
| 1 | 42.81ⁱ | 5.82^{hi} | 53.32^{h} | 132.89ⁱ | 1.98^{h} |
| 2 | 39.60^{ij} | 5.82^{hi} | 53.59^{h} | 124.21ⁱ | 1.69ⁱ |
| 3 | 34.78ⁱ | 5.65ⁱ | 53.48^{h} | 104.92^{j} | 1.76ⁱ |
| 4 | 42.79ⁱ | 5.72^{hi} | 55.48^{h} | 135.54ⁱ | 1.74ⁱ |
| SEM^{g} | 1.98 | 0.091 | 1.11 | 5.77 | 0.058 |

^{a}Treatments: C = 2.5% NaCl, 100% from flake salt, TRT 1 = 2.5% NaCl, 50% salt from SS, 50% salt from flake salt; TRT 2 = 10% reduction in Na, 50% salt from SS, 30% salt from flake salt, 20% salt from KCl; TRT 3 = 35% reduction in Na, 50% salt from SS, 15% salt from flake salt, 35% from KCl; TRT 4 = 50% reduction in Na, 50% salt from SS, 50% salt from KCl.
^{b}Hardness = The peak force during the first compression (compressed 72%).
^{c}Springiness = The height the sample recovered during the time that elapses between the end of the first bite and the start of the second bite (both compressed 50%).
^{d}Cohesiveness = The ratio of the positive force area during the second compression (50%) to that during the first compression (50%), calculated as ((Area 2/Area 1) × 100).
^{e}Chewiness = The product of (hardness × cohesiveness × springiness).
^{f}Puncture = The peak force required to break the outer surface/skin of the frankfurter.
^{g}SEM = Standard error of the means for hardness, springiness, cohesiveness, chewiness, and peak external force for emulsified frankfurters.
^{h-j}Means within the same column with different superscripts are different (P < 0.05).

4.7 Consumer Sensory Analysis and Demographics:

The least squares means for sensory analysis results are presented in Table 9. Overall liking was impacted by the addition of SS, use of KCl, and reduction in NaCl. Both TRTs 1 and 2 were liked significantly more than C. No significant difference existed between C, TRT 3, and TRT 4. TRT 1 was liked equivalently to TRTs 2 and 3. TRT 1 was perceived as significantly saltier than C. TRTs 2, 3, and 4, with a 20%, 35%, and 50% reduction in sodium, respectively, were not statistically different than C; however, TRTs 2 and 3 were rated as tasting saltier than C. TRT 4 was rated as less salty than all other TRTs. These results support the findings herein that umami-containing substances possess the ability to enhance saltiness. All TRTs were rated as having significantly greater overall taste intensity in comparison to C. Bitterness was tested because of the inclusion of KCl in some TRTs. TRTs 3 and 4, were found to be significantly more bitter than C. Numerous research studies suggest that 50% may be the upper limit for KCl usage. In this research, the 50% KCl usage level produced the highest bitterness rating of all TRTs. The inclusion of SS, as well as the reduction of sodium, led to significantly softer texture for all TRTs as compared to C. TRT 4, which had 50% sodium reduction, was rated as having the softest texture. These results are supported by those from the instrumental texture evaluation, as well as sensory results from Phase I and II. Internal color was affected by the addition of SS, as all TRTs containing SS were significantly darker as compared to C, yet TRTs were not found different from one another. Instrumental internal color results support the sensory internal color results, as C was found to be lighter than all TRTs. No significant differences were found between C and any TRTs for meat taste. In studies that have been conducted that replace NaCl with KCl, the conclusions generally indicate that the addition of KCl can lead to off flavors or bitterness, but does not influence other sensory characteristics. This further suggests that differences from C, aside from bitterness, stem from the addition of SS and not KCl.

TABLE 3.9
Least squares means for Phase III consumer sensory analysis^{a} of
emulsified frankfurters containing naturally brewed soy sauce
(SS; TRTs 1-4) and a control frankfurter containing no SS (C).

| | | | Overall | | | | |
|---|---|---|---|---|---|---|---|
| | Overall | Salty | Taste | Bitter- | | Internal | Meat |
| TRT^{b} | Liking | Taste | Intensity | ness | Texture | Color | Taste |
| C | 4.51^{ef} | 4.57^{ef} | 4.52^{g} | 2.51^{f} | 5.59^{d} | 3.27^{e} | 4.73^{de} |
| 1 | 5.04^{d} | 5.19^{d} | 5.95^{d} | 2.86^{def} | 4.44^{e} | 4.85^{d} | 4.93^{de} |
| 2 | 4.89^{d} | 4.70^{e} | 5.11^{ef} | 2.67^{ef} | 4.32^{ef} | 4.59^{d} | 4.80^{de} |
| 3 | 4.87^{de} | 4.74^{e} | 5.41^{e} | 2.89^{de} | 4.17^{ef} | 4.87^{d} | 4.99^{d} |
| 4 | 4.48^{f} | 4.25^{f} | 4.94^{f} | 3.15^{d} | 4.09^{f} | 4.65^{d} | 4.64^{e} |
| SEM^{c} | 0.13 | 0.13 | 0.12 | 0.13 | 0.12 | 0.11 | 0.12 |

^{a}Ranked on a 10 cm line scale with anchors at 1 cm and 9 cm, indicating very litte/weak or very much/strong, respectively for overall liking, salty taste, overall taste intensity, bitterness, and meat taste; indicating very light or very dark for internal color; and indicating very soft or very hard for texture.
^{b}Treatments: C = 2.5% NaCl, 100% from flake salt; TRT 1 = 2.5% NaCl, 50% salt from SS, 50% salt from flake salt; TRT 2 = 20% reduction in Na, 50% salt from SS, 30% salt from flake salt, 20% salt from KCl; TRT 3 = 35% reduction in Na, 50% salt from SS, 15% salt from flake salt, 35% salt from KCl: TRT 4 = 50% reduction in Na, 50% salt from SS, 50% salt from KCl.
^{c}SEM = standard error of the means for overall liking, salty taste, overall taste intensity, bitterness, texture, internal color, and meat taste for emulsified frankfurters.
^{d-g}Means within the same column with different superscripts are different (P < 0.05).

Demographic questions revealed the following information about panelists participating in this phase of research. Over three replications, 166 panelists answered demographics questions. 55% of panelists were male and 45% were female. 39% of panelists were between ages 18-24, 33% of panelists were between ages 25-34, 13% of panelists were between ages 35-44, 6% of panelists were between ages 45-54, 7% of panelists were between ages 55-64, and 2% of panelists were over age 65.23% of participating panelists were Asian, 65% were Caucasian, 8% were Hispanic, 1% were African American, and 2% were Native American. Of the 166 panelists, 42% consume SS a few times per year, 29% consume SS a few times per month, 14% consume SS once per week, and 14% consume SS at least once per week. 35% of the panelists consume Asian food a few times per year, 33% of panelists consume Asian food a few times a month, 13% of panelists consume Asian food once per week, and 19% of panelists consume Asian food more than once per week.

### 5. Conclusions for Using Soy Sauce to Reduce Sodium Content:

Varying levels of SS were investigated as a means to replace and reduce sodium in emulsified frankfurters through three phases of research. The non-SS containing control, with 2.5% salt from flake salt, possessed characteristics typical of an industry-standard frankfurter throughout all research phases.

Phase I results indicated 50% salt from SS+50% salt from flake salt was the optimum formulation to utilize as a baseline to continue with in studying alterations in sodium content. In Phase II, both quality and sensory results indicated that 50% salt from SS+30% salt from flake salt (20% NaCl reduction) is at least one appropriate and feasible formulation for industrial applications of SS to aid in sodium reduction. Resulting in 2.00% total NaCl in the finished product, this formulation provided no major impacts on quality attributes, while delivering sensory traits that were equivalent or improved as compared to C. Phase III results indicated that the most successful formulation, 50% salt from SS+15% salt from flake salt+35% KCl, was apparent, with a 35% sodium reduction, delivering 1.60% total NaCl in the finished product. This is another appropriate and feasible formulation for industrial application of SS in producing processed meat products with significantly reduced sodium content, yet with very high palatability. All research phases indicated that it is, in fact, feasible to utilize SS to replace a portion of NaCl in frankfurters. This research also demonstrated that SS possesses the ability to increase consumer sensory overall liking, salty taste perception, and overall taste intensity. Phase III results suggested that SS has the ability to attenuate bitterness at least up to about 35% KCl usage level, at which point bitterness increased in the sensory panels.

### 6. Phase I—Sodium Chloride Replacement Using Natural Flavor Enhancer:

6.1 Proximate Composition:

Because raw materials (pork and beef) were individually mixed until uniform before batching and assignment as C or TRT, proximate composition for moisture, fat, and protein were only determined for the emulsified frankfurter C samples. The average moisture content was 57.13% and values ranged from 56.71% to 57.66%. Average fat content was 22.71% and values ranged from 21.21% to 23.86%. Average protein content was 13.21% and values ranged from 13.08% to 13.68%.

6.2 Instrumental Color Measurements:

External and internal color measurements were conducted and the least squares means are displayed in Table 10. External color values for CIE L*, a*, and b* were affected by the addition of NFE to frankfurters. L* values were significantly lower for all TRTs as compared to C, indicating that the usage of NFE at 25%, 50%, 75% or 100% of NaCl can darken product color. External color a* values were significantly lower for TRT 3 as compared to C, indicating that the usage of SS at 75% salt levels led to a less red color. External color b* values were significantly higher for TRTs 3 and 4 compared to C, indicating that the usage of NFE at 75% and 100% salt levels led to a more yellow product.

Internal color measurements for CIE L*, a*, and b* were also affected by the addition of NFE to frankfurters. Internal L* values were significantly lower for all TRTs compared to C. These results indicate that the addition of any tested level of NFE as a NaCl source can significantly darken the internal color of frankfurters. Internal a* values were not significantly different for C or any TRTs, suggesting that NFE did not contribute to a decrease in internal redness. This may be due to NFE possessing a lighter color itself (November 2010 personal communication, unreferenced). Internal b* values were significantly higher for all TRTs compared to C, and yellowness values increased with increasing NFE addition. These values for internal b* indicate that addition of NFE to replace NaCl at any level tested can led to an increased yellowish appearance. Overall, the usage of NEE can affect both internal and external color attributes.

6.3 pH Measurements and Processing Attributes:

The least squares means for pH values are displayed in Table 10. All TRTs had significantly lower pH as compared to C. These results demonstrate a pattern of decreasing pH values with increasing addition of NFE. This trend is consistent with the expected results, as the pH of the NFE that was used for this experiment had a pH value of 5.20.

Various product and processing parameters were recorded during the production of the emulsified frankfurters. Raw emulsion pH ranged from 5.76 (TRT 4) to 5.87 (C). The mean pH of the lean beef and the fat pork trimmings were 5.64 and 6.16, respectively.

TABLE 4.1
Least squares means for Phase I objective external and internal color, pH, purge, emulsion stability, cook yield, and salt
levelfor emulsified frankfurters containing natural flavor enhancer (NFE; TRTs 1-4) and a control frankfurters
containing no NFE (C).

| | External^{b} | | | Internal^{b} | | | | Purge^{d} | Emulsion | Cook | Salt^{g} |
|---|---|---|---|---|---|---|---|---|---|---|---|
| TRT^{a} | L* | a* | b* | L* | a* | b* | pH^{c} | (%) | Stability^{e} (%) | Yield^{f} (%) | (%) |
| C | 61.56ⁱ | 17.06ⁱ | 12.71^{j} | 65.82ⁱ | 15.60ⁱ | 8.72^{f} | 6.06ⁱ | 0.92ⁱ | 7.24^{j} | 91.60^{j} | 2.39ⁱ |
| 1 | 59.85^{jk} | 17.47ⁱ | 12.93^{j} | 63.39^{j} | 16.14ⁱ | 9.85^{k} | 5.89ⁱ | 0.93ⁱ | 8.71^{ij} | 91.66^{j} | 2.39ⁱ |
| 2 | 59.13^{kl} | 17.29ⁱ | 13.63^{ij} | 61.66^{l} | 16.13ⁱ | 10.50^{jk} | 5.85^{j} | 1.26^{j} | 7.93^{j} | 92.83^{ij} | 2.39ⁱ |
| 3 | 60.50^{j} | 15.93^{j} | 14.44ⁱ | 62.43^{k} | 15.68ⁱ | 11.92ⁱ | 5.76^{k} | 1.14ⁱ | 8.46^{j} | 93.35ⁱ | 2.41ⁱ |
| 4 | 58.21^{l} | 16.65^{ij} | 14.37^{j} | 60.21^{m} | 15.85ⁱ | 12.38ⁱ | 5.70^{k} | 1.13ⁱ | 10.72ⁱ | 92.55^{ij} | 2.34ⁱ |
| SEM^{h} | 0.37 | 0.44 | 0.78 | 0.31 | 0.20 | 0.17 | 0.034 | 0.14 | 1.08 | 0.37 | 0.045 |

^{a}Treatments (2.5% NaCl): C = 100% salt from flake salt; TRT 1 = 25% salt from NFE, 7.5% salt from flake salt; TRT 2 = 50% salt from NFE, 50% salt from flake salt; TRT 3 = 75% salt from NFE, 25% salt from flake salt; TRT 4 = 100% salt from NFE.
^{b}Commission Internationale de l'Eclairage (CIE) L*, a*, b*, where L* = lightness or darkness on a 0 (black) to 100 (white) scale, a* = redness (positive value) or greenness (negative value), or b* = yellowness (positive value) or blueness (negative value).
^{c}pH of fully cooked emulsified frankfurters.
^{d}Percentage of purge in fully cooked emulsified frankfurter product package after two weeks storage at 4° C.
^{e}Emulsion stability of randomly collected raw emulsion = Percentage of total liquid separation, calculated as the summation of percentage of water separation and percentage of total fat separation.
^{f}Percentage cook yield = ((raw weight of frankfurters/cooked weight of frankfurters) × 100)
^{g}Percentage of salt in fully cooked emulsified frankfurters.
^{h}SEM = Standard error means for objective external and internal color, pH, percentage purge, emulsion stability, percentage salt, and percentage moisture for emulsified frankfurters.
^{i-m}Means within the same column with different superscripts are different (P < 0.05).

6.4 Purge, Emulsion Stability, and Cook Yield Measurements:

The least squares means for purge levels, emulsion stability, and cook yield measurements are listed in Table 10. No significant differences were found for purge levels at two weeks storage of refrigerated storage, and values ranged from 0.92% (C) to 1.26% (TRT 2). Emulsion stability results revealed that TRT 4 had significantly more total liquid separation than C. The percentage of total liquid separation ranged from 7.2% (C) to 10.7% (TRT 4). TRT 4 contained the highest level of NFE, with all salt coming from NFE, suggesting that increased NFE may decrease emulsion stability. It is also possible that emulsion stability decreased due to TRT 4 having a slightly lower salt content (Table 10). Cook yield measurements demonstrated that TRT 3 had a significantly higher cook yield than C. Measurements ranged from 91.60% (C) to 93.35% (TRT 3). TRT 3 having a slightly higher cook yield may also result from TRT 3 having a slightly higher salt content than other TRTs (Table 10).

As a result of the ingoing NaCl content remaining constant between C and TRTs (2.5%), it is not surprising that few differences were found for emulsion stability, cook yield, and purge when the source of NaCl was changed from flake salt to NFE. This is due to the role that NaCl has in the extraction of protein to bind water, fat, and other protein. Research conducted by Sofos (1983b) determined that frankfurters produced with 2.5% NaCl produced stable emulsions with high cook yields. Hand and others (1987) also demonstrated that frankfurters made with 2.5% NaCl produced a stable emulsion. The results from both these experiments are in agreement with the results of this study despite the few differences that were found for emulsion stability and cook yield.

6.5 Salt Level Measurements:

The least squares means for salt level measurements are displayed in Table 10. No significant differences were found for salt level for C or any TRTs. Salt values ranged from 2.34% (TRT 4) to 2.41% (TRT 3), and are close to expected values, as C and all TRTs were formulated with 2.5% ingoing NaCl. These results help support that NaCl coming from NFE is functional in a meat emulsion system.

6.6 Instrumental Texture Measurements:

Textural profile analysis (TPA) and puncture measurements were conducted and the least squares means are listed in Table 11. TPA testing revealed that C was significantly harder than TRTs 2, 3, and 4. A trend of decreasing hardness with increasing NFE content existed, suggesting that the presence of NFE can impact textural integrity despite a constant NaCl content. Both TRTs 3 and 4 were significantly lower for springiness and cohesiveness as compared to C. TRTs 2, 3, and 4 were significantly less chewy than C. Puncture testing demonstrated that TRTs 2, 3, and 4 required significantly less peak force to break the outer skin of the frankfurters as compared to C.

6.7 Consumer Sensory Analysis and Demographics:

The least squares means for sensory analysis results are presented in Table 12. Overall liking was impacted by the addition of NFE, as all TRTs were liked significantly more than C. No significant difference existed between TRTs. All TRTs containing NFE were perceived as significantly saltier than C, with a trend of saltiness ratings increasing with the amount of added NFE. TRT 4 containing 100% salt from NFE was rated as significantly saltier than all other TRTs. The sensory saltiness results indicate that the inclusion of NFE allows for an increase in the perceived salty taste. These results agree with those found by Kremer and others (2009), as they discovered that the inclusion of soy sauce to salad dressings, tomato soup, and stir-fried pork could cause an increase in salty taste. The increase in perceived saltiness caused by the inclusion of NFE also supports the idea that umami substances, such as NFE, can lead to an increase in perceived saltiness (Fuke and Ueda 1996; Keast and Breslin 2002). Overall taste intensity was also increased by the addition of NFE, as all TRTs rated significantly higher for taste intensity than C. Taste intensity, as with saltiness, increased with the addition level of NFE. The taste intensity results also agree with the results found by Kremer and others (2009), as they found that inclusion of soy sauce could lead to increased taste intensity.

The inclusion of NFE led to significantly softer texture for TRTs 2, 3, and 4 as compared to C. Instrumental texture results support the sensory results, as the same trend existed for the objective measurements. These changes in texture may be due to a reduced number of protein cross links being formed, possibly due to salt from NFE not being as functional as flake salt. Further, internal color was affected by the addition of NFE, as all TRTs containing NFE were significantly darker compared to C. TRTs were rated as darker in color as NFE content increased. Consumer sensory results for internal color are in agreement with results from objective color testing, as the objective tests also indicated that the addition of NFE resulted in darker product colors. The inclusion of NFE also led to a significant increase in the perceived meat taste, as TRTs 2, 3, and 4 rated higher than C, but were not significantly different from one another.

Demographic questions revealed the following information about panelists participating in this phase of research. Over three replications, 239 panelists answered demographics questions. 50% of panelists were male and 50% were female. 28% of panelists were between ages 18-24, 25% of panelists were between ages 25-34, 8% of panelists were between ages 35-44, 19% of panelists were between ages 45-54, 18% of panelists were between ages 55-64, and 1% of panelists were over age 65.15% of participating panelists were Asian, 37% were Caucasian, 10% were Hispanic, 29% were African American, 8% were Native American, and 1% were Pacific Islanders. Of the 239 panelists, 28% consume soy sauce (SS) a few times per year, 24% consume 55 a few times per month, 21% consume SS once per week, and 28% consume SS at least once per week. 23% of the panelists consume Asian food a few times per year, 27% of panelists consume Asian food a few times a month, 24% of panelists consume Asian food once per week, and 26% of panelists consume Asian food more than once per week.

TABLE 4.2
Least squares means for Phase I hardness, springiness,
cohesiveness. chewiness, and puncture for emulsified
frankfurters containing naturally flavor enhancer
(NFE: TRTs 1-4) and a control frankfurter containing no NFE (C).

| | Hardness^{b} | Springiness^{c} | Cohesiveness^{d} | Chewiness^{e} | Puncture^{f} |
|---|---|---|---|---|---|
| TRT^{a} | (N) | (mm) | (%) | (N × mm) | (N) |
| C | 50.89^{h} | 5.91^{h} | 60.01^{h} | 180.52^{h} | 2.24^{h} |
| 1 | 46.53^{h} | 5.94^{h} | 58.25^{hi} | 160. 38^{h} | 2.31^{h} |
| 2 | 41.43ⁱ | 5.85^{h} | 56.17^{hi} | 136.05ⁱ | 1.88ⁱ |
| 3 | 37.84^{ij} | 5.63ⁱ | 54.53ⁱ | 116.32ⁱ | 1.73ⁱ |
| 4 | 35.16ⁱ | 5.63ⁱ | 47.65^{j} | 95.22ⁱ | 1.91ⁱ |
| SEM^{g} | 1.22 | 0.073 | 3.71 | 7.57 | 0.059 |

^{a}Treatments (2.5% NaCl): C = 100% from flake salt, TRT 1 = 25% salt from NFE, 75% salt from flake salt; TRT 2 = 50% salt from NFE, 50% salt from flake salt; TRT 3 = 75% salt from NFE, 25% salt from flake salt; TRT 4 = 100% salt from NFE.
^{b}Hardness = The peak force during the first compression (compressed 72%).
^{c}Springiness = The height the sample recovered during the time that elapses between the end of the first bite and the start of the second bite (both compressed 50%).
^{d}Cohesiveness = The ratio of the positive force area during the second compression (50%) to that during the first compression (50%), calculated as ((Area 2/Area 1) × 100).
^{e}Chewiness = The product of (hardness × cohesiveness × springiness).
^{f}Puncture = The peak force required to break the outer surface/skin of the frankfurter.
^{g}SEM = Standard error of the means for hardness, springiness, cohesiveness, chewiness, and peak external force for emulsified frankfurters.
^{h-j}Means within the same column with different superscripts are different (P < 0.05).

TABLE 4.3
Least squares means for Phase I consumer sensory analysis^{a} of emulsified
frankfurters containing natural flavor enhancer (NFE: TRTs 1-4) and a
control frankfurter containing no NFE (C).

| | Overall | Salty | Overall Taste | | Internal | Meat |
|---|---|---|---|---|---|---|
| TRT^{b} | Liking | Taste | Intensity | Texture | Color | Taste |
| C | 4.82^{e} | 4.48^{g} | 4.73^{g} | 5.47^{d} | 3.84^{g} | 4.96^{e} |
| 1 | 5.13^{d} | 4.83^{f} | 5.22^{f} | 5.32^{d} | 4.55^{f} | 5.19^{de} |
| 2 | 5.36^{d} | 5.23^{e} | 5.58^{e} | 4.99^{e} | 5.29^{e} | 5.33^{d} |
| 3 | 5.19^{d} | 5.29^{e} | 5.63^{e} | 4.85^{ef} | 5.32^{e} | 5.31^{d} |
| 4 | 5.19^{d} | 5.68^{d} | 6.20^{d} | 4.63^{f} | 6.30^{d} | 5.27^{d} |
| SEM^{c} | 0.10 | 0.096 | 0.088 | 0.086 | 0.075 | 0.093 |

^{a}Ranked on a 10 cm line scale with anchors at 1 cm and 9 cm, indicating very little/weak or very much/strong, respectively for overall liking, salty taste, overall taste intensity, and meat taste; indicating very light or very dark for internal color; and indicating very soft or very hard for texture.
^{b}Treatments (2.5% NaCl); C = 100% salt from flake salt; TRT 1 = 25% salt from NFE, 75% salt from flake salt; TRT 2 = 50% salt from NFE, 50% salt from flake salt; TRT 3 = 75% salt from NFE, 25% salt from flake salt; TRT 4 = 100% salt from NFE.
^{c}SEM = standard error of the means for overall liking, salty taste, overall taste intensity, texture, internal color, and meat taste for emulsified frankfurters.
^{d-g}Means within the same column with different superscripts are different (P < 0.05).

6.8. Selection of Treatments for Further Investigation (Phases II and III):

Results from Phase I were utilized to determine which TRT would have the greatest efficacy for reducing NaCl levels while maintaining quality and sensory attributes in further research phases. When determining the ideal level of NFE usage to continue with in further studies, sensory results were taken heavily into consideration, with emphasis on overall liking, taste intensity, and saltiness. Quality results were utilized to support and justify the chosen level. Based upon the results of Phase I for quality and sensory analyses, the 50% salt from NFE+50% salt from flake salt TRT was selected as the TRT to move forward with as a baseline for further research phases (II and III).

### 7. Phase II—Sodium Chloride Reduction Using Natural Flavor Enhancer:

7.1 Proximate Composition:

As a result of raw materials (pork and beef) being individually and uniformly mixed prior to batching and assigning to TRT or C, proximate composition of moisture, fat, and protein were determined for the frankfurter C samples only. The average moisture content was 55.06% and values ranged from 54.56% to 55.26%. Average fat content was 25.52% and values ranged from 22.82% to 27.48%. Average protein content was 12.86% and values ranged from 12.52% to 12.94%.

7.2 Instrumental Color Measurements:

The least squares means for external and internal color measurements are displayed in Table 13. External L* values were significantly lower for all TRTs as compared to C, indicating that the usage of NFE at a 50% substitution level can darken product color. These results are in agreement with the results of Phase I, as NFE used at the 50% level had similar effects. No significant differences existed for a* values, which supports results from Phase I, as the 50% NFE TRT was not different from C. These results suggest that addition NFE does not influence external a*. External color b* values were significantly higher for all TRTs as compared to C, indicating that the usage of NFE at 50% levels led to a more yellowish product.

The addition of NFE also affected internal color measurements for CIE L*, a*, and b*. Internal L* values were significantly lower for all TRTs compared to C. These results indicate that the addition of NFE as a salt source may significantly darken the internal color of frankfurters. This is consistent with trends found in Phase I, and is similar to the results from the 50% salt from NFE+50% salt from flake salt TRT. Internal a* values were not significantly different for any TRTs. These results suggest that NFE may be utilized in frankfurters without significantly altering internal redness. Internal b* values were significantly higher for all TRTs compared to C, indicating that NFE addition led to increased yellowish appearance. Sofos (1983a) found that no major changes occurred in instrumental color measurement results when altering NaCl levels, suggesting that changes occurring in this experiment stem only from the addition of NFE.

7.3 pH Measurements and Processing Attributes:

The least squares means for pH values are displayed in Table 13. All TRTs had a significantly lower pH as compared to C, but were not found different from one another. The 50% substitution level in Phase I was also significantly different than C, which is consistent with the TRTs from this research phase. The NFE used in this phase of research had a pH of 5.16, and in turn resulted in a decreasing pH value with NFE addition. It was expected that the pH values of TRTs containing NFE would differ little, as the same level of NFE was added to each TRT.

Various product and processing parameters were recorded during the production of the emulsified frankfurters. Raw emulsion pH ranged from 5.70 (TRT 1) to 5.80 (C). The mean pH of the lean beef and the fat pork trimmings were 5.75 and 6.23, respectively.

TABLE 4.4
Least squares means for Phase II objective external and internal color, pH, purge, emulsion stability, cook yield, and salt
level for emulsified frankfurters containing natural flavor enhancer (NFE; TRTs 1-4) and a control frankfurter
containing no NFE (C).

| | External^{b} | | | Internal^{b} | | | | Purge^{d} | Emulsion | Cook | Salt^{g} |
|---|---|---|---|---|---|---|---|---|---|---|---|
| TRT^{a} | L* | a* | b* | L* | a* | b* | pH^{c} | (%) | Stability^{e} (%) | Yield^{f} (%) | (%) |
| C | 64.55ⁱ | 15.28ⁱ | 13.31^{j} | 68.04ⁱ | 14.20ⁱ | 8.58ⁱ | 6.14ⁱ | 0.75ⁱ | 8.59ⁱ | 92.72ⁱ | 2.41^{j} |
| 1 | 63.52^{j} | 15.32ⁱ | 14.99ⁱ | 66.10^{j} | 14.17ⁱ | 11.33ⁱ | 6.05^{j} | 0.83ⁱ | 9.41ⁱ | 93.15ⁱ | 2.38ⁱ |
| 2 | 62.81^{j} | 15.43ⁱ | 15.81ⁱ | 65.95ⁱ | 14.10ⁱ | 11.26ⁱ | 6.06ⁱ | 0.73^{j} | 9.20ⁱ | 92.98ⁱ | 2.16ⁱ |
| 3 | 63.04^{j} | 15.37^{j} | 15.42ⁱ | 65.76ⁱ | 14.32ⁱ | 11.43ⁱ | 6.05^{j} | 0.87ⁱ | 9.96ⁱ | 92.89ⁱ | 1.97^{k} |
| 4 | 62.83^{j} | 15.57ⁱ | 15.70ⁱ | 65.62^{j} | 14.14ⁱ | 11.11ⁱ | 6.06ⁱ | 0.94ⁱ | 9.84ⁱ | 93.06ⁱ | 1.72^{l} |
| SEM^{h} | 0.37 | 0.20 | 0.37 | 0.25 | 0.12 | 0.16 | 0.015 | 0.10 | 1.08 | 0.22 | 0.022 |

^{a}Treatments: C = (2.5% NaCl, 100% from flake salt; TRT 1 = 2.5% NaCl, 50% salt from NFE, 50% salt from flake salt; TRT 2 = 10% reduction in NaCl; 50% salt from NFE, 40% salt from flake salt; TRT 3 = 20% reduction in NaCl; 50% salt from NFE, 30% salt from flake salt; TRT 4 = 30% reduction in NaCl; 50% salt from NFE, 20% salt from flake salt.
^{b}Commission Internationale de l'Eclairage (CIE) L*, a*, b*, where L* = lightness or darkness on a 0 (black) to 100 (white) scale, a* = redness (positive value) or greenness (negative value), or b* = yellowness (positive value) or blueness (negative value).
^{c}pH of fully cooked emulsified frankfurters.
^{d}Percentage of purge in fully cooked emulsified frankfurter product package after two weeks storage at 4° C.
^{e}Emulsion stability of randomly collected raw emulsion = Percentage of total liquid separation, calculated as the summation of percentage of water separation and percentage of total fat separation.
^{f}Percentage cook yield = ((raw weight of frankfurters/cooked weight of frankfurters) × 100)
^{g}Percentage of salt in fully cooked emulsified frankfurters.
^{h}SEM = Standard error of the means for objective external and internal color, pH, percentage purge, emulsion stability, percentage salt, and percentage moisture for emulsified frankfurters.
^{i-l}Means within the same column with different superscripts and different (P < 0.05).

7.4 Purge, Emulsion Stability, and Cook Yield Measurements:

The least squares means for purge levels, emulsion stability, and cook yield are listed in Table 13. No significant differences were found for purge levels after two weeks of refrigerated storage and values ranged from 0.73% (TRT 2) to 0.94% (TRT 4). Emulsion stability results revealed no significant differences for any of the TRTs or C. Percentage of total liquid separation ranged from 8.6% (C) to 10.0% (TRT 3). No significant differences existed between C and any TRTs for cook yield. Cook yield measurements ranged from 92.72% (C) to 93.15% (TRT 1).

Although no other research studies have examined NFE to reduce NaCl, reduction of NaCl has still been heavily studied. Emulsion stability results of this study are in agreement with those of Whiting (1984) who tested the stability of frankfurter batter, and found the ability of an emulsion to hold water decreased with decreasing NaCl content. The changes in emulsion stability for the reduced NaCl treatments are also in agreement with results found by Hand and others (1987), as in their study on frankfurters, treatments containing 1.5% NaCl had the most liquid losses compared to a 2.0% and 2.5% NaCl frankfurter. Sofos (1983b) and Barbut (1988) both examined reduced NaCl emulsions and also found that stability decreased with decreasing NaCl content, which agrees with these results. The cook yield results of this experiment are not in agreement with those found by Sofos (1983b), as his study investigating reduced NaCl frankfurters revealed that decreased NaCl content also resulted in decreased cook yield, which did not occur in this study.

7.5 Salt Level Measurements:

The least squares means for salt level measurements are displayed in Table 13. TRTs 2, 3, and 4 were significantly lower in salt content than both C and TRT 1. TRT 1 was not different than C, which was expected based upon the formulations. C and TRT 1 both had 2.5% ingoing NaCl, with only the NaCl source being different; measure levels showed that C had 2.41% NaCl and TRT I had 2.38% NaCl. C was 100% salt from flake salt, whereas TRT 1 was 50% salt from NFE+50% salt from flake salt. Decreases in the percentage of NaCl in TRTs 2, 3, and 4 were expected due to the changes in ingoing NaCl percentage. TRTs 2, 3, and 4 were formulated to have 2.25%, 2.00%, and 1.75% total NaCl, respectively. Salt level analysis demonstrated that TRT 2 had total 2.16% NaCl, TRT 3 contained 1.96% total NaCl, and TRT 4 had 1.72% total NaCl.

7.6 Instrumental Texture Measurements:

Textural profile analysis (TPA) and puncture measurements were conducted and are listed in Table 14. TPA testing revealed that C was significantly harder than all TRTs. TRT 4, containing the least amount of NaCl produced the lowest hardness value. All TRTs were significantly less springy than C, but were not different from each other. Only TRTs 3 and 4 were less cohesive than C; however, no differences existed between NFE TRTs. All TRTs were significantly less chewy than C. TPA results indicate that the addition of NFE may affect textural attributes more than the reductions in NaCl, as no clear trends existed with NaCl reduction.

Puncture testing demonstrated that all TRTs required significantly less peak force to break the outer skin of the frankfurters as compared to C. With the addition of NFE, less peak force was required to break the frankfurter skin. Also, as NaCl was reduced, a trend of decreasing peak force also existed, although TRT 1, which contained 2.5% NaCl, had a lower peak force requirement than TRT 2, which had a 10% reduction in salt. The instrumental texture results of this study are in agreement with those found by Sofos (1983a), whose study determined that required shear force values for frankfurters decreased significantly with decreasing NaCl content. Results from Hand and others (1987) also agree with these texture results, as they tested a 1.5% NaCl frankfurter which showed a reduced peak force, indicating a softer product can be caused by decreased NaCl content. For all textural traits, except cohesiveness, all NFE containing TRTs were significantly different than C. Results from this study have suggested that both the inclusion of NFE and decrease in NaCl affected textural traits.

7.7 Consumer Sensory Analysis and Demographics:

The least squares means for sensory analysis results are presented in Table 15. TRTs 2, 3, and 4 were liked significantly more than C. TRTs 1 and 2 were found to be significantly saltier than C. The sensory saltiness results indicate that the inclusion of NFE may allow for NaCl reductions at least 30%, as all treatments were ranked as saltier than C.

TABLE 4.5
Least squares means for Phase II hardness, springiness,
cohesiveness. chewiness, and puncture for emulsified
frankfurters containing naturally flavor enhancer
(NFE: TRTs 1-4) and a control frankfurter containing no NFE (C).

| | Hardness^{b} | Springiness^{c} | Cohesiveness^{d} | Chewiness^{e} | Puncture^{f} |
|---|---|---|---|---|---|
| TRT^{a} | (N) | (mm) | (%) | (N × mm) | (N) |
| C | 45.48^{h} | 5.99^{h} | 51.82^{h} | 147.01^{h} | 2.04^{h} |
| 1 | 36.95^{ij} | 5.68ⁱ | 50.35^{hi} | 106.90ⁱ | 1.76^{ij} |
| 2 | 39.69ⁱ | 5.73ⁱ | 49.11^{hi} | 111.83ⁱ | 1.85ⁱ |
| 3 | 36.00ⁱ | 5.77ⁱ | 46.29ⁱ | 98.03ⁱ | 1.72^{ij} |
| 4 | 35.42^{j} | 5.61ⁱ | 46.42ⁱ | 92.27ⁱ | 1.59ⁱ |
| SEM^{g} | 2.29 | 0.057 | 2.32 | 11.38 | 0.079 |

^{a}Treatments: C = 2.5% NaCl, 100% from flake salt, TRT 1 = 2.5% NaCl, 50% salt from NFE, 50% salt from flake salt; TRT 2 = 10% reduction in NaCl, 50% salt from NFE, 40% salt from flake salt; TRT 3 = 20% reduction in NaCl, 50% salt from NFE, 30% salt from flake salt; TRT 4 = 30% reduction in NaCl, 50% salt from NFE, 20% salt from flake salt.
^{b}Hardness = The peak force during the first compression (compressed 72%).
^{c}Springiness = The height the sample recovered during the time that elapses between the end of the first bite and the start of the second bite (both compressed 50%).
^{d}Cohesiveness = The ratio of the positive force area during the second compression (50%) to that during the first compression (50%), calculated as ((Area 2/Area 1) × 100).
^{e}Chewiness = The product of (hardness × cohesiveness × springiness).
^{f}Puncture = The peak force required to break the outer surface/skin of the frankfurter.
^{g}SEM = Standard error of the means for hardness, springiness, cohesiveness, chewiness, and peak external force for emulsified frankfurters.
^{h-j}Means within the same column with different superscripts are different (P < 0.05).

TABLE 4.6
Least squares means for Phase II consumer sensory analysis^{a} of emulsified
frankfurters containing natural flavor enhancer (NFE; TRTs 1-4) and a
control frankfurter containing no NFE (C).

| | Overall | Salty | Overall Taste | | Internal | Meat |
|---|---|---|---|---|---|---|
| TRT^{b} | Liking | Taste | Intensity | Texture | Color | Taste |
| C | 4.50^{f} | 4.50^{f} | 4.77^{g} | 5.09^{d} | 3.21^{f} | 4.93^{e} |
| 1 | 4.78^{ef} | 5.37^{d} | 3.81^{d} | 3.88^{g} | 4.58^{d} | 4.98^{de} |
| 2 | 5.29^{d} | 4.85^{e} | 5.43^{e} | 4.43^{e} | 4.48^{de} | 5.25^{d} |
| 3 | 5.07^{de} | 4.60^{ef} | 5.29^{ef} | 4.28^{ef} | 4.56^{d} | 5.19^{de} |
| 4 | 4.88^{e} | 4.65^{ef} | 5.09^{f} | 4.07^{fg} | 4.30^{e} | 4.99^{de} |
| SEM^{c} | 0.12 | 0.12 | 0.11 | 0.11 | 0.092 | 0.11 |

^{a}Ranked on a 10 cm line scale with anchors at 1 cm and 9 cm, indicating very little/weak or very much/strong, respectively for overall liking, salty taste, overall taste intensity, and meat taste, indicating very light or very dark for internal color; and indicating very soft or very hard for texture.
^{b}Treatments: C = 2.5% NaCl, 100% from flake salt; TRT 1 = 2.5% NaCl, 50% salt from NFE, 50% salt from NaCl; TRT 2 = 10% reduction in NaCl, 50% salt from NFE, 40% salt from flake salt; TRT 3 = 20% reduction in NaCl, 50% salt from NFE, 30% salt from flake salt; TRT 4 = 30% reduction in NaCl, 50% salt from NFE, 20% salt from flake salt.
^{c}SEM = standard error of the means for overall liking, salty taste, overall taste intensity, texture, internal color, and meat taste for emulsified frankfurters.
^{d-g}Means within the same column with different superscripts are different (P < 0.05).

Overall taste intensity was also increased by the addition of NFE, as all TRTs tasted significantly more intense than C; however, taste intensity decreased with decreasing NaCl content. The inclusion of NFE and reduction of NaCl led to significantly softer texture for all TRTs as compared to C. These results are supported by those found via instrumental texture evaluation, as all TRTs that contained NFE were softer than C. All TRTs that contained NFE were significantly darker compared to C. Sensory color results are in agreement with those found by instrumental color evaluation. For meat taste, only TRT 2 was rated as having significantly more than C; however, all TRTs were rated higher than C for the amount of meat taste present, and no significant differences existed between TRTs that contained NFE.

Demographic questions revealed the following information about panelists participating in this Phase of research. Over three replications, 189 panelists answered demographics questions. 56% of panelists were male and 44% were female. 43% of panelists were between ages 18-24, 29% of panelists were between ages 25-34, 12% of panelists were between ages 35-44, 9% of panelists were between ages 45-54, 5% of panelists were between ages 55-64, and 2% of panelists were over age 65.22% of participating panelists were Asian, 68% were Caucasian, 6% were Hispanic, 5% were African American, and 2% were Native American. Of the 189 panelists, 39% consume SS a few times per year, 35% consume SS a few times per month, 8% consume SS once per week, and 18% consume SS at least once per week. 33% of the panelists consume Asian food a few times per year, 37% of panelists consume Asian food a few times a month, 10% of panelists consume Asian food once per week, and 21% of panelists consume Asian food more than once per week.

### 8. Phase III—Sodium Reduction Using Natural Flavor Enhancer:

8.1 Proximate Composition:

Raw materials (pork and beet) were individually and uniformly mixed before batching and being assigned to either TRT or C; due to this, proximate composition for moisture, fat, and protein were determined for the frankfurter C sample only. The average moisture content was 55.51% and values ranged from 54.85% to 56.44%. Average fat content was 26.09% and values ranged from 24.54% to 28.06%. Average protein content was 13.05% and values ranged from 12.64% to 13.34%.

8.2 Instrumental Color Measurements:

External and internal color measurements were conducted for the emulsified frankfurters and the least squares means are displayed in Table 16. External color values for CIE L*, a*, and b* were affected by the addition of NFE to frankfurters. Only TRT 4 was significantly different than C for L* value. No differences existed for external L* values for NFE containing TRTs. These results are consistent with those of Phase II, in which no significant differences existed between NFE containing TRTs. TRT 4 a* value indicated the TRT was significantly more red than C and all other TRTs. These differences may have occurred due to effects of the smokehouse, as in Phase I and II, no differences existed for any external a* values with NFE usage at 50% of the salt level. External color b* values were significantly more yellow for TRTs 3 and 4 compared to C. No significant differences existed between TRTs containing NFE, and all NFE containing TRTs were more yellow than C. External b* results may also indicate an effect of smokehouse influence, as in Phase II there were no differences in external b* for NFE containing TRTs.

Internal L* values were significantly lower for all TRTs compared to C. These results indicate that the addition of NFE as a salt source may significantly darken the internal color of frankfurters, which is consistent with the results of Phase I and II. In the evaluation of a*, only TRT 4 possessed a significantly higher a* value than C. All other TRTs were not different than C. Internal b* values were significantly higher for all TRTs compared to C, indicating that NFE addition led to increased yellowish appearance. This trend is consistent with results from both Phase I and II, indicating that NFE can increase internal yellowness.

8.3 pH Measurements and Processing Attributes:

The least squares means for pH values are displayed in Table 16. TRTs 1, 3, and 4 had significantly lower pH as compared to C. TRT 2 was not different from C or any other TRT, but was lower in value than C. The NFE used in this phase of research had a pH of 4.71. These results support those results from Phase I and II, and demonstrate that pH values decreased with addition of NFE. Due to the consistent level of NFE usage, it was expected that the pH of TRTs containing NFE would not be different.

Various product and processing parameters were recorded during the production of the frankfurters. Raw emulsion pH ranged from 5.77 (TRT 1) to 5.95 (C). The mean pH of the lean beef and fat pork trimmings were 5.59 and 6.23, respectively.

8.4 Purge, Emulsion Stability, and Cook Yield Measurements:

The least squares means for purge levels, emulsion stability, and cook yield measurements are listed in Table 16. No significant differences were found for purge levels after two weeks of refrigerated storage. Purge levels ranged from 0.67% (TRT 2) to 0.90% (TRT 1). No significant differences were observed for emulsion stability between any TRTs or C. Percentage of total liquid separation ranged from 6.2% (TRT 1) to 7.1% (TRT 4). No significant differences existed between C and any TRTs for cook yield, and measurements ranged from 92.29% (TRT 1) to 92.85% (TRT 4).

Seman and others (1980) established emulsion stability results in bologna that demonstrated a trend similar to these results, in that no differences were found between controls and treatments containing NaCl and KCl. Similar cook yield results were found by Arganosa and Marriot (1990), when KCl was used to substitute 50% of NaCl in restructured hams; no differences were found in cook yield as compared to the control. Seman and others (1980) also concluded that no differences existed for cook yield when bologna was formulated for NaCl replacement using KCl. The conclusions from the study of Seman and others (1980) along with those from the Arganosa and Marmot (1990) experiment are similar to the results of this study.

TABLE 4.7
Least squares means for Phase III objective external and internal color, pH, purge, emulsion stability, cook yield, and salt
level for emulsified frankfurters containing natural flavor enhancer (NFE; TRTs 1-4) and a control frankfurter
containing no NFE (C).

| | External^{b} | | | Internal^{b} | | | | Purge^{d} | Emulsion | Cook | Salt^{g} |
|---|---|---|---|---|---|---|---|---|---|---|---|
| TRT^{a} | L* | a* | b* | L* | a* | b* | pH^{c} | (%) | Stability^{e} (%) | Yield^{f} (%) | (%) |
| C | 62.71ⁱ | 16.83^{j} | 14.86^{j} | 67.92ⁱ | 14.60^{j} | 8.36^{j} | 6.11ⁱ | 0.81ⁱ | 6.49ⁱ | 92.52ⁱ | 2.46 |
| 1 | 61.98^{ij} | 16.56^{j} | 16.15^{ij} | 65.80^{jk} | 14.55^{j} | 11.43ⁱ | 6.02^{j} | 0.90ⁱ | 6.19^{j} | 92.29ⁱ | 2.46 |
| 2 | 61.63^{ij} | 16.69ⁱ | 15.79^{ij} | 65.50^{jk} | 14.81^{ij} | 11.48ⁱ | 6.07^{ij} | 0.67ⁱ | 6.56ⁱ | 92.26ⁱ | 1.97* |
| 3 | 61.72^{ij} | 16.94ⁱ | 17.20ⁱ | 66.20^{j} | 14.54ⁱ | 11.62ⁱ | 6.05^{j} | 0.87ⁱ | 6.56ⁱ | 92.53ⁱ | 1.60* |
| 4 | 61.25^{j} | 17.71ⁱ | 17.15ⁱ | 65.09^{k} | 15.24ⁱ | 11.64ⁱ | 6.03^{j} | 0.67ⁱ | 7.13ⁱ | 92.85ⁱ | 1.23* |
| SEM^{h} | 0.39 | 0.17 | 0.53 | 0.25 | 0.13 | 0.18 | 0.013 | 0.14 | 0.53 | 0.20 | — |

^{a}Treatments: C = 2.5% NaCl, 100% from flake salt; TRT 1 = 2.5% NaCl, 50% salt from NFE, 50% salt from flake salt; TRT 2 = 20% reduction in Na, 50% salt from NFE, 30% salt from flake salt, 20% salt from KCl; TRT 3 = 35% reduction in Na, 50% salt from NFE, 15% salt from flake salt, 35% salt from KCl; TRT 4 = 50% reduction in Na, 50% salt from NFE, 50% salt from KCl.
^{b}Commission Internationale de l'Eclairage (CIE) L*, a*, b*, where L* = lightness or darkness on a 0 (black) to 100 (white) scale a* = redness (positive value) or greenness (negative value), or b* = yellowness (positive value) or blueness (negative value).
^{c}pH of fully cooked emulsified frankfurters.
^{d}Percentage of purge in fully cooked emulsified frankfurter product package after two weeks storage at 4° C.
^{e}Emulsion stability of randomly collected raw emulsion = Percentage of total liquid separation, calculated as the summation of percentage of water separation and percentage of total fat separation.
^{f}Percentage cook yield = ((raw weight of frankfurters/cooked weight of frankfurters) × 100)
^{g}Percentage of salt in fully cooked emulsified frankfurters.
^{h}SEM = Standard error means for objective external and internal color, pH, percentage purge, emulsion stability, percentage salt, and percentage moisture for emulsified frankfurters.
^{i-k}Means within the same column with different superscripts are different (P < 0.05).
*Indicates values were calculated based on C and TRT 1 as they could not be measured using the Quantab method due to KCl content.

8.5 Salt Level Measurements:

The values for salt level measurements are displayed in Table 16. Salt levels of TRTs 2, 3, and 4 were lower than those of C and TRT 1. Statistical analysis was not performed for TRT 2, 3, or 4 salt measurement data due to the fact that the values were extrapolated based on C and TRT 1. These values were extrapolated because the NaCl measurement system that was used measured the presence of chloride ions and was unable to distinguish between chloride ions coming from NaCl and chloride ions coming from KCl, and therefore, any measurements would have been inaccurate for NaCl content.

8.6 Instrumental Texture Measurements:

Textural profile analysis (TPA) and puncture measurements for least squares means are listed in Table 17. TPA testing revealed that C was significantly harder than all TRTs, indicating that the inclusion of NFE and reduction in NaCl content can lower product firmness. TRT 4, containing the least amount of NaCl produced the lowest hardness value, and hardness decreased as NaCl content decreased. TRTs 1, 3, and 4 were significantly less springy than C. All TRTs were significantly less cohesive and chewy than C. Puncture testing demonstrated that TRTs 3 and 4 required significantly less peak force to break the outer skin of the frankfurters as compared to C. Results presented by Whiting and Jenkins (1981) suggested that frankfurter texture was unaffected by changes in ratios of NaCl and KCl, which may indicate that textural differences found in this study have come about from the addition of NFE. Seman and others (1980) reported results that were contradictory, and suggested that the addition of KCl to bologna led to a higher textural hardness value. Findings of Hand and others (1982) are in agreement with the results from this study, as they found a treatment containing 65% NaCl and 35% KCl to be less firm than a control throughout a six week storage period. Based upon the conflicting results of previous research studies, it is possible that the textural differences in this study are caused by both KCl and NFE addition.

TABLE 4.8
Least squares means for Phase III hardness, springiness,
cohesiveness. chewiness, and puncture for emulsified
frankfurters containing naturally flavor enhancer
(NFE: TRTs 1-4) and a control frankfurter containing no NFE (C).

| | Hardness^{b} | Springiness^{c} | Cohesiveness^{d} | Chewiness^{e} | Puncture^{f} |
|---|---|---|---|---|---|
| TRT^{a} | (N) | (mm) | (%) | (N × mm) | (N) |
| C | 46.66^{h} | 6.02^{h} | 57.86^{h} | 162.55^{h} | 1.87^{h} |
| 1 | 38.03ⁱ | 5.82ⁱ | 48.04^{ij} | 105.73ⁱ | 1.73^{hi} |
| 2 | 38.11ⁱ | 5.89^{hi} | 51.08^{ij} | 115.58ⁱ | 1.89^{h} |
| 3 | 35.15ⁱ | 5.80ⁱ | 52.09ⁱ | 106.44ⁱ | 1.61^{ij} |
| 4 | 31.19^{j} | 5.61^{j} | 46.70^{j} | 81.69^{j} | 1.53^{j} |
| SEM^{g} | 1.75 | 0.052 | 1.93 | 5.96 | 0.075 |

^{a}Treatments: C = 2.5% NaCl, 100% from flake salt, TRT 1 = 2.5% salt, 50% salt from NFE, 50% salt from flake salt; TRT 2 = 20% reduction in Na, 50% salt from NFE, 30% salt from flake salt, 20% salt from KCl; TRT 3 = 35% reduction in Na, 50% salt from NFE, 15% salt from flake salt, 35% from KCl; TRT 4 = 50% reduction in Na, 50% salt from NFE, 50% salt from KCl.
^{b}Hardness = The peak force during the first compression (compressed 72%).
^{c}Springiness = The height the sample recovered during the time that elapses between the end of the first bite and the start of the second bite (both compressed 50%).
^{d}Cohesiveness = The ratio of the positive force area during the second compression (50%) to that during the first compression (50%), calculated as ((Area 2/Area 1) × 100).
^{e}Chewiness = The product of (hardness × cohesiveness × springiness).
^{f}Puncture = The peak force required to break the outer surface/skin of the frankfurter.
^{g}SEM = Standard error of the means for hardness, springiness, cohesiveness, chewiness, and peak external force for emulsified frankfurters.
^{h-j}Means within the same column with different superscripts are different (P < 0.05).

8.7 Consumer Sensory Analysis and Demographics:

The least squares means for sensory analysis results are presented in Table 18. C and TRTs 1, 2, and 3 were liked significantly more than TRT 4. Only TRTs 1 and 2 were statistically saltier than C. The sensory saltiness results indicate that the inclusion of NFE allows for an increase in the perceived salty taste, despite a decrease in NaCl and the inclusion of KCl. The belief that umami containing substances, such as NFE, are able to enhance saltiness is supported by these sensory results (Fuke and Ueda 1996; Keast and Breslin 2002).

Overall taste intensity was also increased by the addition of NFE, as all TRTs tasted significantly more intense than C. Bitterness was tested for because of the inclusion of KCl in some treatments. TRTs 1 and 4 were rated as having significantly more bitter taste than C. TRT 4, containing 50% KCl tended to have the highest rating for bitterness. Numerous research studies suggest that 50% KCl may be the upper limit for KCl usage. In this research, the 50% KCl usage level produced the highest bitterness rating of all TRTs. It is unclear as to why bitterness of TRT 1 was not found to be different from TRT 4, as TRT 1 contained no KCl. The inclusion of NFE led to significantly softer texture for all TRTs as compared to C. In TRTs that contained KCl, firmness decreased with increasing KCl content. Instrumental texture evaluation results support this data, as well as results from Phase I and II. Internal color was affected by the addition of NFE, as all TRTs containing NFE were significantly darker compared to C. These results are supported by the instrumental L* measurements, as similar trends were noted. No significant differences were found for meat taste.

TABLE 4.9
Least squares means for Phase III consumer sensory analysis of emulsified
frankfurters containing natural flavor enhancer (NFE; TRTs 1-4) and a
control frankfurter containing no NFE (C).

| | | | Overall | | | | |
|---|---|---|---|---|---|---|---|
| | Overall | Salty | Taste | Bit- | | Internal | Meat |
| TRT^{a} | Liking | Taste | Intensity | terness | Texture | Color | Taste |
| C | 4.84^{d} | 4.42^{f} | 4.52^{g} | 2.66^{f} | 5.50^{d} | 3.54^{g} | 5.01^{de} |
| 1 | 4.87^{d} | 5.20^{d} | 5.79^{d} | 3.23^{de} | 4.20^{ef} | 4.68^{de} | 5.02^{de} |
| 2 | 5.07^{d} | 4.82^{e} | 5.18^{ef} | 2.89^{ef} | 4.46^{e} | 4.48^{ef} | 5.20^{d} |
| 3 | 4.86^{d} | 4.47^{f} | 4.98^{f} | 2.91^{ef} | 4.07^{f} | 4.21^{f} | 5.02^{de} |
| 4 | 4.40^{e} | 4.60^{ef} | 5.35^{e} | 3.50^{d} | 3.55^{g} | 4.91^{d} | 4.81^{e} |
| SEM^{c} | 0.13 | 0.12 | 0.12 | 0.13 | 0.11 | 0.10 | 0.11 |

^{a}Ranked on a 10 cm line scale with anchors at 1 cm and 9 cm, indicating very little/weak or very much/strong, respectively for overall liking, salty taste, overall taste intensity, bitterness, and meat taste; indicating very light or very dark for internal color; and indicating very soft or very hard for texture.
^{b}Treatments: C = 2.5% NaCl, 100% from flake salt; TRT 1 = 2.5% salt, 50% salt from NFE, 50% salt from flake salt; TRT 2 = 20% reduction in Na, 50% salt from NFE, 30% salt from flake salt, 20% salt from KCl; TRT 3 = 35% reduction in Na, 50% salt from NFE, 15% salt from flake salt, 35% salt from KCl; TRT 4 = 50% reduction in Na, 50% salt from NFE, 50% salt from KCl.
^{c}SEM = standard error of the means for overall liking, salty taste, overall taste intensity, bitterness, texture, internal color, and meat taste for emulsified frankfurters.
^{d-g}Means within the same column with different superscripts are different (P < 0.05).

Demographic questions revealed the following information about panelists participating in this Phase of research. Over three replications, 184 panelists answered demographics questions. 52% of panelists were male and 48% were female. 51% of panelists were between ages 18-24, 28% of panelists were between ages 25-34, 9% of panelists were between ages 35-44, 7% of panelists were between ages 45-54, 3% of panelists were between ages 55-64, and 1% of panelists were over age 65.21% of participating panelists were Asian, 70% were Caucasian, 8% were Hispanic, and 2% were African American. Of the 184 panelists, 40% consume SS a few times per year, 41% consume SS a few times per month, 8% consume SS once per week, and 11% consume SS at least once per week. 30% of the panelists consume Asian food a few times per year, 42% of panelists consume Asian food a few times a month, 11% of panelists consume Asian food once per week, and 17% of panelists consume Asian food more than once per week.

8.8 Conclusions for Using Natural Flavor Enhancer to Reduce Sodium Content in Processed Meat Products:

Varying levels of NFE were investigated as a means to replace and reduce sodium in frankfurters through three phases of research. The non-NFE containing control, with 2.5% NaCl (from flake salt), possessed characteristics typical of an industry standard frankfurter throughout all three phases of research.

Phase I results indicated 50% salt from NFE+50% salt from flake salt was the optimum formulation to utilize as a baseline to continue with in studying alterations in sodium content. In Phase II, both quality and sensory results indicated that 50% salt from NFE+30% salt from flake salt (20% NaCl reduction) is at least one appropriate formulation for industry to use to reduce sodium using NFE. Resulting in 2.00% total NaCl in the finished product, this formulation provided no major impact on quality attributes, and sensory traits were equivalent or improved compared to C. Phase III results indicate that a successful combination of NFE, KCl, and flake salt, was apparent with a 35% sodium reduction. This formulation was comprised of 50% salt from NFE+35% salt from KCl+15% salt from flake salt, and delivered 1.60% total NaCl in the finished product. All research phases indicated that it is possible and palatable to utilize NFE to replace NaCl in frankfurters. This research also demonstrated that NFE possesses the ability to increase consumer sensory overall liking, salty taste perception, and overall taste intensity. Phase III results indicate that NFE has the ability to attenuate bitterness at up to about 35% KCl level, as consumer bitterness scores increased at 50% usage level.

### 9. Materials and Methods: Reduced-Sodium Bread:

Simple white bread samples were prepared by using flour (Gold Medal-brand all purpose, bleached, enriched, pre-sifted), table salt (Morton brand non-fluorinated sodium chloride), natural flavor enhancer (NFE) provided by Kikkoman Co., active dry yeast (Red Star brand), and distilled water. The formulations are shown in Table 5 for the salty intensity perception descriptive tests, and Table 6 for the consumer acceptability tests. The ingredients were then mixed, kneaded, risen, and baked using a Panasonic SD-YD250 automatic bread maker using the settings for basic bread, medium crust color, and extra large loaf.

Samples for compositional analysis were prepared according to AACC method 62-05 (AACC, 2000). The fat, protein, ash, moisture, and carbohydrate content of the samples were analyzed by rtech Laboratories. The sodium content of the samples was determined according to AOAC method 2006.03 by rtech Laboratories (St. Paul, Minn., USA). Sample color was determined using a colorimeter (Minolta Chroma Meter CR-300) and taking measurements in 4 points of the crumb and 6 points of the crumb. The volume of the loaves was determined by rapeseed displacement according to AACC method 10-05 (AACC, 2000).

To determine if the use of NFE instead of NaCl has an effect on the intensity of salty taste perception in white bread, bread loaves with 6 different levels of sodium reduction (0%, 10%, 20%, 30%, 40%, 50%) were evaluated by a descriptive panel. The descriptive analysis was done with 15 panelists trained in Spectrum® methodology. The concentration of the NaCl solutions used as references and their anchors in a 15 point scale are shown in Table 7. The samples were made in triplicate and prepared 24 hours after baking by cutting the loaves in 1 cm thick slices, removing the crust, and cutting the crumb into 1 cm3 cubes. Panelists were given 4 different samples per panel and asked to evaluate the intensity of the salty taste in each sample.

To determine the consumer acceptability of using NFE as a substitute of NaCl, a central location test (CLT) was carried out in the UW-Madison Food Science Consumer Sensory Lab with 94 wheat bread consumers. Samples with 0%, 25%, and 50% of the NaCl replaced with NFE were made 24 hours prior to the consumer panel prepared by cutting the loaves in 1 cm thick slices and cutting each slice in four. Each consumer was given 3 samples, water, and asked to answer a ballot.

### 10. Results and Discussion:

The compositional results are show in Table 8. No significant difference (α=0.05) was found in the sodium content of the samples (Table 9).

The volume of the loaves was measured to determine if substituting NaCl with NFE had an effect on the size of the bread loaves. The mean results for the volume of the finished loaves are shown in Table 10. Statistical analysis (Table 11) shows that there are significant differences in the volumes of the loaves of different treatments, with the sample containing only NaCl (0% NFE) and the sample with NFE substituting 100% of the NaCl in the sample (100% NFE) having statistically similar volumes, while the samples with intermediate degrees of NaCl substitution (25% NFE, and 50% NFE) had a smaller volume.

Results for crumb and crust color are shown in Table 12. The increased substitution of NaCl with NFE darkened the color of the crumb and the crust, with the control bread having a very light color, the bread with 25% NFE substitution having a very light brown hue, and the breads with 50% and 100% NFE substitution having a consecutively darker color.

The results of the evaluation of salty taste intensity in bread are shown in Table 13. Breads made with NFE as the main source of sodium were consistently evaluated as having a more intense salty taste than breads made with NaCl as the main source of sodium. See the sole drawing FIGURE. A statistical analysis of this data (Table 14) shows that the source of sodium in the breads (NaCl or NFE) and the different levels of sodium reduction have a statistically significant effect in the salty taste perception, although interaction of these two parameters is not significant.

From the consumer acceptability test, the use of NFE to substitute NaCl up to 50% does not have a difference in the overall liking (Table 15) and texture liking (Table 16) of consumers. However, the appearance changes enough that consumers prefer the sample with 0% NFE statistically more than the samples with 25% and 50% NFE (Table 17). The aroma (Table 18) and flavor (Table 19) of the sample with 0% NFE and 50% NFE were statistically different. Table 20 reports the number of times each bread sample was ranked as the most liked (1) to the least liked (3) during the consumer acceptability test.

Finally, when consumers were asked to rank their preference for the samples from 1 to 3, where 1 was the most liked sample and 3 the least liked sample, the control bread and the 25% NFE bread were not statistically different (Table 21), showing that a 25% substitution of NaCl with NFE does not affect consumer preference for the sample.

### Conclusions

As shown by these examples, NFE can be used in bread to reduce the sodium content without affecting consumer acceptance. It was found that substituting NaCl with NFE affects the volume of bread loaves and with increasing amount of NFE substitution, the color of the bread turns from white to a brown hue. The data also proved that bread made with NFE has an increased salty taste perception compared with bread made with NaCl at different levels of sodium reduction. The use of NFE in bread does not affect consumer overall liking, but has a negative effect on the appearance acceptability and a 50% level of NFE substitution also lowers the flavor and aroma acceptability. Finally, consumer preference is unaffected by the use of NFE to substitute NaCl up to a 25% level.

TABLE 5
Bread formulation to make the salty taste intensity descriptive analysis
samples.

| Sodium | Sodium | Flour | | | | |
|---|---|---|---|---|---|---|
| source | reduction | (g) | NaCl (g) | NFE (g) | Yeast (g) | Water (g) |
| NaCl | 0% | 500 | 8.700 | 0 | 10 | 350 |
| | 10% | 500 | 7.827 | 0 | 10 | 350 |
| | 20% | 500 | 6.953 | 0 | 10 | 350 |
| | 30% | 500 | 6.079 | 0 | 10 | 350 |
| | 40% | 500 | 5.206 | 0 | 10 | 350 |
| | 50% | 500 | 4.333 | 0 | 10 | 350 |
| NFE | 0% | 500 | 0 | 38.453 | 10 | 350 |
| | 10% | 500 | 0 | 34.593 | 10 | 350 |
| | 20% | 500 | 0 | 30.733 | 10 | 350 |
| | 30% | 500 | 0 | 26.872 | 10 | 350 |
| | 40% | 500 | 0 | 23.012 | 10 | 350 |
| | 50% | 500 | 0 | 19.152 | 10 | 350 |

TABLE 6
Bread formulation used for the consumer acceptability test.

| Sample | Flour (g) | NaCl (g) | NFE (g) | Yeast (g) | Water (g) |
|---|---|---|---|---|---|
| 0% NFE | 500 | 8.7 | 0 | 10 | 350 |
| (control) | | | | | |
| 25% NFE | 500 | 6.5 | 10 | 10 | 350 |
| 50% NFE | 500 | 4.3 | 20 | 10 | 350 |
| 100% NFE | 500 | 0 | 40 | 10 | 350 |

TABLE 7
Concentration of NaCl solutions used as references
for descriptive analysis and their anchored
value in a 0-15 point scale.

| NaCl | Anchor |
|---|---|
| concentration | Point |
| 0.25% | 1.0 |
| 0.375% | 2.0 |
| 0.50% | 3.0 |
| 0.75% | 5.5 |
| 1.0% | 9.0 |
| 1.25% | 11.5 |
| 1.5% | 14.0 |

TABLE 8
Proximate analysis results.

| | | Protein | | | Carbo- | Sodium |
|---|---|---|---|---|---|---|
| | Fat | (%, factor | Ash | Moisture | hydrates | (g/ |
| Sample | (%) | 5.7) | (%) | (%)* | (%) | 100 g) |
| 0% (control) | 1.84 | 11.67 | 2.34 | 7.29 | 76.82 | 0.70 |
| 25% NFE | 2.37 | 11.54 | 2.39 | 7.28 | 76.43 | 0.71 |
| 50% NFE | 1.77 | 11.64 | 2.40 | 7.08 | 77.12 | 0.72 |
| 100% NFE | 1.65 | 11.88 | 2.46 | 7.16 | 76.86 | 0.71 |

TABLE 9
ANOVA for sodium content of consumer panel loaves (=0.05).

| | | Sum of | | | |
|---|---|---|---|---|---|
| Source | DF | Squares | Mean Square | F Ratio | Prob > F |
| Sample | 3 | 0.00074 | 0.00024 | 2.7249 | 0.0950 |
| Error | 11 | 0.00100 | 0.00009 | | |
| C. Total | 14 | 0.00174 | | | |

TABLE 10
Bread loaf mean volume results.

| | Mean Volume |
|---|---|
| Sample | (cm³) |
| 0% (control) | 2366.66 |
| 25% NFE | 2237.50 |
| 50% NFE | 2050.00 |
| 100% NFE | 2037.50 |

TABLE 11
ANOVA and t-test results for volume of loaves (=0.05). The percentage
value next to NFE indicates the proportion of NaCl that has been
substituted with NFE, based on sodium content, in the formulation.

| | | Sum of | | | |
|---|---|---|---|---|---|
| Source | DF | Squares | Mean Square | F Ratio | Prob > F |
| Sample | 3 | 260583.33 | 86861.1 | 9.8842 | 0.0019 |
| Error | 11 | 96666.67 | 8787.9 | | |
| C. Total | 14 | 357250.00 | | | |

| Level | | | Mean |
|---|---|---|---|
| 0% (control) | A | | 2366.6667 |
| 100% NFE | A | | 2237.5000 |
| 25% NFE | | B | 2050.0000 |
| 50% NFE | | B | 2037.5000 |

TABLE 12
Mean values of L*, a, b for crumb and crust of bread samples The percentage value
next to NFE indicates the proportion of NaCl that has been substituted with NFE,
based on sodium content, in the formulation.

| | Crumb | | | Crust Top | | | Crust Side | | | Crust Bottom | | |
|---|---|---|---|---|---|---|---|---|---|---|---|---|
| | L | a | b | L | a | b | L | a | b | L | a | b |
| 0% (control) | 64.09 | −1.32 | 12.31 | 57.18 | 10.86 | 34.34 | 49.36 | 13.38 | 28.87 | 48.31 | 10.73 | 27.45 |
| 25% NFE | 62.33 | −0.42 | 16.56 | 52.40 | 12.11 | 33.89 | 48.49 | 13.42 | 27.56 | 41.09 | 11.82 | 22.24 |
| 50% NFE | 57.49 | 0.82 | 19.53 | 45.71 | 14.02 | 29.84 | 40.48 | 11.24 | 19.81 | 39.98 | 9.72 | 20.62 |
| 100% NFE | 53.33 | 2.68 | 21.98 | 41.49 | 14.38 | 25.44 | 38.89 | 10.86 | 19.06 | 40.65 | 8.89 | 19.84 |

TABLE 13
Mean salty taste intensity values for breads with NaCl or
NFE as the main source of sodium at the different
levels of sodium reduction.

| | Sodium | |
|---|---|---|
| Sodium | Reduction | Salt |
| Source | (%) | Intensity |
| NaCl | 0 | 1.87 |
| | 10 | 1.51 |
| | 20 | 1.59 |
| | 30 | 1.39 |
| | 40 | 1.14 |
| | 50 | 1.04 |
| NFE | 0 | 2.25 |
| | 10 | 1.90 |
| | 20 | 1.86 |
| | 30 | 1.66 |
| | 40 | 1.53 |
| | 50 | 1.19 |

TABLE 14
ANOVA table for salt intensity perception in bread using NaCl or NFE
as the source of sodium, at different levels (0%, 10%, 20%, 30%,
40%, and 50%) of sodiumreduction.

| Source | DF | Sum of Squares | Mean Square | F Ratio |
|---|---|---|---|---|
| Model | 24 | 148.39229 | 6.18301 | 11.8302 |
| Error | 448 | 234.14651 | 0.52265 | Prob > F |
| C. Total | 472 | 382.53880 | | <.0001 |

| Source | Nparm | DF | Sum of Squares | F Ratio | Prob > F |
|---|---|---|---|---|---|
| Panelist | 13 | 13 | 92.742585 | 13.6498 | <.0001 |
| Sodium Source | 1 | 1 | 10.600908 | 20.2831 | <.0001 |
| Sodium Reduction | 5 | 5 | 45.863040 | 17.5502 | <.0001 |
| Sodium Source * | 5 | 5 | 0.774407 | 0.2963 | 0.9149 |
| Sodium Reduction | | | | | |

TABLE 15
ANOVA and pairwise comparison (=0.05) results for the overall
acceptability of wheat bread with 0%, 25%, or 50% of the NaCl
substituted with NFE.

| | | | Sum of | | |
|---|---|---|---|---|---|
| Source | Nparm | DF | Squares | F Ratio | Prob > F |
| Panelist | 93 | 93 | 430.76051 | 2.5084 | <0.0001 |
| Bread | 2 | 2 | 4.74015 | 1.2835 | 0.2795 |

Student's t
Alpha = 0.05, t = 1.97294

| Level | | Least Sq Mean |
|---|---|---|
| 0% (control) | A | 6.0239492 |
| 25% NFE | A | 5.8404255 |
| 50% NFE | A | 5.7050302 |

TABLE 16
ANOVA and pairwise comparison (=0.05) results for the texture liking of
wheat bread with 0%, 25%, or 50% of the NaCl substituted with NFE

| | | | Sum of | | |
|---|---|---|---|---|---|
| Source | Nparm | DF | Squares | F Ratio | Prob > F |
| Panelist | 93 | 93 | 172.594 | 1.7012 | 0.0012 |
| Bread | 2 | 2 | 0.27199 | 0.1247 | 0.8829 |

Student's t
Alpha = 0.05, t = 1.97294

| Level | | Least Sq Mean |
|---|---|---|
| 0% (control) | A | 4.7400224 |
| 25% NFE | A | 4.6914894 |
| 50% NFE | A | 4.6643467 |

TABLE 17
ANOVA and pairwise comparison (=0.05) results for the
appearance liking of wheat bread with 0%, 25%, or 50%
of the NaCl substituted with NFE

| | | | Sum of | | |
|---|---|---|---|---|---|
| Source | Nparm | DF | Squares | F Ratio | Prob > F |
| Panelist | 93 | 93 | 181.81288 | 2.6026 | <0.0001 |
| Bread | 2 | 2 | 12.9506 | 8.6202 | 0.0003 |

Student's t
Alpha = 0.05, t = 1.97294

| Level | | | Least Sq Mean |
|---|---|---|---|
| 0% (control) | A | | 5.1002552 |
| 25% NFE | | B | 4.7765957 |
| 50% NFE | | B | 4.5759309 |

TABLE 18
ANOVA and pairwise comparison (=0.05) results for the aroma liking of
wheat bread with 0%, 25%, or 50% of the NaCl substituted with NFE

| | | | Sum of | | |
|---|---|---|---|---|---|
| Source | Nparm | DF | Squares | F Ratio | Prob > F |
| Panelist | 93 | 93 | 185.02328 | 2.2543 | <0.0001 |
| Bread | 2 | 2 | 3.94767 | 2.2366 | 0.1097 |

Student's t
Alpha = 0.05, t = 1.97294

| Level | | | Least Sq Mean |
|---|---|---|---|
| 0% (control) | A | | 4.7629103 |
| 25% NFE | A | B | 4.6276596 |
| 50% NFE | | B | 4.4710184 |

TABLE 19
ANOVA and pairwise comparison (=0.05) results for the flavor liking of
wheat bread with 0%, 25%, or 50% of the NaCl substituted with NFE

| | | | Sum of | | |
|---|---|---|---|---|---|
| Source | Nparm | DF | Squares | F Ratio | Prob > F |
| Panelist | 93 | 93 | 197.09244 | 1.9447 | <0.0001 |
| Bread | 2 | 2 | 5.31413 | 2.4382 | 0.0901 |

Student's t
Alpha = 0.05, t = 1.97294

| Level | | | Least Sq Mean |
|---|---|---|---|
| 0% (control) | A | | 4.4966992 |
| 25% NFE | A | B | 4.4361702 |
| 50% NFE | | B | 4.1777803 |

TABLE 20
Number of times each bread sample was ranked as the most liked
(1) to the least liked (3) during the consumer acceptability test

| | Rank | | |
|---|---|---|---|
| Sample | 1 | 2 | 3 |
| 0% (control) | 36 | 27 | 27 |
| 25% NFE | 31 | 43 | 16 |
| 50% NFE | 23 | 20 | 47 |

TABLE 21
ANOVA table and pairwise comparison of the ranked data for breads with
0%, 25%, and 50% of the sodium chloride subsituted for NFE

| Source | DF | Sum of Squares | Mean Square | F Ratio |
|---|---|---|---|---|
| Model | 2 | 9.80000 | 4.90000 | 7.6868 |
| Error | 267 | 170.20000 | 0.63745 | Prob > F |
| C. Total | 269 | 180.00000 | | 0.0006 |

| Level | | | Least Sq Mean |
|---|---|---|---|
| 342 | A | | 2.2666667 |
| 529 | | B | 1.9000000 |
| 781 | | B | 1.8333333 |

### 11. Additional Reduced-Sodium Meat Products: Experimental Design:

This study assessed the effect of the addition of varying levels of SS and NFE have on the quality and sensory attributes of bacon, summer sausage, and beef jerky by descriptive sensory panelists. Each meat product was manufactured twice (n=2) and sensory was duplicated for each manufacture (n=4). Products were manufactured at the University of Wisconsin Meat and Muscle Biology Laboratory and transported to the Food Science Sensory Application Laboratory for descriptive sensory analysis. Each product investigated in this study comprised of 6 treatments (3 soy sauce “SS”, 3 natural flavor enhancer “NFE”) and a control formulation (no SS/NFE). Each treatment consisted of a different level of SS/NFE. All treatments were focused on replacing table salt with equal amounts of sodium from either SS or NFE. The three treatment levels for all meat products were 25%, 50% and 75% sodium replacement from SS/NFE. The SS or NFE was analyzed prior to formulating to determine the salt content.

### 11.1 Product Manufacture and Formulations:

Products manufactured in this study were formulated using generic formulas with an average level of salt. Each product contains an overall manufacture formulation and a seasoning blend formulation.

### 11.2 Bacon Manufacture:

Bacon was manufactured using raw bellies procured from a local supplier. Each treatment was assigned 2 random bellies (weight varied in each belly) however each treatment brine was formulated to a 201b batch size following the formulations shown in Table 22 and Table 23. Brines were made by adding phosphates, salt, cure, erythorbate, and sugar dissolving each ingredient. SS/NFE were then added to the cold water following each formulation. Each treatment was injected using the formaco injector. Brines were pumped through the machine and each belly was injected to 12% over its original weight. Bellies were then place in a lug and soaked in a 50% diluted brine solution of their respective treatment overnight. The bellies were then smoked and processed using a standard bacon cycle shown in Table 24. After cooking the bacon was cooled and tempered in a freezer prior to slicing. Each treatment was stored for two weeks prior to sensory evaluation

TABLE 22
Bacon manufacture formulations.¹

| | | | Seasoning | |
|---|---|---|---|---|
| | Water² | Salt | blend | SS/NFE |
| Treatment | (g) | (g) | (g) | (g) |
| SS 25% | 6714.66 | 1006.41 | 1178.11 | 2444.86 |
| SS 50% | 4603.56 | 670.94 | 1178.11 | 4894.16 |
| SS 75% | 2506.08 | 316.57 | 1178.11 | 7341.24 |
| NFE 25% | 6396.86 | 1006.41 | 1178.11 | 2761.53 |
| NFE 50% | 3967.96 | 670.94 | 1178.11 | 5523.06 |
| NFE 75% | 1561.76 | 316.57 | 1178.11 | 8284.60 |
| Control | 8825.76 | 1341.88 | 1178.11 | 0.00 |

¹Bacon treatments consisted of two randomly selected bellies per treatment
²Water volume decreased from added water with increasing SS/NFE inclusion
³Seasoning blend consisted of sugar, sodium phosphates, sodium erythorbate and cure (6.25% sodium nitrite) shown in Table 23.

TABLE 23
Bacon seasoning blend¹

| | Formulation |
|---|---|
| Ingredient | (g) |
| Sugar | 566.99 |
| Sodium phosphates | 377.99 |
| Cure (6.25% sodium | 181.44 |
| nitrite) | |
| Sodium erythorbate | 51.69 |

¹Seasoning blend remained constant throughout all treatments of bacon.

TABLE 24
Bacon thermal processing cycle

| | | | | Internal | | | |
|---|---|---|---|---|---|---|---|
| | | Dry | Wet | Tem- | Main | Exhaust | |
| Cook | Time | Bulb | Bulb | perature | Fan | Fan | Humidity/ |
| Step | (min)¹ | (° F.) | (° F.) | (° F.)² | Speed | Speed | Smoke |
| Cook | 180 | 105 | 0 | 0 | 1 | 10 | None |
| Smoke | 90 | 110 | 0 | 0 | 10 | 0 | Smoke |
| Cook | | | | | | | |
| Smoke | 90 | 115 | 0 | 0 | 10 | 0 | Smoke |
| Cook | | | | | | | |
| Smoke | 90 | 120 | 0 | 0 | 10 | 0 | Smoke |
| Cook | | | | | | | |
| Cook | 70 | 125 | 0 | 0 | 10 | 10 | Steam |
| Cook | 1 | 139 | 135 | 129 | 6 | 0 | Both |

¹Time showing 1 minute in this cook step was held for one minute at 160° F. once the internal temperature was reached.
²Internal temperature was monitored using data loggers in addition to the smokehouse temperature probe.
³Smoke consisted of a natural smoke blend

### 11.3 Beef Jerky Manufacture:

Beef jerky was manufactured using beef inside rounds procured from a local supplier. The rounds were trimmed of all connective tissue and ground through a ⅜ inch grinder plate. The product was batched and placed in a ribbon mixer. Each treatment was mixed in a ribbon mixer for a total of 5 minutes while each ingredient was added according to the formulations in Table 25 and Table 26. During the last 2 minutes of mixing, water or the SS/NFE depending on treatment was added to the mixture. Beef Jerky was stuffed into long 3′ strips using a beef jerky attachment for the Handtmann stuffer. The product was cooked on racks using a standard beef jerky cook schedule shown in Table 27. Racks were rotated throughout the cook cycle to keep drying even on all treatments. Once the product was cooked and cooled it was packaged and held for two weeks until sensory analysis began

TABLE 25
Beef jerky manufacture formulations¹

| | | | Seasoning | |
|---|---|---|---|---|
| | Water | Salt | blend | SS/NFE |
| Treatment | (g) | (g) | (g) | (g) |
| SS 25% | 721.86 | 140.33 | 67.29 | 341.44 |
| SS 50% | 426.76 | 93.56 | 67.29 | 682.88 |
| SS 75% | 131.66 | 46.78 | 67.29 | 1024.32 |
| NFE 25% | 676.46 | 140.33 | 67.29 | 385.32 |
| NFE 50% | 340.5 | 93.56 | 67.29 | 770.63 |
| NFE 75% | 0.00 | 46.78 | 67.29 | 1155.95 |
| Control | 1016.96 | 187.11 | 67.29 | 0.00 |

¹Beef jerky treatments consisted of 15 lbs raw meat block per treatment.
²Water volume decreased from added water with increasing SS/NFE inclusion
³Seasoning blend consisted of ground black pepper, allspice, garlic powder, sodium erythorbate and cure (6.25% sodium nitrite) shown in Table 26.

TABLE 26
Beef jerky seasoning blend¹

| | Formulation |
|---|---|
| Ingredient | (g) |
| Ground Black Pepper | 31.50 |
| Cure (6.25% sodium | 19.66 |
| nitrite) | |
| Allspice | 7.88 |
| Sodium erythorbate | 4.31 |
| Garlic powder | 3.94 |

¹Seasoning blend remained constant throughout all treatments of bacon.

TABLE 27
Beef Jerky thermal processing cycle

| | | | | Internal | | | |
|---|---|---|---|---|---|---|---|
| | | Dry | Wet | Tem- | Main | Exhaust | |
| Cook | Time | Bulb | Bulb | perature | Fan | Fan | Humidity/ |
| Step | (min)¹ | (° F.) | (° F.) | (° F.)² | Speed | Speed | Smoke |
| Cook | 30 | 129 | 0 | 0 | 7 | 0 | None |
| Smoke | 60 | 130 | 105 | 0 | 10 | 0 | Smoke |
| Cook | | | | | | | |
| Smoke | 30 | 145 | 120 | 0 | 10 | 0 | Smoke |
| Cook | | | | | | | |
| Smoke | 30 | 165 | 140 | 0 | 10 | 0 | Smoke |
| Cook | | | | | | | |
| Cook | 30 | 170 | 160 | 0 | 10 | 0 | Steam |
| Cook | 1 | 170 | 0 | 158 | 10 | 0 | Both |

¹Time showing 1 minute in this cook step was held for one minute at 160° F. once the internal temperature was reached.
²Internal temperature was monitored using data loggers in addition to the smokehouse temperature probe.
³Smoke consisted of a natural smoke blend

### 11.4 Summer Sausage Manufacture:

Summer Sausage was manufactured using ground chuck procured through a local supplier. This product came in frozen and was thawed 2 days prior to manufacture. Once thawed, the product was placed in a mixer and mixed for a total of 5 minutes following the formulations in Table 28 and Table 29. The spice seasoning, dextrose and either water, SS or NFE was added according to treatment and mixed for 4 minutes. The starter culture was then added to the mixture for the last minute and the product was placed in the handtmann stuffer and stuffed into 1.5″ mahogany casings. Summer sausage was fermented overnight to a pH of 4.8 prior to following a thermal processing schedule shown in Table 30. Once the product was cooked and cooled it was packaged and held for two weeks until sensory analysis began.

TABLE 28
Summer sausage manufacture formulations¹

| | | | Spice | |
|---|---|---|---|---|
| | Water | Salt | Seasoning | SS/NFE |
| Treatment | (g) | (g) | (g) | (g) |
| SS 25% | 876.22 | 170.55 | 216.73 | 413.87 |
| SS 50% | 517.56 | 113.40 | 216.73 | 827.74 |
| SS 75% | 158.90 | 159.66 | 216.73 | 1241.61 |
| NFE 25% | 821.74 | 170.55 | 216.73 | 467.05 |
| NFE 50% | 408.60 | 113.40 | 216.73 | 934.10 |
| NFE 75% | 0.00 | 56.79 | 216.73 | 1401.15 |
| Control | 1184.94 | 205.57 | 216.73 | 0.00 |

¹Summer sausage treatments consisted of 20 lbs. raw meat block per treatment.
²Water volume decreased from added water with increasing SS/NFE inclusion
³Seasoning blend consisted of dextrose, black pepper, whole mustard seed, ground mustard, coriander, garlic powder, nutmeg, allspice, starter culture, sodium erythorbate and cure (6.25% sodium nitrite) shown in Table 29.

TABLE 29
Summer sausage seasoning blend¹

| | Formulation |
|---|---|
| Ingredient | (g) |
| Dextrose | 68.04 |
| Coriander | 31.75 |
| Black pepper | 27.22 |
| Ground mustard | 22.66 |
| Cure (6.25% sodium | 22.64 |
| nitrite) | |
| Whole mustard seed | 17.91 |
| Garlic powder | 9.07 |
| Sodium erythorbate | 4.96 |
| Nutmeg | 4.54 |
| Allspice | 4.54 |
| Starter Culture² | 3.40 |

¹Seasoning blend remained constant throughout all treatments of bacon
²Kerry Saga 200 lactic acid starter culture

TABLE 30
Summer Sausage thermal processing cycle

| | | | | Internal | | | |
|---|---|---|---|---|---|---|---|
| | | Dry | Wet | Tem- | Main | Exhaust | Humidity |
| Cook | Time | Bulb | Bulb | perature | Fan | Fan | (Water or |
| Step | (min)¹ | (° F.) | (° F.) | (° F.)² | Speed | Speed | Steam) |
| Cook | 720 | 105 | 103 | 0 | 3 | 0 | Both |
| Cook | 60 | 130 | 100 | 0 | 10 | 10 | Off |
| Smoke | 90 | 145 | 120 | 0 | 10 | 0 | Smoke³ |
| Cook | | | | | | | |
| Cook | 60 | 160 | 120 | 0 | 10 | 0 | Steam |
| Cook | 60 | 165 | 135 | 0 | 10 | 0 | Steam |
| Cook | 1 | 170 | 145 | 160 | 10 | 0 | Steam |
| Cold | 30 | 30 | 40 | 0 | 10 | 10 | Off |
| Shower | | | | | | | |

¹Time showing 1 minute in this cook step was held for one minute at 160° F. once the internal temperature was reached.
²Internal temperature was monitored using data loggers in addition to the smokehouse temperature probe.
³Smoke consisted of a natural smoke blend

### 11.5 Results:

11.5.1 Descriptive Sensory Panel:

The Descriptive sensory panel consisted of 13 panelists trained using commercial samples representing each product tested. Sampling of products occurred over eight-one hour sessions spanning over four days with a makeup day after each product manufacture testing period. Each product consisted of a set scale of 15 points. The scale ranged from a low value (0) resulting in a weak/no perception of an attribute to a high value (15) resulting in a very high perception of the attribute. Table 31 shows a description of all attributes used in this study.

TABLE 31
Descriptive sensory attribute list.

| | |
|---|---|
| Attributes | Attribute definition |

Basic Flavors

| | |
|---|---|
| Salt¹ | Basic taste sensation elicited by salt |
| Sweet¹ | Basic taste sensation elicited by sugars |
| Acid¹ | Basic taste sensation elicited by acids |
| Bitter¹ | Basic taste sensation elicited by bitter compounds, perceived as unpleasant |
| Umami¹ | Basic taste sensation elicited by amino acids and nucleotides. Appetitive |
| | tastes, savoriness. Induces salivation and furriness sensation on tongue, |
| | throat, roof, and back of the mouth |

Meat Specific Attributes

| | |
|---|---|
| Soy Sauce/NFE¹ | Aromatic note peculiar of soy sauce |
| Phosphate^{2,} | Aromatic taste of bitter, metallic, chemical associated with processed meats. |
| Caramelized² | Sweet aromatic characteristic of browned sugars |
| Pork Cured² | Aromatic associated with cured lean pork, lean smoked cured pork |
| Pork Fatty² | The flavor of fatty pork (coating of inside of mouth) |
| Smoked^{2,3,4} | Perception of any type of smoke flavor, may be phenol like. |
| Beef Cured³ | Aromatic associated with cooked beef muscle meat. Combination of beefy |
| | and brothy/brothlike |
| Black Pepper^{3,4} | Spicy pungent aromatic characteristic of freshly ground black pepper |
| Coriander⁵ | The sweet, citrus/lemony, almost minty and musty aroma characteristic of the |
| | spice coriander |
| Garlic⁵ | Aromatic associated with garlic |
| Mustard⁵ | Aromatic and heat associated with mustard |

Texture

| | |
|---|---|
| Hand Firmness⁴ | Strength required to compress a cube 30% |
| First Chew Hardness³ | Using incisors measure the amount of energy required to bite through a cube |
| | of product |
| Cohesiveness^{2,3,4,5} | Chew sample seven times, bring particles to center of mouth and observe |
| | how much the product stuck together or broke apart |
| Chewiness^{2,3} | Number of chews to prepare for swallowing/expectoration |
| Crispiness² | The degree of sound made by chewing a sample |

Chemical Feeling Factors

| | |
|---|---|
| Astringent¹ | Puckering, drying associated with tannins or alum |
| Burn¹ | High concentration of irritants of the mucous membranes of the mouth |
| Metallic¹ | Flat chemical feeling factor stimulated on the tongue |

¹Attribute for all products evaluated in this study
²Product specific for bacon evaluation
³Product specific for beef jerky evaluation
⁴Product specific for summer sausage evaluation

11.5.2 Bacon Results:

Bacon sensory results are shown in Table 32. Salt and umami attributes saw increases with increasing treatments of SS/NFE up to 50%. In both SS 75% and NFE 75% decreases in salt and umami were observed but were slight (0.5 on a scale of 15). Bacon specific attributes included pork cured, pork fatty, soy sauce, smoked, caramelized and phosphate. Pork cured and pork fatty both decreased with increasing addition of SS/NFE. Soy sauce flavor increased in both SS and NFE. Soy sauce treatments increased at a higher rate than NFE treatments. Smoked, caramelized and phosphate did not increase or decrease with any trend with increasing SS/NFE replacement. Texture for both SS and NFE treatments did not vary throughout each treatment but again saw some variations based on inherent differences between each treatment. Chemical feeling factors did not show much difference throughout the treatments. Analytical tests were performed and are shown in Tables 35-38. Color analysis showed some darkening of the lean and fat but was also due to smoke color present in the exterior of the product. Puncture force tests were performed to evaluate the softness of the product which showed no major variations with each treatment. Proximate analysis tests showed variation as bellies have some variation in lean/fat ratio. Results showed that SS and NFE, when added to bacon significantly (P<0.05) increased the salt perception up to a 50% inclusion level and provided a numerical, but not significant increase at 75% when compared to the control. Despite inherent normal compositional variations found in bellies, no major variations were observed for any objective analytical, texture and color analyses and thus no negative impact was observed from the use of SS and NFE.

11.5.3 Beef Jerky Results:

Beef jerky sensory results are shown in Table 33. Saltiness perception increased in both SS and NFE as the levels were increased. Umami also increased with addition of SS/NFE. Specific attributes for beef jerky include beef cured, black pepper, soy sauce and smoked flavor. An enhancing effect in black pepper was observed however not significant. Cohesiveness decreased with addition of SS/NFE however some variation in product can occur. Chewiness increased with increasing SS/NFE while hardness did not change significantly. Burn perception increased with addition of SS and NFE. Analytical tests performed on beef jerky were consistent with other products shown in Tables 39-41. Color analysis did not show major changes to color with addition of SS/NFE. Texture analysis showed some differences in hardness, springiness, cohesiveness. Results showed that both SS and NFE had a significant (P<0.05) increasing effect for saltiness and umami at all levels tested. The results also showed that inclusion of SS and NFE did not have an effect on proximate analysis and overall texture of the product.

11.5.4 Summer Sausage Results:

Summer sausage results are shown in Table 34. With increasing SS/NFE replacement, increases in saltiness and umami were shown. Sweetness, acid and bitter did not vary with increasing levels. Summer sausage specific attributes included coriander, garlic, mustard, black pepper, soy sauce and smoked flavors. Coriander, mustard and black pepper saw a decrease with increasing levels of soy sauce while garlic was enhanced with low levels of soy sauce. Texture results showed a slight decrease in firmness with SS/NFE inclusion but no major differences were shown in first chew hardness and cohesiveness. Summer sausage analytical results were carried out on all treatments in the same methods used as all other products shown in Tables 42-44. The color analysis of summer sausage did not show an increase or decrease with SS/NFE inclusion. The texture profile analysis also did not show much change from the control treatment with increasing SS/NFE inclusion. Chemical feeling factors did not show major differences in products. Results from this study showed that when increasing concentrations of SS and NFE were used for replacement of salt, potentiation significantly (P<0.05) increased at all inclusion levels investigated. Further, greater umami and garlic levels were also noted. Quality characteristics including color, texture, and pH were not affected by the addition of SS and NFE in any of the treatments.

TABLE 32
Least Squares Means of Bacon Sensory Results
Soy Sauce Sensory Results

| | | | | | |
|---|---|---|---|---|---|
| Treatments¹ | Control | SS 25 | SS 50 | SS 75 | SEM³ |

Basic Flavors²

| | | | | | |
|---|---|---|---|---|---|
| Salt | 7.98^{c} | 8.89^{ab} | 8.99^{a} | 8.44^{bc} | 0.09 |
| Sweet | 0.82^{a} | 0.91^{a} | 0.94^{a} | 0.99^{a} | 0.04 |
| Acid | 0.48^{b} | 0.49^{b} | 0.49^{b} | 0.68^{a} | 0.03 |
| Bitter | 0.092^{a} | 0.043^{a} | 0.107^{a} | 0.101^{a} | 0.020 |
| Umami | 6.65^{b} | 7.06^{a} | 7.27^{a} | 7.04^{a} | 0.07 |

Bacon Specific Attributes²

| | | | | | |
|---|---|---|---|---|---|
| Pork Cured | 6.11^{a} | 5.42^{b} | 5.52^{b} | 5.38^{b} | 0.08 |
| Pork Fatty | 5.4^{a} | 4.93^{ab} | 3.99^{c} | 4.42^{bc} | 0.11 |
| Soy Sauce | 0.07^{c} | 0.65^{b} | 1.40^{a} | 1.54^{a} | 0.08 |
| Smoked | 2.22^{a} | 2.33^{a} | 2.23^{a} | 2.22^{a} | 0.07 |
| Caramelized | 0.93^{b} | 1.14^{ab} | 1.44^{a} | 1.25^{ab} | 0.08 |
| Phosphate | 1.23^{ab} | 1.21^{ab} | 1.47^{a} | 0.95^{b} | 0.06 |

Texture²

| | | | | | |
|---|---|---|---|---|---|
| Cohesiveness | 5.98^{a} | 5.99^{a} | 5.55^{a} | 5.79^{a} | 0.12 |
| Chewiness | 5.09^{a} | 4.95^{a} | 4.95^{a} | 4.95^{a} | 0.09 |
| Crispiness | 4.06^{b} | 4.92^{a} | 5.09^{a} | 4.99^{a} | 0.14 |

Chemical Feeling Factors²

| | | | | | |
|---|---|---|---|---|---|
| Astringent | 2.02^{b} | 2.23^{ab} | 2.47^{a} | 2.22^{ab} | 0.06 |
| Burn | 0.53^{c} | 0.94^{b} | 1.30^{a} | 0.85^{b} | 0.06 |
| Metallic | 0.85^{a} | 1.01^{a} | 1.02^{a} | 1.08^{a} | 0.05 |

Natural Flavor Enhancer Sensory Results

| | | | | |
|---|---|---|---|---|
| Control | NFE 25 | NFE 50 | NFE 75 | SEM³ |

Basic Flavors²

| | | | | | |
|---|---|---|---|---|---|
| Salt | 7.98^{c} | 8.69^{ab} | 8.92^{a} | 8.41^{bc} | 0.09 |
| Sweet | 0.82^{a} | 0.76^{a} | 0.78^{a} | 0.83^{a} | 0.04 |
| Acid | 0.48^{a} | 0.47^{a} | 0.43^{a} | 0.48^{a} | 0.03 |
| Bitter | 0.092^{a} | 0.102^{a} | 0.029^{a} | 0.095^{a} | 0.03 |
| Umami | 6.65^{b} | 7.01^{ab} | 7.35^{a} | 6.89^{b} | 0.08 |

Bacon Specific Attributes²

| | | | | | |
|---|---|---|---|---|---|
| Pork Cured | 6.11^{a} | 5.83^{ab} | 5.65^{b} | 5.49^{b} | 0.07 |
| Pork Fatty | 5.4^{a} | 4.73^{b} | 4.28^{bc} | 4.03^{c} | 0.10 |
| Soy Sauce | 0.07^{c} | 0.49^{b} | 0.96^{a} | 1.17^{a} | 0.07 |
| Smoked | 2.22^{a} | 2.15^{a} | 2.28^{a} | 2.02^{a} | 0.07 |
| Caramelized | 0.93^{a} | 1.19^{a} | 1.09^{a} | 1.28^{a} | 0.08 |
| Phosphate | 1.28^{a} | 1.30^{a} | 1.06^{a} | 1.30^{a} | 0.06 |

Texture²

| | | | | | |
|---|---|---|---|---|---|
| Cohesiveness | 5.98^{a} | 5.64^{a} | 5.63^{a} | 5.67^{a} | 0.11 |
| Chewiness | 5.09^{a} | 4.87^{ab} | 5.22^{a} | 4.49^{b} | 0.08 |
| Crispiness | 4.06^{b} | 4.91^{ab} | 4.73^{ab} | 5.14^{a} | 0.16 |

Chemical Feeling Factors²

| | | | | | |
|---|---|---|---|---|---|
| Astringent | 2.02^{b} | 2.43^{a} | 2.26^{ab} | 2.22^{ab} | 0.05 |
| Burn | 0.53^{b} | 0.78^{a} | 0.80^{a} | 0.84^{a} | 0.04 |
| Metallic | 0.85^{a} | 0.95^{a} | 0.87^{a} | 1.00^{a} | 0.04 |

¹Treatments (SS 25 = Soy Sauce 25%, NFE 25 = Natural Flavor Enhancer 25%).
^{a-c}Within a row and each product type (soy sauce and natural flavor enhancer), means without a common superscript differ (P < 0.05).
²Attribute definitions can be found in Table 34.
³SEM = Standard error of the means

TABLE 33
Least Squares Means of Beef Jerky Sensory Results
Soy Sauce Sensory Results

| | | | | | |
|---|---|---|---|---|---|
| Treatments¹ | Control | SS 25 | SS 50 | SS 75 | SEM³ |

Basic Flavors²

| | | | | | |
|---|---|---|---|---|---|
| Salt | 8.57^{b} | 9.42^{a} | 8.54^{b} | 8.73^{b} | 0.09 |
| Sweet | 1.17^{a} | 1.05^{a} | 1.08^{a} | 1.11^{a} | 0.04 |
| Acid | 1.05^{a} | 1.07^{a} | 1.11^{a} | 1.12^{a} | 0.04 |
| Bitter | 0.035^{a} | 0.12^{a} | 0.007^{a} | 0.12^{a} | 0.02 |
| Umami | 5.69^{c} | 6.55^{a} | 6.01^{bc} | 6.23^{ab} | 0.08 |

Beef Jerky Specific Attributes²

| | | | | | |
|---|---|---|---|---|---|
| Beef Cured | 4.59^{a} | 4.6^{a} | 4.71^{a} | 4.44^{a} | 0.06 |
| Black Pepper | 3.22^{a} | 3.26^{a} | 3.41^{a} | 3.44^{a} | 0.09 |
| Soy Sauce | 0.74^{b} | 1.16^{ab} | 1.38^{a} | 1.37^{a} | 0.11 |
| Smoked | 4.31^{a} | 4.13^{a} | 4.23^{a} | 4.1^{a} | 0.06 |

Texture²

| | | | | | |
|---|---|---|---|---|---|
| Hardness | 11.49^{a} | 11.67^{a} | 11.71^{a} | 11.27^{a} | 0.11 |
| Cohesiveness | 4.23^{a} | 3.58^{ab} | 3.42^{bc} | 2.78^{c} | 0.13 |
| Chewiness | 9.96^{a} | 9.76^{ab} | 10.00^{a} | 9.11^{b} | 0.12 |

Chemical Feeling Factors²

| | | | | | |
|---|---|---|---|---|---|
| Astringent | 1.65^{b} | 2.03^{a} | 1.8^{ab} | 1.95^{ab} | 0.06 |
| Burn | 3.30^{b} | 4.22^{a} | 3.69^{bc} | 3.67^{b} | 0.09 |
| Metallic | 3.20^{a} | 3.60^{a} | 3.28^{a} | 3.54^{a} | 0.09 |

Natural Flavor Enhancer Sensory Results

| | | | | | |
|---|---|---|---|---|---|
| Treatments¹ | Control | NFE 25 | NFE 50 | NFE 75 | SEM³ |

Basic Flavors

| | | | | | |
|---|---|---|---|---|---|
| Salt | 8.62^{a} | 8.76^{a} | 8.69^{a} | 8.86^{a} | 0.09 |
| Sweet | 1.15^{a} | 1.04^{a} | 1.1^{a} | 1.03^{a} | 0.04 |
| Acid | 1.03^{a} | 1.08^{a} | 1.07^{a} | 1.21^{a} | 0.04 |
| Bitter | 0.032^{a} | 0.058^{a} | 0.016^{a} | 0.032^{a} | 0.013 |
| Umami | 5.71^{c} | 6.23^{ab} | 6.03^{bc} | 6.47^{a} | 0.08 |

Beef Jerky Specific Attributes²

| | | | | | |
|---|---|---|---|---|---|
| Beef Cured | 4.58^{a} | 4.24^{a} | 4.44^{a} | 4.35^{a} | 0.07 |
| Black Pepper | 3.15^{a} | 3.31^{a} | 3.44^{a} | 3.09^{a} | 0.08 |
| Soy Sauce | 0.66^{c} | 1.00^{bc} | 1.20^{b} | 1.85^{a} | 0.10 |
| Smoked | 4.33^{a} | 4.08^{ab} | 3.80^{b} | 3.84^{b} | 0.06 |

Texture²

| | | | | | |
|---|---|---|---|---|---|
| Hardness | 11.54^{a} | 10.13^{b} | 10.27^{b} | 9.93^{b} | 0.11 |
| Cohesiveness | 4.21^{a} | 3.52^{ab} | 2.89^{b} | 3.5^{ab} | 0.14 |
| Chewiness | 10.01^{a} | 8.81^{b} | 8.41^{b} | 8.22^{b} | 0.12 |

Chemical Feeling Factors²

| | | | | | |
|---|---|---|---|---|---|
| Astringent | 1.66^{a} | 1.83^{a} | 1.66^{a} | 1.83^{a} | 0.05 |
| Burn | 3.30^{b} | 3.67^{ab} | 3.61^{ab} | 3.94^{a} | 0.08 |
| Metallic | 3.22^{a} | 3.54^{a} | 3.46^{a} | 3.40^{a} | 0.09 |

¹Treatments (SS 25 = Soy Sauce 25%, NFE 25 = Natural Flavor Enhancer 25%).
^{a-c}Within a row and each product type (soy sauce and natural flavor enhancer), means without a common superscript differ (P < 0.05).
²Attribute definitions can be found in Table 34.
³SEM = Standard error of the means

TABLE 34
Least Squares Means of Summer Sausage Sensory Results
Soy Sauce Sensory Results

| | | | | | |
|---|---|---|---|---|---|
| Treatments¹ | Control | SS 25 | SS 50 | SS 75 | SEM³ |

Basic Flavors²

| | | | | | |
|---|---|---|---|---|---|
| Salt | 5.21^{b} | 5.96^{a} | 6.20^{a} | 6.42^{a} | 0.10 |
| Sweet | 0.66^{a} | 0.45^{a} | 0.54^{a} | 0.54^{a} | 0.04 |
| Acid | 4.94^{a} | 5.17^{a} | 4.88^{a} | 5.00^{a} | 0.09 |
| Bitter | 0.026^{ab} | 0.001^{b} | 0.002^{b} | 0.097^{a} | 0.01 |
| Umami | 3.62^{c} | 4.31^{ab} | 4.11^{bc} | 4.65^{a} | 0.09 |

Summer Sausage Attributes²

| | | | | | |
|---|---|---|---|---|---|
| Coriander | 4.73^{a} | 3.86^{b} | 4.25^{ab} | 4.45^{ab} | 0.15 |
| Garlic | 4.47^{a} | 4.81^{a} | 4.60^{a} | 4.39^{a} | 0.12 |
| Mustard | 4.06^{a} | 3.97^{a} | 3.82^{a} | 3.66^{a} | 0.10 |
| Black Pepper | 3.66^{a} | 3.42^{ab} | 3.44^{ab} | 2.96^{b} | 0.10 |
| Soy Sauce | 0.05^{c} | 1.00^{b} | 1.28^{b} | 2.00^{a} | 0.11 |
| Smoked | 4.06^{a} | 4.15^{a} | 3.96^{a} | 3.66^{a} | 0.10 |

Texture²

| | | | | | |
|---|---|---|---|---|---|
| Hand Firmness | 10.16^{a} | 9.33^{b} | 10.02^{a} | 9.96^{a} | 0.11 |
| First Chew | 5.07^{a} | 4.98^{a} | 5.15^{a} | 4.97^{a} | 0.07 |
| Hardness | | | | | |
| Cohesiveness | 6.78^{a} | 6.87^{a} | 6.9^{a} | 6.59^{a} | 0.09 |

Chemical Feeling Factors²

| | | | | | |
|---|---|---|---|---|---|
| Metallic | 0.33^{a} | 0.36^{a} | 0.26^{a} | 0.26^{a} | 0.03 |
| Astringent | 1.85^{a} | 1.85^{a} | 1.83^{a} | 1.71^{a} | 0.06 |
| Burn | 2.58^{a} | 2.45^{a} | 2.87^{a} | 2.8^{a} | 0.09 |

Natural Flavor Enhancer Sensory Results

| | | | | | |
|---|---|---|---|---|---|
| Treatments¹ | Control | NFE 25 | NFE 50 | NFE 75 | SEM³ |

Basic Flavors²

| | | | | | |
|---|---|---|---|---|---|
| Salt | 5.22^{b} | 5.86^{a} | 6.15^{a} | 5.89^{a} | 0.10 |
| Sweet | 0.66^{a} | 0.54^{a} | 0.64^{a} | 0.7^{a} | 0.05 |
| Acid | 4.93^{a} | 4.94^{a} | 5.05^{a} | 5.08^{a} | 0.09 |
| Bitter | 0.025^{a} | 0.039^{a} | 0.037^{a} | 0.078^{a} | 0.01 |
| Umami | 3.60^{c} | 4.05^{bc} | 4.46^{ab} | 4.65^{a} | 0.09 |

Summer Sausage Attributes²

| | | | | | |
|---|---|---|---|---|---|
| Coriander | 4.62^{a} | 4.54^{a} | 4.20^{a} | 4.12^{a} | 0.14 |
| Garlic | 4.50^{a} | 4.90^{a} | 4.32^{a} | 4.67^{a} | 0.13 |
| Mustard | 4.09^{a} | 3.81^{a} | 4.00^{a} | 3.94^{a} | 0.10 |
| Black Pepper | 3.62^{a} | 3.46^{a} | 3.64^{a} | 3.45^{a} | 0.11 |
| Soy Sauce | 0.03^{d} | 0.87^{c} | 1.88^{b} | 2.87^{a} | 0.12 |
| Smoked | 4.09^{ab} | 4.28^{a} | 3.53^{b} | 3.59^{b} | 0.11 |

Texture²

| | | | | | |
|---|---|---|---|---|---|
| Hand Firmness | 10.16^{a} | 9.07^{b} | 9.09^{b} | 9.46^{b} | 0.11 |
| First Chew | 5.09^{a} | 4.80^{a} | 4.94^{a} | 4.72^{a} | 1.00 |
| Hardness | | | | | |
| Cohesiveness | 6.72^{a} | 7.09^{a} | 6.8^{a} | 7.17^{a} | 0.10 |

Chemical Feeling Factors²

| | | | | | |
|---|---|---|---|---|---|
| Metallic | 0.33^{a} | 0.38^{a} | 0.30^{a} | 0.33^{a} | 0.04 |
| Astringent | 1.86^{a} | 1.79^{a} | 1.88^{a} | 1.79^{a} | 0.06 |
| Burn | 2.62^{b} | 3.25^{a} | 3.11^{ab} | 3.05^{ab} | 0.10 |

¹Treatments (SS 25 = Soy Sauce 25%, NFE 25 = Natural Flavor Enhancer 25%).
^{a-d}Within a row and each product type (soy sauce and natural flavor enhancer), means without a common superscript differ (P < 0.05).
²Attribute definitions can be found in Table 34.
³SEM = Standard error of the means

TABLE 35
Bacon Color Analysis (Lean)^{1,2}

| | External | | | | | |
|---|---|---|---|---|---|---|
| Treatment | L* | External a* | External b* | Internal L* | Internal a* | Internal b* |
| Control | 36.82 ± 1.07 | 16.58 ± 0.40 | 18.02 ± 1.21 | 55.48 ± 7.65 | 11.00 ± 4.69 | 6.28 ± 0.51 |
| SS 25 | 38.05 ± 2.40 | 15.79 ± 0.36 | 17.02 ± 1.19 | 52.58 ± 3.70 | 9.14 ± 1.78 | 13.29 ± 4.07 |
| SS 50 | 37.14 ± 0.91 | 15.02 ± 1.57 | 16.08 ± 0.84 | 47.41 ± 5.13 | 11.43 ± 0.68 | 13.81 ± 3.36 |
| SS 75 | 34.41 ± 1.12 | 13.47 ± 0.58 | 14.70 ± 1.20 | 49.24 ± 3.87 | 8.56 ± 3.29 | 15.44 ± 3.28 |
| NFE 25 | 34.70 ± 1.19 | 15.89 ± 2.15 | 14.16 ± 1.60 | 51.82 ± 8.72 | 11.69 ± 1.98 | 10.87 ± 0.11 |
| NFE 50 | 39.00 ± 0.63 | 15.13 ± .60 | 18.37 ± 2.84 | 54.58 ± 3.67 | 9.76 ± 2.50 | 11.83 ± 1.55 |
| NFE 75 | 37.15 ± 2.45 | 14.64 ± 1.81 | 17.29 ± 4.39 | 50.39 ± 4.65 | 9.48 ± 1.29 | 12.41 ± 2.88 |

¹Commision Internationale de l'Eclairage (CIE)L* = lightness a* = redness b* = yellowness.
²Mean ± standard deviation reported.

TABLE 36
Bacon Color Analysis (Fat)^{1,2}

| | External | | | | Internal | |
|---|---|---|---|---|---|---|
| Treatment | L* | External a* | External b* | Internal L* | a* | Internal b* |
| Control | 69.78 ± 2.28 | 7.25 ± 1.44 | 28.58 ± 2.57 | 82.66 ± 1.59 | 4.61 ± 0.39 | 8.27 ± 1.72 |
| SS 25 | 65.62 ± 3.08 | 10.43 ± 2.69 | 31.86 ± 2.88 | 74.69 ± 2.46 | 5.92 ± 1.50 | 18.26 ± 2.19 |
| SS 50 | 63.93 ± 3.44 | 11.22 ± 1.43 | 33.35 ± 1.40 | 75.87 ± 0.55 | 7.00 ± 0.60 | 16.39 ± 0.72 |
| SS 75 | 63.87 ± 3.30 | 13.30 ± 0.13 | 34.48 ± 1.24 | 74.89 ± 2.95 | 5.60 ± 1.09 | 17.74 ± 2.11 |
| NFE 25 | 67.48 ± 1.90 | 8.69 ± 0.95 | 29.99 ± 3.42 | 77.85 ± 1.89 | 7.42 ± 1.39 | 14.02 ± 2.91 |
| NFE 50 | 63.21 ± 2.47 | 14.45 ± 2.41 | 33.82 ± 2.49 | 77.39 ± 1.41 | 5.88 ± 0.41 | 17.28 ± 0.38 |
| NFE 75 | 65.29 ± 4.12 | 10.09 ± 0.74 | 31.19 ± 0.53 | 73.87 ± 3.50 | 4.88 ± 2.56 | 16.40 ± 3.41 |

¹Commision Internationale de l'Eclairage (CIE)L* = lightness a* = redness b* = yellowness.
²Mean ± standard deviation reported.

TABLE 37
Bacon Proximate Analysis, Salt/pH and Cook Yields¹

| | | Salt | Moistures | Protein | Cook Yield |
|---|---|---|---|---|---|
| Treatment | pH | (%)² | (%) | (%) | (%)³ |
| Control | 6.125 ± .23 | 2.16 ± .13 | 47.82 ± 0.04 | 13.78 ± 1.00 | 97.79 ± .03 |
| SS 25 | 6.306 ± .17 | 2.14 ± .32 | 47.57 ± 0.05 | 12.28 ± 1.66 | 100.52 ± .02 |
| SS 50 | 6.237 ± .11 | 2.43 ± .09 | 48.93 ± 0.01 | 15.80 ± 0.78 | 99.48 ± .01 |
| SS 75 | 6.161 ± .12 | 2.34 ± .21 | 47.34 ± 0.04 | 15.76 ± 1.37 | 99.88 ± .01 |
| NFE 25 | 6.530 ± .05 | 2.24 ± .04 | 46.03 ± 0.05 | 13.24 ± 2.14 | 100.58 ± .01 |
| NFE 50 | 6.208 ± .06 | 2.38 ± .30 | 49.27 ± 0.04 | 16.78 ± 1.39 | 99.92 ± .01 |
| NFE 75 | 6.300 ± .06 | 1.76 ± .20 | 51.52 ± 0.04 | 16.15 ± 1.23 | 99.09 ± .02 |

¹Mean ± standard deviation reported.
²Salt measured by chloride ion determination using Quantab rapid test strips.
³Cook yield = ((raw weight/cooked weight) × 100).

TABLE 38
Bacon puncture force test.

| | Lean | | Fat | |
|---|---|---|---|---|
| Treatment | Force¹ | Energy² | Force¹ | Energy² |
| Control | 2.88 ± 0.57 | 5.79 ± 1.37 | 2.19 ± 0.56 | 4.08 ± 1.40 |
| SS 25 | 2.27 ± 0.76 | 5.10 ± 2.10 | 1.72 ± 0.64 | 3.53 ± 1.25 |
| SS 50 | 3.66 ± 1.16 | 8.34 ± 3.14 | 2.16 ± 0.64 | 4.52 ± 1.47 |
| SS 75 | 2.95 ± 0.78 | 5.84 ± 2.50 | 1.61 ± 0.39 | 2.63 ± 0.50 |
| NFE 25 | 3.24 ± 0.73 | 6.63 ± 2.24 | 2.30 ± 0.86 | 3.80 ± 1.38 |
| NFE 50 | 3.23 ± 1.33 | 6.48 ± 2.15 | 2.44 ± 1.65 | 4.59 ± 3.05 |
| NFE 75 | 2.76 ± 0.49 | 5.39 ± 1.00 | 1.74 ± 0.39 | 3.30 ± 0.90 |

¹Peak force = maximum force during puncture of sample.
²Total energy = total energy during puncture of sample (area under the curve)

TABLE 39
Beef Jerky color analysis^{1,2}

| | External | External | External | | | Internal |
|---|---|---|---|---|---|---|
| Treatment | L* | a* | b* | Internal L* | Internal a* | b* |
| Control | 27.21 ± 1.27 | 9.78 ± .96 | 5.20 ± 1.95 | 24.54 ± 1.29 | 10.30 ± 0.22 | 6.31 ± 1.89 |
| SS 25 | 25.24 ± 1.28 | 7.84 ± 1.31 | 5.08 ± 0.99 | 24.02 ± 0.86 | 8.45 ± 0.76 | 5.74 ± 1.25 |
| SS 50 | 26.14 ± 3.08 | 6.63 ± 1.77 | 4.30 ± 1.13 | 25.32 ± 1.26 | 8.20 ± 1.49 | 6.43 ± 1.04 |
| SS 75 | 25.58 ± 1.04 | 7.50 ± 2.24 | 4.97 ± 0.61 | 22.64 ± 0.44 | 8.41 ± 2.06 | 7.00 ± 0.18 |
| NFE 25 | 26.64 ± 1.16 | 9.86 ± 1.80 | 5.85 ± 0.97 | 27.44 ± 0.83 | 10.75 ± 1.70 | 7.96 ± 0.29 |
| NFE 50 | 26.59 ± 1.28 | 8.33 ± 1.21 | 5.49 ± 1.63 | 27.42 ± 1.04 | 9.39 ± 0.21 | 8.31 ± 1.22 |
| NFE 75 | 27.64 ± 0.81 | 8.62 ± 1.47 | 5.90 ± 1.81 | 26.68 ± 0.96 | 10.44 ± 1.06 | 8.56 ± 1.31 |

¹Commision Internationale de l'Eclairage (CIE)L* = lightness a* = redness b* = yellowness.
²Mean ± standard deviation reported.

TABLE 40
Beef Jerky proximate analysis, salt/pH and cook yields¹

| | | Salt | Moisture | Protein | Cook Yields |
|---|---|---|---|---|---|
| Treatment | pH | (%)² | (%) | (%) | (%)³ |
| Control | 5.479 ± .06 | 7.36 ± .15 | 35.77 ± .02 | 47.95 ± .35 | 56.68 ± 3.50 |
| SS 25 | 5.376 ± .07 | 7.26 ± .54 | 35.63 ± .01 | 43.11 ± 1.02 | 57.20 ± 1.3 |
| SS 50 | 5.327 ± .05 | 7.11 ± .36 | 34.68 ± .02 | 43.61 ± .96 | 55.49 ± .89 |
| SS 75 | 5.322 ± .06 | 6.56 ± .95 | 35.65 ± .05 | 44.35 ± 1.57 | 57.38 ± 1.5 |
| NFE 25 | 5.468 ± .03 | 6.22 ± .31 | 39.62 ± .03 | 44.87 ± .33 | 59.63 ± 2.4 |
| NFE 50 | 5.474 ± .03 | 6.27 ± .25 | 38.71 ± .04 | 46.69 ± 1.57 | 58.56 ± 1.5 |
| NFE 75 | 5.430 ± .02 | 6.47 ± .25 | 39.13 ± .03 | 46.65 ± 3.11 | 58.60 ± 1.3 |

¹Mean ± standard deviation reported.
²Salt measured by chloride ion determination using Quantab rapid test strips.
³Cook yield = ((raw weight/cooked weight) × 100).

TABLE 41
Beef Jerky Texture Profile Analysis

| Treatment | Force¹ | Springiness² | Cohesiveness³ | Gumminess⁴ | Chewiness⁵ |
|---|---|---|---|---|---|
| Control | 60.848 ± 12.94 | 1.018 ± .033 | 79.4 ± 6.3 | 48.361 ± 11.433 | 49.154 ± 11.36 |
| SS 25 | 36.747 ± 16.14 | 1.027 ± .041 | 80.8 ± 8.8 | 28.856 ± 11.194 | 29..453 ± 11.49 |
| SS 50 | 71.678 ± 13.60 | 1.372 ± 1.18 | 77.1 ± 5.6 | 55.735 ± 13.567 | 82.903 ± 9.08 |
| SS 75 | 33.047 ± 7.65 | 1.036 ± .040 | 80.4 ± 3.2 | 26.550 ± 6.159 | 27.592 ± 6.77 |
| NFE 25 | 82.387 ± 14.70 | 1.055 ± .040 | 78.9 ± 5.1 | 61.907 ± 13.326 | 65.412 ± 14.19 |
| NFE 50 | 40.474 ± 14.17 | 1.049 ± .044 | 80.1 ± 3.3 | 32.250 ± 10.847 | 33.875 ± 11.75 |
| NFE 75 | 34.069 ± 12.781 | 1.040 ± .100 | 84.0 ± 9.7 | 28.026 ± 10.812 | 29.189 ± 10.15 |

¹Force = the peak force during the first compression (compressed 50%).
²Springiness = the height the sample recovered during the time that elapses between the end of the first bite and the start of the second bite (both compressed 50%).
³Cohesiveness = the ratio of the positive force area during the second compression (50%) to that during the first compression (50%), calculated as ((Area 2/Area1) × 100).
⁴Gumminess = (Area 2/Area 1) × Force
⁵Chewiness = the product of (hardness × cohesiveness × springiness).

TABLE 42
Summer Sausage Color Analysis^{1,2}

| | External | External | External | | | |
|---|---|---|---|---|---|---|
| Treatment | L* | a* | b* | Internal L* | Internal a* | Internal b* |
| Control | 49.81 ± 1.68 | 15.38 ± 1.20 | 11.55 ± 0.38 | 40.57 ± 2.00 | 17.39 ± 1.15 | 16.08 ± 1.33 |
| SS 25 | 48.94 ± 1.21 | 22.74 ± 0.79 | 13.00 ± 0.41 | 32.82 ± 3.71 | 22.45 ± 1.76 | 16.78 ± 1.63 |
| SS 50 | 48.01 ± .90 | 13.58 ± 0.79 | 14.06 ± 0.55 | 39.73 ± 1.41 | 15.80 ± 1.79 | 16.61 ± 1.05 |
| SS 75 | 44.48 ± 1.09 | 14.24 ± 0.99 | 14.68 ± 0.15 | 38.92 ± 1.02 | 15.85 ± 0.44 | 16.16 ± 1.65 |
| NFE 25 | 49.14 ± 1.24 | 14.64 ± 0.80 | 12.43 ± 0.33 | 42.20 ± 3.00 | 16.52 ± 0.72 | 16.20 ± 2.08 |
| NFE 50 | 48.08 ± 0.96 | 14.07 ± 0.51 | 13.39 ± 0.89 | 39.39 ± 1.42 | 16.06 ± 0.90 | 16.03 ± 0.75 |
| NFE 75 | 46.94 ± 0.58 | 14.38 ± 0.49 | 14.17 ± 0.47 | 40.32 ± 1.85 | 15.65 ± 1.20 | 16.27 ± 0.96 |

¹Commision Internationale de l'Eclairage (CIE)L* = lightness a* = redness b* = yellowness.
²Mean ± standard deviation reported.

TABLE 43
Summer Sausage proximate analysis, pH/salt and cook yields¹

| | | Salt | Moisture | Proteins | Cook Yields |
|---|---|---|---|---|---|
| Treatment | pH | (%)² | (%) | (%) | (%)³ |
| Control | 4.523 ± .037 | 2.82 ± .06 | 59.86 ± .00 | 19.255 ± .96 | 83.11 ± .01 |
| SS 25 | 4.502 ± .041 | 3.02 ± 0.15 | 59.34 ± .01 | 19.050 ± .39 | 83.13 ± .01 |
| SS 50 | 4.540 ± .046 | 2.93 ± 0.20 | 59.26 ± .01 | 19.227 ± .22 | 83.56 ± .01 |
| SS 75 | 4.495 ± .026 | 2.61 ± 0.18 | 57.32 ± .03 | 19.855 ± .98 | 83.64 ± .01 |
| NFE 25 | 4.503 ± 0.030 | 3.27 ± 0.68 | 59.10 ± .00 | 18.784 ± .11 | 84.41 ± .04 |
| NFE 50 | 4.579 ± 0.048 | 2.57 ± 0.06 | 58.71 ± .01 | 19.003 ± .98 | 83.15 ± .01 |
| NFE 75 | 4.573 ± 0.004 | 2.70 ± 0.20 | 59.29 ± .01 | 19.602 ± .68 | 83.71 ± .01 |

¹Mean ± standard deviation reported.
²Salt measured by chloride ion determination using Quantab rapid test strips.
³Cook yield = ((raw weight/cooked weight) × 100).

TABLE 44
Summer Sausage texture profile analysis.

| Treatment | Force¹ | Cohesiveness² | Springiness³ | Chewiness⁴ |
|---|---|---|---|---|
| Control | 39.45 ± 5.72 | 48.0 ± 5.51 | 6.22 ± 3.11 | 118.27 ± .14 |
| SS 25 | 30.35 ± 2.37 | 43.9 ± 1.93 | 6.12 ± 0.79 | 81.53 ± .28 |
| SS 50 | 32.11 ± 3.53 | 51.2 ± 5.64 | 5.92 ± 1.85 | 96.80 ± .30 |
| SS 75 | 28.69 ± 3.46 | 44.2 ± 4.76 | 6.00 ± 1.93 | 75.99 ± .16 |
| NFE 25 | 26.76 ± 4.39 | 45.5 ± 4.79 | 6.09 ± 2.05 | 74.25 ± .18 |
| NFE 50 | 25.80 ± 4.48 | 46.1 ± 5.19 | 5.81 ± 2.27 | 69.13 ± .20 |
| NFE 75 | 25.03 ± 2.56 | 44.3 ± 3.83 | 6.07 ± 1.31 | 67.28 ± .23 |

¹Force = the peak force during the first compression (compressed 50%).
²Springiness = the height the sample recovered during the time that elapses between the end of the first bite and the start of the second bite (both compressed 50%).
³Cohesiveness = the ratio of the positive force area during the second compression (50%) to that during the first compression (50%), calculated as ((Area 2/Area1) × 100).
⁴Chewiness = the product of (hardness × cohesiveness × springiness).

### 12. Cheese Products:

The object of this series of examples was to investigate the impact of natural flavor enhancer (NFE) on the ability to enhance the salt taste perception of reduced sodium Cheddar cheeses without negatively affecting the quality and sensory attributes

### 12.1 Cheese Manufacture:

Cheddar cheese was manufactured by licensed Wisconsin cheese makers at the University of Wisconsin-Madison dairy processing plant. Three cheese vats, that can hold 300 kg of milk, were utilized to separately manufacture reduced sodium cheeses with different levels of NFE; control (no NFE), low (0.16% NFE) and high (0.32% NFE). Four independent batches of milled-curd Cheddar cheeses were produced within a three month period. A previous study carried out in our laboratory indicated that moisture content of cheese increased with a decrease in the NaCl content, thus we applied certain modifications to the cheese manufacturing procedure to try to keep the moisture levels to ˜37% (Grant, 2011).

Whole milk (3.58±0.07) was pasteurized at 73° C. for 19 s and cooled to 33.3° C. Direct vat-set culture consisting of mesophilic mixed-strain of Lactococcus lactis ssp. cremoris and Lactococcus lactis ssp. lactis (MA11, Danisco, Inc., Madison, Wis., USA) was used as starter culture, and was added at the rate of 8 g per 227 kg milk. Following a 60 minute ripening period chymosin (Chymax M (1000 IMCU/ml), Chr. Hansen, Milwaukee, Wis., USA) was added at the rate of 10.5 ml per 227 kg of milk. The coagula were cut on firmness (−20 min) as evaluated subjectively by an experienced licensed Wisconsin cheesemaker. The coagulum was cut with 4 mm knives with 12 extra passes made with the vertical knife to control moisture gain typical in reduced sodium cheeses.

The pH of the whey at cut was 6.54±0.02. After 20 minutes of forework, the curd-whey mixture was raised from ˜33 to 39° C. over 30 min. After reaching the cooking temperature each vat was stirred for 20 minutes and drained at a curd pH of 6.29±0.04. Curd slabs were cheddared with no stacking of the slabs. Slabs were milled at pH 5.59±0.02. Control (no NFE addition) cheeses were salted (Alberger Fine Flake Salt, Cargill Salt, Minneapolis, Minn., USA) at a rate of 450 g per 24.5 kg of cheese. Adjustments to salt levels were made for the low and the high NFE variables based on sodium content of the ingredient. NFE was blended with the salt at time of addition to the curd. Low NFE cheeses had 40 g NFE added to 441 g salt per 24.5 kg of cheese while high NFE cheeses had 80 g NFE added to 432 g salt per 24.5 kg cheese. All cheeses were salted over a 60 minute period and were hooped 30 minutes after last salting to keep moisture in target range. Curd was packed in 11 kg Wilson-style hoops and pressed at ambient temperature for 3 hours at a pressure of 280 kPa until the pH of the curds reached 5.17±0.07. Cheeses were then vacuum packed and was ripened for 3 months (mo) at 4° C. and analyzed at 2 weeks (wk), 5 wk and 3 mo.

### 12.2 Cheese Composition:

The cheeses were sampled after 3 wk for compositional analysis. Compositional analysis was performed in duplicate and included: total fat content by the Mojonnier method (AOAC, 2000), total protein content by the Kjeldahl method (N×6.38 conversion factor) (AOAC, 2000), moisture content by vacuum oven (Vanderwarn, 1989), cheese salt by chloride electrode (MKII Chloride Analyzer, Nelson Jameson, Marshfield, Wis.). Mineral analysis in cheese was determined using inductively coupled plasma (ICP) spectroscopy. The wavelengths of plasma emission used to measure the calcium and sodium contents were 318.1, 185.9 and 330.2 nm, respectively. During cheese ripening, pH was measured by the quinhydrone method (Marshall, 1992).

### 12.3 Texture Profile Analysis:

Texture Profile Analysis (TPA) was performed using a TA.X2 Texture Analyzer (Texture Tech. Corp, Scarsdale, N.Y.) equipped with a 5.1 cm aluminum cylinder test probe. Cheese cylinders (17.5 mm height and 16 mm diameter) were prepared using a cork borer and held at 4° C. overnight in a sealed plastic bag. Cheese samples were compressed to 70% of the original height in a double bite test at a speed of 0.8 mm/s. A drop of mineral oil was placed on top of the surface to aid lubrication. Texture parameters were determined from the force-deformation curves (Bourne, 1982). At least 8 replicates were performed for each treatment at all time points.

### 12.4 Descriptive Sensory Analysis:

Quantitative descriptive analysis (Herbert, 1992) was conducted to evaluate cheese flavor and texture with 10 trained panelists at 5 wks and 3 mo of ripening. Cheeses cubes (2×2×2 cm) were evaluated at 12° C. Cheeses were identified with random 3 digit numbers. Sensory panels were conducted in duplicate on two different days. A 15-point texture and flavor intensity scale was used to evaluate the following attributes: acid, bitter, salt, oxidized, metallic, and sulfur.

TABLE 45
A Description of the flavor and textural attributes that were evaluated during trained
descriptive panels.

| | |
|---|---|
| Attributes | Attribute definition |

Basic Flavors

| | |
|---|---|
| Salt | Basic taste sensation elicited by salt |
| Sweet | Basic taste sensation elicited by sugars |
| Acid | Basic taste sensation elicited by acids |
| Bitter | Basic taste sensation elicited by bitter compounds |
| Umami | Basic taste sensation elicited by amino acids and nucleotides. Appetitive |
| | tastes, savoriness. Induces salivation and furriness sensation on tongue, |
| | throat, roof, and back of the mouth |

Flavors/Sensations

| | |
|---|---|
| Milkfat | Aromatics associated with milk, fresh cream, fresh butter |
| Soy Sauce | Aromatics associated with soy sauce |
| Sulfur | Aromatics associated with sulfurous compounds |
| Metallic | Chemical feeling factor of metallic sensation in mouth |
| Oxidized (cardboard) | Aroma associated with wet cardboard |

Texture

| | |
|---|---|
| Hand Firmness | Amount of force required to compress the sample |
| First Chew Hardness | Amount of force required to completely bite through the sample |
| Cohesiveness of mass | Degree to which the chewed mass holds together or is broken apart |
| Chewiness | Degree of chewing needed to break up the sample, how much mastication is |
| | required |

Residual

| | |
|---|---|
| Astringent | Harsh, drying, puckering sensation on the surfaces of the mouth |

### 12.5 Consumer Sensory Analysis:

Consumer testing was conducted by consumer sensory panelists at the University of Wisconsin-Madison, Sensory Laboratory (Madison, Wis.). Reduced sodium cheeses manufactured with different NFE levels were evaluated over two days (6 hours per day). Cheeses were cut into 2-cm cubes and placed into 120-mL soufflé cups with lids and 3-digit codes. The cheeses were served at 12° C. Consumers (n=116) were provided with cheeses individually in a randomized balanced order. A screener was provided to the consumers to determine demographic information as well as their opinions about cheese and dairy products. Consumers indicated overall cheese acceptability, appearance liking, overall flavor liking, and texture liking using a hedonic scale (1=dislike extremely to 9=like extremely). Consumers were also asked to rate the flavor intensity of the cheeses (1=not intense to 7=very intense) and which sample they preferred. Consumers were provided with water and unsalted crackers to cleanse their palates. Panelists were rewarded with treats upon completion.

### 12.6 Experimental Design and Statistical Analysis:

Three treatments (different NFE levels; 0, low and high) were used to manufacture reduced sodium Cheddar cheeses, in quadriplicate; each cheesemaking trial was performed on four different days. A 3×4 completely randomized block design, which incorporated all 3 treatments and four trial days, was used for analysis of the response variables relating to cheese composition, textural and sensory analyses. Analysis of variance was carried out using the PROC GLM procedure of SAS (version 9.1; SAS Institute, 2002-2003). Scheffe's multiple-comparison test was used to evaluate differences in the treatments at a significance level of P<0.05 for cheese.

A split-plot design was used to monitor the effects of treatment (control, low NFE and high NFE) and ripening time and their interactions on pH and textural properties. In the whole-plot factor, treatment (control, low NFE and high NFE) was analysed as a discontinuous variable and cheesemaking day was blocked. For the subplot factor, age and age λ treatment were treated as variables. The interactive term treatment×day of cheesemaking was treated as the error term for the treatment effect. Analysis of variance for the split-plot design was carried out using PROC GLM of SAS. Fisher's least significant difference test was carried out to evaluate differences in the treatment (control, low NFE and high NFE) means at a significance level of P<0.05.

### 12.7 Results and Discussion:

12.7.1 Cheese Composition:

Previous study carried out in our laboratory (Grant, 2011) indicated that moisture content of cheese increased with a decrease in the salt content, thus we applied modifications to the cheese manufacturing procedure to try to keep the moisture levels to ˜37%, which is typical for Cheddar cheese. NFE, itself contains sodium so we accounted for this and adjustments to salt levels were made for the low and the high NFE treatments used, based on sodium content of the ingredient. Based on the amount of NFE powder (40 g for low and 80 g for high) and salt (441 g and 432 g) added to 24.5 kg of cheese curd, 2% and 4% of Na from the salt was replaced by the Na from NFE, for the low and high NFE cheeses, respectively. For the control cheeses, no NFE was added during the manufacture, thus the added salt exclusively contributed to the Na content in this cheese.

The moisture contents of all three cheeses were similar at 37% (P>0.05) (Table 46). No significant differences ((P>0.05) were found between the cheeses in regards to fat, protein, total calcium, and sodium contents. The fat in DM of the cheeses was within the typical range of values (−0.52) expected for Cheddar. As the moisture and the salt contents in all the cheeses were similar, there was no significant difference in the salt in moisture phase (S/M) between the cheeses. The manufacturing pH values at the critical points during cheese making were similar in the different treatment, which resulted in cheese having similar total calcium contents (Table 46). Thus adding NFE powder at the levels we had used during the manufacture did not have an impact on the composition of the cheeses.

TABLE 46
Composition of reduced sodium Cheddar cheese at 3 wk manufactured
with different levels of NFE (n = 4).

| | Treatments | | | |
|---|---|---|---|---|
| | | Reduced | Reduced | |
| | | Sodium | Sodium | |
| | | Cheese | Cheese | |
| | Reduced | made with | made with | |
| | Sodium | Low levels | High levels | |
| | Cheese | of NFE | of NFE | |
| Component | Control | Powder | Powder | SEM |
| Moisture, % | 36.5^{a} | 36.5^{a} | 37.0^{a} | 0.176 |
| Fat, % | 33.4^{a} | 33.4^{a} | 32.9^{a} | 0.106 |
| Total Proteins¹, % | 25.2^{a} | 25.1^{a} | 24.9^{a} | 0.066 |
| Salt², % | 1.31^{a} | 1.27^{a} | 1.18^{a} | 0.036 |
| MNFS³, % | 54.5^{a} | 54.7^{a} | 54.9^{a} | 0.202 |
| FDM⁴, % | 52.2^{a} | 52.1^{a} | 51.7^{a} | 0.164 |
| SM⁵, % | 3.59^{a} | 3.36^{a} | 3.10^{a} | 0.114 |
| Total Calcium | 771^{a} | 752^{a} | 750^{a} | 15.3 |
| (mg/100 g) | | | | |
| Total Sodium⁶ | 466^{a} | 461^{a} | 428^{a} | 17.7 |
| (mg/100 g) | | | | |
| pH⁷ at | | | | |
| 3 d | 5.08^{a} | 5.06^{a} | 5.04^{a} | |
| 3 wk | 5.07^{a} | 5.04^{a} | 5.01^{a} | |
| 5 wk | 5.11^{a} | 5.05^{a} | 5.04^{a} | |
| 3 mo⁷ | 5.14^{a} | 5.11^{a} | 5.09^{a} | |

¹Total % N × 6.38
²Determined using salt analyzer
³Moisture in the nonfat substance of the cheese
⁴Fat content on a dry weight basis
⁵Salt in the moisture phase of the cheese
⁶Determined using ICP method (Park, 2000)
⁷pH at 3 d, 3 and 5 wk are averaged values from 4 sets of trials whilst the pH values for the 3 mo is an average of 2 sets of trials.
^{a,b,c}Means within the same row not sharing a common superscript differ (P < 0.05)

NFE addition did not have significant effect on pH of the cheeses (Table 47), all cheeses had a similar pH values during ripening (Table 46). As the cheeses have similar moisture content, the final pH values of the cheeses were not significantly different. All cheeses showed a slight pH increase with ripening time (Tables 46 and 47), probably due to the solubilization of colloidal calcium phosphate during ripening (Hassan et al., 2004).

12.7.2 Texture Profile Analysis:

Textural analyses was carried out for all the cheeses at 3 wk, 5 wk and 3 mo. Treatment did not have any significant effect (P>0.05) on any of the measured textural properties of the cheeses (Tables 47 and 48). Hardness, adhesiveness, springiness, cohesiveness, gumminess and chewiness values were similar for all the cheeses during ripening. Previous studies reported a softening of cheese with a reduction in S/M (Grant, 2011; Mistry and Kasperson, 1998; Pastorino et al., 2003). The salt content in the aqueous phase could impact casein interactions, for example, the low S/M levels in the cheese aqueous phase causes greater casein hydration (Geurts et al. 1972, thereby weakening the matrix. The concentrations of soluble calcium and sodium chloride in cheese have a significant effect on cheese texture (Geurts et al., 1972; Lucey and Fox, 1993). As S/M, total calcium, pH and salt levels were similar between the cheeses, there was no significant differences in the textural properties of the cheeses.

TABLE 47
Mean squares and probabilities (in parentheses), and R² values for pH and hardness,
adhesiveness, springiness, cohesiveness, gumminess and chewiness determined by texture
profile analysis for Cheddar cheese manufactured with different levels of NFE powder
during 90 d of ripening.

| Factor | df | pH | df | Hardness¹ | Adhesiveness¹ | Springiness¹ | Cohesiveness¹ | Gumminess¹ | Chewiness¹ |
|---|---|---|---|---|---|---|---|---|---|
| Whole-plot | | | | | | | | | |
| Treatment (T) | 3 | 0.009 | 3 | 6.70 | 6.23 | 0.00013 | 0.00002 | 2.47 | 1.20 |
| | | (0.14) | | (0.44) | (0.84) | (0.20) | (0.78) | (0.40) | (0.41) |
| Day of cheesemaking (D) | 2 | 0.014 | 2 | 38.0 | 95.50 | 0.00024 | 0.00072* | 11.6* | 7.044* |
| | | (0.06) | | (0.04) | (0.14) | (0.07) | (<0.05) | (0.05) | (0.03) |
| Error (T × D) | 6 | 0.003 | 6 | 7.20 | 35.3 | 0.00006 | 0.00009 | 2.33 | 1.19 |
| Subplot | | | | | | | | | |
| Age (A) | 3 | 0.009* | 2 | 39.7** | 168 | 0.00005 | 0.00002 | 14.4** | 11.32** |
| | | (0.03) | | (<0.01) | (0.07) | (0.25) | (0.69) | (<0.01) | (<0.01) |
| A × T | 6 | 0.005 | 4 | 4.21 | 37.5 | 0.00002 | 0.00003 | 1.57 | 1.23 |
| | | (0.98) | | (0.47) | (0.59) | (0.70) | (0.77) | (0.92) | (0.48) |
| Error | 21 | 0.003 | 12 | 4.40 | 51.0 | 0.00003 | 0.00006 | 1.71 | 1.31 |
| R² | | 0.67 | | 0.83 | 0.66 | 0.80 | 0.81 | 0.81 | 0.78 |

¹texture properties were measured in texture profile analyzer
*0.01 < P ≦ 0.05
**P ≦ 0.01

TABLE 48
Mean values for Hardness, adhesiveness, springiness, cohesiveness,
gumminess and chewiness for the reduced sodium Cheddar cheeses
manufactured with different levels of NFE as determined by texture
profile analyzer

| | Treatments | | |
|---|---|---|---|
| | Reduced Na cheeses manufactured | | |
| | with different levels of NFE powder | | |
| Textural Attributes | No | Low | High |

At 3 wk

| | | | |
|---|---|---|---|
| Hardness (N) | 36.6^{a} | 38.6^{a} | 37.4^{a} |
| Adhesiveness | −54.4^{a} | −56.1^{a} | −54.3^{a} |
| Springiness | 0.85^{a} | 0.85^{a} | 0.86^{a} |
| Cohesiveness | 0.64^{a} | 0.63^{a} | 0.64^{a} |
| Gumminess | 23.4^{a} | 24.4^{a} | 23.8^{a} |
| Chewiness | 19.9^{a} | 20.7^{a} | 20.4^{a} |

At 5 wk

| | | | |
|---|---|---|---|
| Hardness | 41.1^{a} | 42.2^{a} | 38.8^{a} |
| Adhesiveness | −53.9^{a} | −55.2^{a} | −48.7^{a} |
| Springiness | 0.85^{a} | 0.85^{a} | 0.86^{a} |
| Cohesiveness | 0.64^{a} | 0.64^{b} | 0.63^{a} |
| Gumminess | 26.1^{a} | 26.8^{a} | 24.6^{a} |
| Chewiness | 22.2^{a} | 22.9^{a} | 21.1^{a} |

At 3 mo

| | | | |
|---|---|---|---|
| Hardness | 37.2^{a} | 39.6^{a} | 40.7^{a} |
| Adhesiveness | −49.7^{a} | −38.6^{a} | −45.1^{a} |
| Springiness | 0.86^{a} | 0.85^{a} | 0.86^{a} |
| Cohesiveness | 0.65^{a} | 0.64^{a} | 0.63^{a} |
| Gumminess | 23.9^{a} | 25.2^{a} | 25.6^{a} |
| Chewiness | 20.6^{a} | 21.4^{a} | 22.0^{b} |

^{a-b}Means with different superscript letters within the same row are significantly different (P < 0.05)

12.7.3 Descriptive Sensory Analysis:

Descriptive analysis panelists evaluated the 5 wk- and 3 mo-old cheeses for both textural and flavor attributes. At both 5 wk and 3 mo, there were no significant differences (P>0.05) between the textural attributes; firmness (hand), hardness, cohesiveness or chewiness (Table 49). The texture sensory data was in agreement with the instrumental data obtained from the texture profile analysis (Table 48). The use of NFE during the manufacture of reduced sodium Cheddar cheese did not affect the sensory textural attributes.

The panelists were trained on soy flavor. The panelists were able to detect the soy flavors in both the NFE-cheeses (low and high NFE-cheeses) during ripening (Table 49). As the cheeses aged, the soy flavor intensities also increased (Table 49). This suggested that the amount of NFE added during the manufacture was sufficient as the panelists were able to detect the soy flavor in the cheeses. The ability to detect the soy flavor is critical as this flavor is not typically present in cheeses and may be considered as an off-flavor to a consumer if detectable.

The use of NFE in the cheeses did not affect the sweetness, bitterness, sulfur and oxidized flavor intensities. Cheeses made with NFE were perceived to be slightly acidic, more astringent and metallic compared to the control cheese (Table 49). Interestingly the use of NFE did not have an impact on the umami flavor in the cheeses, even though it is known that NFE contains umami containing substances (Fuke and Ueda, 1996). Also the inclusion of high levels of NFE resulted in slight decrease (0.5) in the salty intensities whilst the low levels of NFE did not affect the salty perception as it was similar to the control cheese. The slightly higher acid intensities may have contributed to the NFE cheeses being slightly more sour, masking other flavors, such as umami taste or even slightly increased salt intensities as result of NFE addition.

TABLE 49
Sensory properties of Cheddar Cheeses at 5 wk (n = 4) and 3 mo
(n = 2) manufactured with different levels of NFE

| | Treatments | | |
|---|---|---|---|
| | Reduced Na cheeses manufactured | | |
| | with different levels of NFE powder | | |
| Sensory Attributes | No | Low | High |

At 5 wk

| | | | |
|---|---|---|---|
| Firmness | 11.6^{a} | 11.6^{a} | 11.6^{a} |
| Hardness | 5.7^{a} | 5.8^{a} | 5.6^{a} |
| Cohesiveness | 8.3^{a} | 8.5^{a} | 8.6^{a} |
| Chewiness | 5.5^{a} | 5.5^{a} | 5.4^{a} |
| Sweetness | 0.29^{a} | 0.23^{a} | 0.31^{a} |
| Saltiness | 4.6^{a} | 4.4^{a} | 4.3^{a} |
| Acidity | 5.2^{b} | 5.3^{ba} | 5.6^{a} |
| Bitterness | 0.58^{b} | 0.76^{ba} | 1.0^{a} |
| Umami | 2.0^{a} | 2.2^{a} | 2.2^{a} |
| Milkfat | 3.6^{a} | 3.5^{a} | 3.3^{a} |
| Soy | 0.33^{b} | 0.68^{b} | 1.3^{a} |
| Sulfur | 1.2^{a} | 1.1^{a} | 1.2^{a} |
| Metallic | 1.4^{a} | 1.4^{a} | 1.5^{a} |
| Oxidized | 1.0^{a} | 0.93^{a} | 0.90^{a} |
| Astringent | 2.2^{b} | 2.4^{ba} | 2.6^{a} |

At 3 mo

| | | | |
|---|---|---|---|
| Firmness | 11.5^{a} | 11.6^{a} | 11.9^{a} |
| Hardness | 5.3^{a} | 5.6^{a} | 5.7^{a} |
| Cohesiveness | 7.9^{a} | 7.7^{a} | 8.0^{a} |
| Chewiness | 5.6^{a} | 5.4^{a} | 5.3^{a} |
| Sweetness | 0.28^{a} | 0.22^{a} | 0.18^{a} |
| Saltiness | 4.3^{a} | 4.3^{a} | 3.8^{b} |
| Acidity | 5.5^{b} | 5.9^{a} | 6.1^{a} |
| Bitterness | 0.76^{a} | 0.84^{a} | 1.1^{a} |
| Umami | 2.1^{a} | 1.9^{a} | 2.1^{a} |
| Milkfat | 3.5^{a} | 3.4^{a} | 3.2^{a} |
| Soy | 0.69^{b} | 0.89^{b} | 1.8^{a} |
| Sulfur | 1.7^{a} | 1.7^{a} | 1.7^{a} |
| Metallic | 1.0^{b} | 1.3^{ba} | 1.7^{a} |
| Oxidized | 0.79^{a} | 0.82^{a} | 0.88^{a} |
| Astringent | 2.6^{b} | 2.7^{b} | 3.1^{a} |

^{a-b}Means with different superscript letters within the same row are significantly different (P < 0.05)

12.7.4 Consumer Sensory Analysis:

Demographic questions revealed the following information about consumer panelists who evaluated the cheeses. Over two replications, 116 panelists answered demographics questions. 51% of panelists were male and 49% were female. 51% of panelists were between ages 18-24, 26% of panelists were between ages 25-34, 11% of panelists were between ages 35-44, 5% of panelists were between ages 45-54, 4% of panelists were between ages 55-64, and 2% of panelists were over age 65. When asked about the frequency of cheese consumption, 72% consumed cheeses more than once a week, 17% once a week, 9% a few times per month and 2% a few times per year. Of the 116 panelists, 88% of the panelists consumed Cheddar cheese.

The data obtained from the consumer sensory analysis is presented in Table 50. From the consumer acceptability test, the use of NFE to manufacture reduced sodium Cheddar cheeses did not impact the overall, appearance, texture, aroma, acid or salt liking (Table 50) of the consumers. The flavor liking, however decreased slightly (by 0.5) for the high NFE cheeses compared to the control cheeses. Presence of an atypical flavor in the high NFE cheeses, such as “soy flavor” (which was detected in the high NFE cheeses by the descriptive panelists) may have contributed to the slight decrease in the flavor liking for the high NFE. Consumers may not associate such flavors typically with cheese. There was no significant (P>0.5) difference in the flavor liking of the consumers for the low NFE cheese compared to that of the control cheeses.

TABLE 50
Liking data obtained from consumer sensory analysis¹ (n = 116) of
3 mo-old Cheddar Cheeses² manufactured with different levels of NFE.

| | Treatments | | |
|---|---|---|---|
| | Reduced Na cheeses manufactured | | |
| | with different levels of NFE powder | | |
| Attributes | 0% | Low | High |
| Overall Liking | 6.6^{a} | 6.4^{a} | 6.3^{a} |
| Appearance Liking | 6.5^{a} | 6.5^{a} | 6.5^{a} |
| Texture Liking | 6.6^{a} | 6.4^{a} | 6.4^{a} |
| Aroma Liking | 6.1^{a} | 6.0^{a} | 5.8^{a} |
| Flavor Liking | 6.7^{a} | 6.4^{ab} | 6.2^{b} |
| Salt Liking | 6.0^{a} | 5.8^{a} | 5.7^{a} |
| Acid Liking | 5.8^{a} | 5.7^{a} | 5.6^{a} |

¹The evaluation form that was used for the consumer panel analyses is given in the Appendix
²Data presented from the consumer sensory analyses were based on cheeses manufactured from one set of trials.
^{a-b}Means with different superscript letters within the same row are significantly different (P < 0.05)

### 12.8 Conclusion:

NFE can be used to replace the sodium content in reduced sodium Cheddar cheeses without affecting consumer acceptance. Substitution at 2 or 4% of did not affect the composition, pH or textural properties of the cheeses. However, replacing at 4% level did increase the soy flavor note to be detected by trained panelists in the cheeses compared to the control cheese. The use of NFE in cheese does not affect the overall appearance, texture, aroma, acid or salt liking of the consumers, but it does have a negative effect on the flavor liking at the higher substitution level; 4%.

### REFERENCES CITED

AOAC. 2000a. Official Methods of Analysis of the Association of Official Analytical Chemists. 17th ed. Method No. 950.46, Moisture in Meat and Meat Products. Gaithersburg, Md.: Association of Official Analytical Chemists.
AOAC. 2000b. Official Methods of Analysis of the Association of Official Analytical Chemists. 17th ed. Method No. 990.03, Protein (Crude) in Animal Feed Combustion Method. Gaithersburg, Md.: Association of Official Analytical Chemists.
AOAC. 2000c. Official Methods of Analysis of the Association of Official Analytical Chemists. 17th ed. Method No. 991.36, Fat (Crude) Ether Extract in Meat. Gaithersburg, Md.: Association of Official Analytical Chemists.
Arganosa G C, Marriott N G. 1990. Salt substitutes in restructured ham. J Muscle Foods. 1: 105-14.
Barbut S. 1988. Microstructure of reduced salt meat batters as affected by polyphosphates and chopping time. J Food Sci. 53(5):1300-04.
Bourne M C. 1978. Texture profile analysis. Food Technol. 32(7):66-72.
Djordjevic J, Zatorre Ri, Jones-Gotman M. 2004. Odor-induced changes in taste perception. Experimental Brain Research. 159(3):405-8.
Doyle M E, Glass K A. 2010. Sodium reduction and its effect on food safety, food quality, and human health. Comp Rev Food Sci Food Safety. 9:44-56.
Fuke S, Ueda Y. 1996. Interactions between umami and other flavor characteristics. Trends Food Sci and Technol. 7:407-11.
Hand L W, Terrell R N, Smith G C. 1982. Effects of chloride salts on physical, chemical and sensory properties of frankfurters. J Food Sci. 47:1800-02.
Hand L W, Hollingsworth C A, Calkins C R, Mandigo R W. 1987. Effects of preblending, reduced fat and salt levels on frankfurter characteristics. I Food Sci. 52(5):1 149-51.
Hazen C. 2010. Reducing sodium. Food Product Design. Phoenix, Ariz., Virgo Publishing 20:84-98.
Hutton T. 2002. Sodium: Technological functions of salt in the manufacturing of food and drink products. Br Food J. 104(2):126-52.
Keast R S J, Breslin P A S. 2002. An overview of binary taste-taste interactions. Food Qual Preference. 14:111-24.
Kremer S, Mojet J, Shimojo R. 2009. Salt reduction in foods using naturally brewed soy sauce. J Food Sci. 74(6):5255-562.
Man C M D. 2007. Technological functions of salt in food products. In: Kilcast D, Angus F. Reducing salt in foods: Practical strategies. Philadelphia: Woodhead Publishing. p 157-73.
Mojet J, Heidema J, Chrost-Hazelhof E. 2004. Effect of concentration on taste-taste interactions in foods for elderly and young subjects. Chem. Senses. 29:671-81.
Resurreccion A V A. 2003. Sensory aspects of consumer choices for meat and meat products. Meat Sci. 66:11-20.
Rust R E. 1987. Sausage products. In: Price J F, Schweigert B S. The science of meat and meat products, 3rd ed. Westport, Conn.: Food and Nutrition Press, Inc. p 457-85.
Sebranek J G, Lonergan S M, King-Brink M, Larson E. 2001. Meat science and processing. 3rd ed. Zenda, Wis.: Peerage Press. 275.
Seman D L, Olson D G, Mandigo R W. 1980. Effect of reduction and partial replacement of sodium on bologna characteristics and acceptability. J Food Sci. 45:1116-25.
Sofos J N. 1983a. Effects of reduced salt (NaCl) levels on sensory and instrumental evaluation of frankfurters. J Food Sci. 48:1692-95, 99.
Sofos J N. 1983b. Effects of reduced salt (NaCl) levels on the stability of frankfurters. J Food Sci. 48:1684-91.
Soong S. 2010. Shaking things up. Meatingplace. September 2010:71-76.
Wenther J B. 2003. The effect of various protein ingredients utilized as a lean meat replacement in a model emulsion system and frankfurters. PhD Dissertation. Ames, Iowa: Iowa State University. p 325.
Wenther J B. 2010. Reducing salt content in food threatens processed meat industry. AAMPlifier. Elizabethtown, Pa.: American Association of Meat Processors.
Whiting R C, Jenkins R K. 1981. Partial substitution of sodium chloride by potassium chloride in frankfurter formulations. J Food Qual. 4:259-69.
Whiting R C. 1984. Stability and gel strength of frankfurter batters made with reduced NaCl. J Food Sci. 49:1350-54.
World Health Organization. 2007. Reducing salt intake in populations. Report of a WHO Forum and Technical Meeting. Geneva, Switzerland, WHO Document Production Services.
Yamaguchi S, Takahashi C. 1984. Interactions of monosodium glutamate and sodium chloride on saltiness and palatability of a clear soup. J Food Sci. 49:82-85.
AOAC. 2009. Method 2006.03 Microwave Digestion and Inductively Coupled Plasma Optical Emission Spectrometry. AOAC. 18^{th} Ed. http://www.eoma.aoac.org Accessed Mar. 3, 2012
AACC. 2000a. Approved Methods of the American Association of Cereal Chemists. AACC, Inc. 10^{th} Ed.
Anderson C. A. M. et al., Dietary Sources of Sodium in China, Japan, the United Kingdom, and the United States, Women and Men Aged 40 to 59 Years: The INTERMAP Study. J. Am. Diet. Assoc. 110: 736-745 (2010)
Bibbins-Domingo K. et al., Projected Effect of Dietary Salt Reduction on Future Cardiovascular Disease. N. Engl. J. Med. 362: 590-599 (2010)
Taormina P. J. Implications of Salt and Sodium Reduction on Microbial Food Safety. Crit. Rev. Food Sci. Nutr. 50: 209-227 (2010)
Braschi A. et al., Partial Substitution of Sodium with Potassium in White Bread: Feasibility and Bioavailability. Int. J. Food Sci. and Nutr. 60: 507-521 (2009)
Pimenta E. et al., Effects of Dietary Sodium Reduction on Blood Pressure in Subjects with Resistant Hypertension Results from a Randomized Trial. Hypertension. 54: 475-481 (2009)
Berry D. Sodium Reduction Strategies. Dairy Foods. 111: 54-58 (2010)
Johnson E. et al., Reduction of Sodium and Fat Levels in Natural and Processed Cheeses: Scientific and Technological Aspects. Comprehensive Rev. in Food Sci. and Food Safety. 8: 252-268 (2009)
Lynch E. J. et al., Fundamental Studies on the Reduction of Salt on Dough and Bread Characteristics. Food Research International. 42: 885-891 (2009)
Kiskini A. et al., Effect of different iron compounds on wheat and gluten-free breads. J Sci Food Agric. 90: 1136-1145 (2010)

What is claimed is:

1. A method of making a reduced-sodium food product, in which a corresponding full-sodium food product is designated as containing 100% sodium from NaCl, the method comprising:
preparing a food product using no more than about 50 wt % NaCl from flake salt as compared to the corresponding full-sodium food product and up to 45 wt % NaCl provided from soy sauce or natural flavor enhancer as compared to the corresponding full-sodium food product, thereby yielding a reduced-sodium food product that is at least 5 wt % reduced in NaCl as compared to the full-sodium food product.

2. The method of claim 1, comprising preparing the food product using up to 40 wt % NaCl provided from soy sauce or natural flavor enhancer as compared to the corresponding full-sodium food product, thereby yielding a reduced-sodium food product that is at least 10 wt % reduced in NaCl as compared to the full-sodium food product.

3. The method of claim 1, comprising preparing the food product using up to 35 wt % NaCl provided from soy sauce or natural flavor enhancer as compared to the corresponding full-sodium food product, thereby yielding a reduced-sodium food product that is at least 15 wt % reduced in NaCl as compared to the full-sodium food product.

4. The method of claim 1, comprising preparing the food product using up to 30 wt % NaCl provided from soy sauce or natural flavor enhancer as compared to the corresponding full-sodium food product, thereby yielding a reduced-sodium food product that is at least 20 wt % reduced in NaCl as compared to the full-sodium food product.

5. The method of claim 1, comprising preparing the food product using up to 25 wt % NaCl provided from soy sauce or natural flavor enhancer as compared to the corresponding full-sodium food product, thereby yielding a reduced-sodium food product that is at least 25 wt % reduced in NaCl as compared to the full-sodium food product.

6. The method of claim 1, comprising preparing the food product using up to 20 wt % NaCl provided from soy sauce or natural flavor enhancer as compared to the corresponding full-sodium food product, thereby yielding a reduced-sodium food product that is at least 30 wt % reduced in NaCl as compared to the full-sodium food product.

7. The method of claim 1, comprising preparing the food product using up to 15 wt % NaCl provided from soy sauce or natural flavor enhancer as compared to the corresponding full-sodium food product, thereby yielding a reduced-sodium food product that is at least 35 wt % reduced in NaCl as compared to the full-sodium food product.

8. The method of any one of claims 1 through 7, comprising preparing a food product selected from the group consisting of bread, cheese, and meat products.

9. The method of any one of claims 1 through 7, further comprising preparing the food product by adding KCl in an amount by weight approximately equal to the percent reduction in NaCl in the reduced-sodium food product as compared to the full-sodium food product.

10. The method of claim 8, comprising preparing a food product selected from the group consisting of bread, cheese, and meat products.

11. A method of making a reduced-sodium food product, in which a corresponding full-sodium food product is designated as containing 100% sodium as NaCl provided by an amount of flake salt, the method comprising:
preparing a food product by reducing the amount of NaCl provided by flake salt, and replacing only a portion of the reduced amount of NaCl provided by flake salt with NaCl contained in soy sauce or natural flavor enhancer, thereby yielding a reduced-sodium food product.

12. The method of claim 11, further comprising adding KCl in an amount by weight approximately equal to the percent reduction in NaCl in the reduced-sodium food product.

13. The method of claim 11 or 12, comprising preparing a food product selected from the group consisting of bread, cheese, and meat products.

14. A reduced-sodium food product in which a corresponding full-sodium food product is designated as containing 100% sodium from NaCl, the product produced by:
preparing the reduced-sodium food product using no more than about 50 wt % NaCl from flake salt as compared to the corresponding full-sodium food product and up to 45 wt % NaCl provided from soy sauce or natural flavor enhancer as compared to the corresponding full-sodium food product, thereby yielding a reduced-sodium food product that is at least 5 wt % reduced in NaCl as compared to the full-sodium food product.

15. The method of claim 14, comprising preparing a food product selected from the group consisting of bread, cheese, and meat products.

16. A reduced-sodium food product in which a corresponding full-sodium food product is designated as containing 100% sodium as NaCl provided by an amount of flake salt, the product produced by:
preparing a food product by reducing the amount of NaCl provided by flake salt, and replacing only a portion of the reduced amount of NaCl provided by flake salt with NaCl contained in soy sauce or natural flavor enhancer, thereby yielding a reduced-sodium food product.

17. The method of claim 16, comprising preparing a food product selected from the group consisting of bread, cheese, and meat products.
